(19) United States
(12) Patent Application Publication
(10) Pub. No.: US 2011/0311899 A1
(43) Pub. Date: Dec. 22, 2011

(54) POLYMER, POLYARYLENE BLOCK COPOLYMER, POLYELECTROLYTE, POLYELECTROLYTE MEMBRANE, AND FUEL CELL

(75) Inventors: Toru Onodera, Ibaraki (JP); Taisuke Nakamura, Ibaraki (JP); Sho Kanesaka, Ibaraki (JP); Arihiro Yashiro, Ibaraki (JP); Takashi Yamada, Ibaraki (JP); Masamitsu Ishitobi, Ibaraki (JP); Shigeru Sasaki, Ibaraki (JP); Isao Kaito, Ibaraki (JP); Akira Kaito, Ibaraki (JP); Yuko Kaito, Ibaraki (JP)

(73) Assignee: SUMITOMO CHEMICAL COMPANY, LIMITED, Chuo-ku, Tokyo (JP)

(21) Appl. No.: 12/993,675

(22) PCT Filed: May 21, 2009
(86) PCT No.: PCT/JP2009/059377

§ 371 Date: Jul. 1, 2011

(30) Foreign Application Priority Data
May 21, 2008 (JP) 2008-132912
Dec. 25, 2008 (JP) 2008-331143
Mar. 24, 2009 (JP) 2009-071361
Mar. 24, 2009 (JP) 2009-071362
Apr. 21, 2009 (JP) 2009-102867

(51) Int. Cl. B01J 39/18; H01M 8/10

(52) U.S. Cl. 429/482; 521/27; 521/25; 521/30

(57) ABSTRACT

The polymer electrolyte membrane according to the present invention comprises a polymer electrolyte having ion-exchange groups, wherein Sp and Snp satisfy a relationship expressed by the following expression (I):

Sp/Snp≦0.42 (I)

where Sp represents the total of peak areas obtained by measurement of a ¹³C-solid state nuclear magnetic resonance spectrum of the polymer electrolyte membrane, the polymer electrolyte membrane having been subjected to a first immersion treatment comprising immersing the polymer electrolyte membrane in 5 mmol/L iron (II) chloride tetrahydrate aqueous solution at 25° C. for 1 hour, and thereafter drying the polymer electrolyte membrane at 25° C. at 10 hPa or lower for 12 hours; and Snp represents the total of peak areas obtained by measurement of a ¹³C-solid state nuclear magnetic resonance spectrum of the polymer electrolyte membrane, the polymer electrolyte membrane before the first immersion treatment having been subjected to a second immersion treatment comprising immersing the polymer electrolyte membrane in water at 25° C. for 1 hour, and thereafter drying the polymer electrolyte membrane at 25° C. at 10 hPa or lower for 12 hours.

### TECHNICAL FIELD

The present invention relates to polymers and polyarylene block copolymers which are useful as polymer electrolytes for fuel cells, polymer electrolyte membranes to be used for solid polymer fuel cells, and fuel cells.

### BACKGROUND ART

Polymer electrolytes containing a polymer having proton conductivity are used as materials constituting diaphragms of electrochemical devices such as primary cells, secondary cells and fuel cells. Fluoropolymer electrolytes which contain as an effective component a polymer whose side chains have perfluoroalkylsulfonic acid residues as a super-strong acid and whose main chain is a perfluoroalkane chain, typified by, for example, Nafion (registered trademark of E.I. du Pont de Nemours and Company), have conventionally been mainly used because they are excellent in power generating characteristics when used as proton conductive membranes for fuel cells (hereinafter, sometimes referred to as “proton conductive membrane”). However, the fluoropolymer electrolytes have such pointed-out problems as high prices, low heat resistance, high disposal cost, and poor practical utility due to low membrane strength without any reinforcement.

Solid polymer fuel cells (hereinafter, contracted to “fuel cell” in some cases) are power generating devices to generate a power by a chemical reaction between hydrogen and oxygen, and are greatly expected as one of next-generation energies in the fields including electric equipment industries and car industries. As polymer electrolyte membrane materials to be used in fuel cells, hydrocarbon polymer electrolytes which are inexpensive and excellent in heat resistance have recently attracted attention in place of conventional fluoropolymer electrolytes.

It is pointed out that membranes composed of hydrocarbon polymer electrolytes (hydrocarbon polymer electrolyte membranes) are lower in long-term operational stability (hereinafter, referred to as “long-term stability”) for fuel cells than membranes composed of fluoropolymer electrolytes (fluoropolymer electrolyte membranes). Various factors have been presumed to be factors reducing the long-term stability, and the deterioration of membranes due to peroxides (for example, hydrogen peroxide) generated during cell operation or radicals generated from the peroxides has been known as one of the factors. Therefore, improving the durability of a polymer electrolyte membrane to peroxides and radicals (hereinafter, referred to as “radical resistance”) is considered to be one measure leading to long-term stability of a solid polymer fuel cell.

As a hydrocarbon polymer electrolyte membrane improved in the radical resistance, Patent Literature 1 discloses a hydrocarbon polymer electrolyte membrane formed from a polyarylene polymer composition containing an antioxidant such as a hindered phenolic compound or a hindered amine compound in order to improve the radical resistance of the hydrocarbon polymer electrolyte.

Patent Literature 2 proposes a polyarylene polymer electrolyte having sulfonated aromatic rings of phenoxybenzoyl groups in side chains by sulfonating a polyarylene polymer having a flexible group such as a phenoxybenzoyl group as side chains, and discloses that the polyarylene polymer electrolyte has a high proton conductivity even in a high temperature region of 100° C. or higher.

Further, Patent Literature 3 discloses a polymer electrolyte membrane prepared by using a polyarylene copolymer comprising a structural unit having a specific structure in which ion-exchange groups are bonded directly to aromatic rings except aromatic rings constituting the main chain, and a structural unit having a polystyrene-equivalent weight-average molecular weight of 28,200 and substantially having no ion-exchange group.

### CITATION LIST

### Patent Literature

Patent Literature 1: Japanese Patent Application Laid-Open Publication No. 2003-183526
Patent Literature 2: U.S. Pat. No. 5,403,675 (columns 9-11, FIG. 4)
Patent Literature 3: Japanese Patent Application Laid-Open Publication No. 2003-212988

### SUMMARY OF INVENTION

However, although the addition of an antioxidant described in Patent Literature 1 is likely to improve the radical resistance of a polymer electrolyte membrane, characteristics thereof required for fuel cell applications, such as proton conductivity, may decrease. Thus in conventional hydrocarbon polymer electrolyte membranes, the improvement in radical resistance without relying on the addition of an antioxidant is very difficult, and even if an antioxidant is added, characteristics except the radical resistance are likely to decrease.

It is then an object of the present invention to provide a polymer electrolyte membrane having a sufficiently high radical resistance without addition of an auxiliary agent such as an antioxidant, and a membrane-electrode assembly (MEA) and a fuel cell using the polymer electrolyte membrane. It is an other object of the present invention to provide a polymer and a polyarylene block copolymer which are excellent in radical resistance and useful as polymer electrolytes to constitute polymer electrolyte membranes.

As a result of exhaustive studies to achieve the above-mentioned objects, the present inventors found that the distribution of water contained in a polymer electrolyte membrane influenced radical resistance, and this finding has led to the completion of the present invention.

That is, the present invention is a polymer electrolyte membrane comprising a polymer electrolyte having an ion-exchange group, wherein Sp and Snp satisfy a relationship expressed by the following expression (I):

Sp/Snp≦0.42 (I)

wherein Sp represents the total of peak areas obtained by measurement of a ¹³C-solid state nuclear magnetic resonance spectrum of the polymer electrolyte membrane, the polymer electrolyte membrane having been subjected to a first immersion treatment comprising immersing the polymer electrolyte membrane in 5 mmol/L iron (II) chloride tetrahydrate aqueous solution at 25° C. for 1 hour, and thereafter drying the polymer electrolyte membrane at 25° C. at 10 hPa or lower for 12 hours; and Snp represents the total of peak areas obtained by measurement of a ¹³C-solid state nuclear magnetic resonance spectrum of the polymer electrolyte membrane, the polymer electrolyte membrane before the first immersion treatment having been subjected to a second immersion treatment comprising immersing the polymer electrolyte membrane in water at 25° C. for 1 hour, and thereafter drying the polymer electrolyte membrane at 25° C. at 10 hPa or lower for 12 hours.

In the polymer electrolyte membrane according to the present invention, the polymer electrolyte preferably comprises a copolymer comprising a structural unit having an ion-exchange group and a structural unit having no ion-exchange group. Such a polymer electrolyte membrane serves as a polymer electrolyte membrane that is excellent in radical resistance and capable of exhibiting proton conductivity and mechanical strength sufficiently excellent in use for fuel cells.

From the viewpoint of further improving the radical resistance of a polymer electrolyte membrane, the polymer electrolyte is preferably an aromatic polymer electrolyte.

The present invention provides a polymer whose main chain is of a polyarylene structure in which a plurality of aromatic rings are linked together substantially via direct bonds, wherein part or all of the aromatic rings constituting the main chain have a sulfonic acid group directly bonded thereto, and part or all of the aromatic rings constituting the main chain further have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and wherein the ion-exchange capacity of the polymer is more than 3.0 meq/g.

A polyarylene polymer electrolyte such as that disclosed in Patent Literature 2 described above is likely to be remarkably decreased in water resistance when a sulfonic acid group equivalent weight is attempted to be increased in order to improve the proton conductivity, and thus it lacks practical utility as a proton conductive membrane for fuel cells. Production means specifically disclosed in Patent Literature 2 has a difficulty in increasing per se a sulfonic acid group equivalent weight responsible for the proton conductivity over a certain equivalent weight.

By contrast, the use of the polymer according to the present invention as a polymer electrolyte for fuel cells, particularly a proton conductive membrane, makes it possible to form a membrane having, in addition to an excellent radical resistance, water resistance in a high level and simultaneously an excellent proton conductivity.

In the polymer described above, the structural unit having, in the main chain, an aromatic ring to which a sulfonic acid group is directly bonded preferably accounts for 20 mol % or more, based on 100 mol % of the total of structural units.

The polymer described above preferably comprises a structural unit represented by the following formula (A-1):

[Chemical Formula 1]

Ar¹ (A-1)

wherein in the formula (A-1), Ar¹ denotes a divalent aromatic group, and the aromatic group may be substituted with at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; and at least one sulfonic acid group is directly bonded to an aromatic ring constituting the main chain of Ar¹.

In the polymer described above, the structural unit represented by the formula (A-1) preferably comprises a structural unit represented by the following formula (A-2):

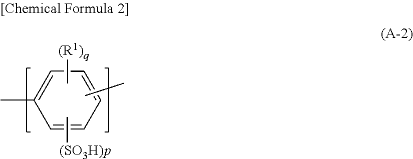

wherein in the formula (A-2), R¹ denotes a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; p is an integer of 1 or more and 3 or less, q is an integer of 0 or more and 3 or less, and p+q is an integer of 4 or less; and in the case where q is 2 or more, the plurality of R¹ may be identical or different from each other.

The polyarylene structure described above is preferably a structure having a proportion of direct bonds of 80% or more based on 100% of the total number of bonds between aromatic rings.

The present invention also provides a polymer obtained by polymerizing raw material monomers comprising a first aromatic monomer represented by the following formula (A-3) and a second aromatic monomer represented by the following formula (A-4).

Q-Ar¹⁰-Q (A-3)

In the formula (A-3), Ar¹⁰ is a divalent aromatic group that may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; Q denotes a leaving group, and two Q may be identical or different from each other; and a sulfonic acid group and/or a sulfonic acid precursor group is bonded to an aromatic ring bonded with one of the two Q.

Q-Ar⁰-Q (A-4)

In the formula (A-4), Ar⁰ is a divalent aromatic group, and the divalent aromatic group has at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; and Q denotes a leaving group, and two Q may be identical or different from each other.

The second aromatic monomer described above preferably has, as a substituent, an acyl group that may have a substituent.

The polymer described above can be obtained by polymerizing raw material monomers in the presence of a zero-valent transition metal complex.

Although conventional polymer electrolyte membranes have practical proton conductivity and water resistance, a polymer electrolyte membrane having a higher proton conductivity and an excellent water resistance is demanded to be developed for development of high-performance fuel cells.

The present inventors have found that by specifying, in a polyarylene block copolymer comprising blocks having an ion-exchange group and blocks having substantially no ion-exchange group, the bonding form of the ion-exchange group of the blocks having an ion-exchange group and the sequence of the blocks, and specifying the sequence of the blocks having no ion-exchange group and the weight-average molecular weight of the blocks, a polymer electrolyte membrane can be obtained which has a sufficiently excellent radical resistance, a high proton conductivity and an excellent water resistance.

The present invention provides a polyarylene block copolymer comprising a block having an ion-exchange group and a block having substantially no ion-exchange group obtained from a polymer having substantially no ion-exchange group and having a polystyrene-equivalent weight-average molecular weight of 4000 to 25000, wherein the block having an ion-exchange group comprises a structural unit represented by the following formula (B-1), and the block having substantially no ion-exchange group comprises a structural unit represented by the following formula (B-2).

[Chemical Formula 3]

Ar¹ (B-1)

Ar²—X¹ (B-2)

In the formula (B-1), Ar¹ denotes an arylene group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; and at least one ion-exchange group is directly bonded to an aromatic ring constituting the main chain in Ar¹. In the formula (B-2), Ar² denotes a divalent aromatic group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; and X¹ denotes an oxygen atom (—O—) or a sulfur atom (—S—).

The polyarylene copolymer according to the present invention can provide a membrane that has, in addition to a sufficiently excellent radical resistance, a high proton conductivity as well as an excellent water resistance when used as a polymer electrolyte membrane.

In the polyarylene copolymer according to the present invention, the ion-exchange group is preferably at least one or more acid groups selected from the group consisting of a sulfonic acid group, a phosphonic acid group, a carboxylic acid group and a sulfonimide group.

The structural unit represented by the above formula (B-1) is preferably a structural unit represented by the following formula (B-3).

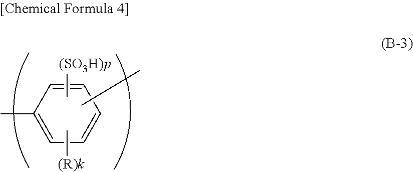

In the formula (B-3), R denotes an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, or a cyano group; k denotes an integer of 0 to 3, p denotes an integer of 1 or 2, and k+p denotes an integer of 4 or less; and in the case where k is 2 or more, the plurality of R may be identical or different from each other.

In the polyarylene copolymer according to the present invention, the polymer having substantially no ion-exchange group is preferably a polymer represented by the following formula (B-4).

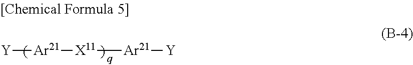

In the formula (B-4), Ar²¹ denotes a divalent aromatic group, and the plurality of Ar²¹ may be identical or different from each other; the aromatic group may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; X¹¹ denotes an oxygen atom (—O—) or a sulfur atom (—S—), and the plurality of X¹¹ may be identical or different from each other; Y denotes a leaving group, and two Y may be identical or different from each other; and q denotes an integer of 4 or more.

The polymer represented by the above formula (B-4) preferably has a hydrophobicity parameter of 1.7 to 6.0, and more preferably 2.5 to 4.0.

The polyarylene block copolymer described above preferably has an ion-exchange capacity of 1.0 to 7.0 meq/g.

Use of a conventional polyarylene polymer electrolyte like that disclosed in Patent Literature 3 as a proton conductive membrane for polymer electrolyte fuel cells has a problem of low power generation characteristics under high-temperature and low-moisture conditions.

As a result of exhaustive studies to find out a polymer that can exhibit a better performance as a polymer electrolyte suitable for a proton conductive membrane or a catalyst layer of a fuel cell, the present inventors have found that a block copolymer comprising a block having an ion-exchange group and a block having substantially no ion-exchange group, by specifying a bonding form of the ion-exchange group of the block having an ion-exchange group, and a structure and a repeating number of the block having substantially no ion-exchange group, exhibits not only an excellent radical resistance, but also improved power generation characteristics under high-temperature and low-moisture conditions when a polymer electrolyte fuel cell is fabricated.

The present invention provides a polyarylene block copolymer comprising a block having an ion-exchange group and a block having substantially no ion-exchange group, wherein the main chain of the block having an ion-exchange group has a polyarylene structure in which a plurality of aromatic rings are linked together substantially directly wherein part or all of ion-exchange groups are directly bonded to the aromatic rings constituting the main chain, and the block having substantially no ion-exchange group has a structure represented by the following formula (C-1).

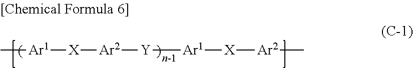

In the formula (C-1), Ar¹ and Ar² each independently denote an arylene group, and the arylene group may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; X denotes a carbonyl group (—C(═O)—) or a sulfonyl group (—S(═O)₂—); Y denotes an oxygen atom (—O—) or a sulfur atom (—S—); n denotes an integer of 3 to 45; and the pluralities of Ar¹, Ar², X and Y may be each identical or different from each other.

When the polyarylene block copolymer is used as a polymer electrolyte, a polymer electrolyte fuel cell can be produced that can exhibit, in addition to an excellent radical resistance, good power generating characteristics even under high-temperature and low-moisture conditions.

In the polyarylene block copolymer according to the present invention, the block having substantially no ion-exchange group preferably has a structure represented by the following formula (C-2):

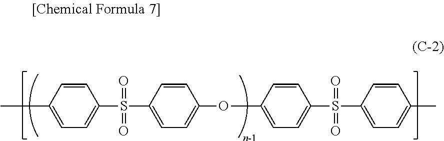

wherein in the formula (C-2), n denotes an integer of 3 to 45.

In the polyarylene block copolymer according to the present invention, the block having an ion-exchange group preferably has a structure represented by the following formula (C-3):

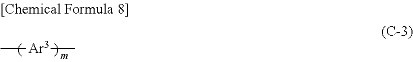

wherein in the formula (C-3), m denotes an integer of 3 or more; Ar³ denotes an arylene group, and the arylene group may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent and has 2 to 20 carbon atoms; in Ar³, at least one ion-exchange group is directly bonded to an aromatic ring constituting the main chain thereof; and the plurality of Ar³ may be identical or different from each other.

In the polyarylene block copolymer described above, the ion-exchange group is at least one acid group selected from the group consisting of a sulfonic acid group, a sulfonimide group, a phosphonic acid group and a carboxylic acid group.

The block having an ion-exchange group described above preferably has a structure represented by the following formula (C-4):

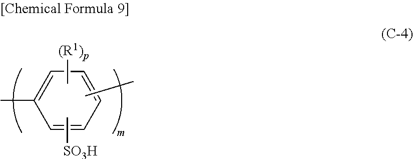

wherein in the formula (C-4), m denotes an integer of 3 or more; R¹ denotes at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; p is an integer of 0 to 3; and in the case where there are a plurality of R¹, R¹ may be identical or different from each other.

The polyarylene block copolymer described above preferably has an ion-exchange capacity of 0.5 meq/g to 5.0 meq/g.

The present invention provides a polymer electrolyte comprising the polymer described above or the polyarylene block copolymer described above, and a polymer electrolyte membrane comprising the polymer electrolyte.

The present invention also provides a polymer electrolyte composite membrane comprising a porous base material having a polymer electrolyte in pores thereof, wherein the polymer electrolyte is the polymer electrolyte described above according to the present invention. The present invention further provides a catalyst composition comprising the above-mentioned polymer electrolyte and a catalyst component.

The present invention provides a membrane-electrode assembly comprising the above-mentioned polymer electrolyte membrane according to the present invention and a catalyst layer formed on the polymer electrolyte membrane. The present invention further provides a membrane-electrode assembly comprising the polymer electrolyte membrane or the polymer electrolyte composite membrane described above. The present invention further provides a membrane-electrode assembly comprising a polymer electrolyte membrane and a catalyst layer formed on the polymer electrolyte membrane, wherein the catalyst layer is formed of the catalyst composition.

The present invention provides a fuel cell comprising a pair of separators, a pair of gas diffusion layers disposed between the pair of separators, and a membrane-electrode assembly disposed between the pair of gas diffusion layers, wherein the membrane-electrode assembly is the above-mentioned membrane-electrode assembly.

### EFFECTS OF INVENTION

The present invention can provide a polymer electrolyte membrane having a sufficiently high radical resistance even without addition of an auxiliary agent such as an antioxidant, and also provide a membrane-electrode assembly (MEA) and a fuel cell both using the polymer electrolyte membrane.

The present invention can provide a polymer that has an excellent radical resistance as well as a water resistance in a high level and that simultaneously is capable of developing an excellent proton conductivity when used as a member for a fuel cell (a polymer electrolyte for a fuel cell), particularly as a proton conductive membrane. Both the performances of such a high proton conductivity and a water resistance are expected to be useful for the case where the polymer according to the present invention is applied to a catalyst layer of a fuel cell. A fuel cell equipped with a fuel cell member prepared by using the polymer according to the present invention, which exhibits a high power generating efficiency, is industrially very useful.

The present invention provides a polyarylene block copolymer that has an excellent radical resistance and that develops a high proton conductivity and an excellent water resistance when used as a member for a polymer electrolyte fuel cell, particularly as a polymer electrolyte membrane. The polyarylene block copolymer according to the present invention is suitable for use as a catalyst layer of a polymer electrolyte fuel cell. Particularly when the polyarylene block copolymer is used for a fuel cell as the above-mentioned polymer electrolyte membrane, a fuel cell that exhibits a high power generating efficiency is obtained.

The polyarylene block copolymer according to the present invention gives a fuel cell that has an excellent radical resistance as well as exhibits good power generating characteristics under high-temperature and low-moisture conditions when used as a polymer electrolyte membrane (proton conductive membrane) of a polymer electrolyte fuel cell. The operation of a polymer electrolyte fuel cell under high-temperature and low-moisture conditions results in the improvement in the power generating efficiency, and the simplification of a cooling apparatus, a humidifying apparatus and the like. In such a way, the polyarylene block copolymer according to the present invention is industrially very useful particularly in applications to fuel cells.

### BRIEF DESCRIPTION OF DRAWING

FIG. 1 is a diagram schematically illustrating a cross-sectional structure of a fuel cell according to the present embodiment.

### DESCRIPTION OF EMBODIMENTS

Hereinafter, preferable embodiments of the present invention will be described in detail, with reference to a drawing as required.

The polymer electrolyte membrane according to the present invention comprises a polymer electrolyte having an ion-exchange group, wherein Sp and Snp satisfy a relationship expressed by the following expression (I):

Sp/Snp≦0.42 (I)

wherein Sp represents the total of peak areas obtained by measurement of a ¹³C-solid state nuclear magnetic resonance spectrum of the polymer electrolyte membrane, the polymer electrolyte membrane having been subjected to a first immersion treatment comprising immersing the polymer electrolyte membrane in 5 mmol/L iron (II) chloride tetrahydrate aqueous solution at 25° C. for 1 hour, and thereafter drying the polymer electrolyte membrane at 25° C. at 10 hPa or lower for 12 hours, and Snp represents the total of peak areas obtained by measurement of a ¹³C-solid state nuclear magnetic resonance spectrum of the polymer electrolyte membrane, the polymer electrolyte membrane before the first immersion treatment having been subjected to a second immersion treatment comprising immersing the polymer electrolyte membrane in water at 25° C. for 1 hour, and thereafter drying the polymer electrolyte membrane at 25° C. at 10 hPa or lower for 12 hours.

Such a polymer electrolyte membrane has little unevenness in the distribution of water in the membrane and uniformly dispersed water, and has a sufficiently high radical resistance. The Sp/Snp described above is 0.42 or less, preferably 0.35 or less, more preferably 0.25 or less, and still more preferably 0.10 or less. Here, in the present description, “Sp/Snp” is defined as a “nonuniformity factor (H)”, which represents the nonuniformity of water in a membrane. The total of peak areas in a spectrum is calculated using a “TOPSPIN,” trade name, made by Bruker Biospin GmbH, which is software capable of processing spectra.

First, a preferable embodiment of a polymer electrolyte constituting a polymer electrolyte membrane will be described. A polymer electrolyte constituting a polymer electrolyte membrane is not especially limited as long as the polymer electrolyte has ion-exchange groups that exhibit proton conductivity, and H, which is a nonuniformity factor described above, satisfies a relationship represented by the above expression (I) when a polymer electrolyte membrane has been produced therefrom, and a fluoropolymer electrolyte and/or a hydrocarbon polymer electrolyte may be used singly or in combination of two or more types thereof. A hydrocarbon polymer electrolyte, which is to constitute a hydrocarbon polymer electrolyte membrane, can further have an advantage of the present invention.

In the present embodiment, the radical resistance of a polymer electrolyte membrane can be evaluated by using an evaluation method in which the polymer electrolyte membrane is subjected to an immersion treatment as described before, and before and after the treatment, a ¹³C-solid state NMR spectrum is measured to calculate “a nonuniformity factor (H)”.

The polymer electrolyte according to the present invention has acidic ion-exchange groups (cation-exchange groups) or basic ion-exchange groups (anion-exchange groups). From the viewpoint of achieving a higher proton conductivity, the ion-exchange group is preferably a cation-exchange group, and the use of a polymer electrolyte having cation-exchange groups can provide a fuel cell better in power generating performance. Examples of the cation-exchange group include a sulfonic acid group (—SO₃H), a carboxyl group (—COOH), a phosphonic acid group (—P(O)(OH)₂), a hydroxyphosphoryl group (—P(O)(OH)—), a sulfonylimide group (—SO₂NHSO₂—) and a phenolic hydroxyl group. Above all, the cation-exchange group is more preferably a sulfonic acid group or a phosphonic acid group, and especially preferably a sulfonic acid group. These ion-exchange groups may be partially or wholly replaced by metal ions or quaternary ammonium ions to form salts, and when a polymer electrolyte is used as a member for a fuel cell, it is preferable that the ion-exchange groups be substantially wholly in the form of free acids.

The content of ion-exchange groups in a polymer electrolyte greatly influences the ion conductivity of a polymer electrolyte membrane, and a preferable content thereof depends on the structure of the polymer electrolyte. For example, in this embodiment, the introduced amount of the ion-exchange groups in the polymer electrolyte is preferably 0.5 to 6.0 meq/g, and more preferably 1.5 to 5.0 meq/g, in terms of ion-exchange capacity. The ion-exchange capacity of the polymer electrolyte being 0.5 meq/g or more can provide a high water content and a sufficient ion (proton) conductivity. An ion-exchange capacity thereof of 6.0 meq/g or less is likely to result in a good water resistance to be exhibited when the polymer electrolyte is made into a polymer electrolyte membrane.

The molecular weight of a polymer electrolyte is preferably 5000 to 1000000, and more preferably 15000 to 600000, in terms of a polystyrene-equivalent number-average molecular weight. As such, the strength of a polymer electrolyte membrane is likely to be good. The number-average molecular weight is measured by gel permeation chromatography (GPC).

As a polymer electrolyte, both of a fluoropolymer electrolyte such as Nafion containing fluorine in the main chain structure and a hydrocarbon polymer electrolyte containing no fluorine in the main chain structure are applicable as described before, but a hydrocarbon polymer electrolyte is preferable. A polymer electrolyte may contain a combination of a fluorine type and a hydrocarbon type, but in this case, a hydrocarbon type is preferably contained as a main component.

The hydrocarbon polymer electrolyte is preferably an aromatic polymer electrolyte having aromatic rings in the main chain, and examples thereof include polymer electrolyte s such as a polyimide type, a polyarylene type, a polyethersulfone type and a polyphenylene type. These may be contained singly or in combination of two or more. Further, it is preferable that ion-exchange groups be directly bonded to aromatic rings constituting the main chain of the aromatic polymer electrolyte.

The polymer electrolyte according to the present invention preferably contains a polymer comprising a structural unit having an ion-exchange group and a structural unit having no ion-exchange group because if so it is excellent in the proton conductivity and mechanical strength. Further, it is preferable that in the polymer, at least one of structural units having an ion-exchange group have an aromatic group, and at least one of structural units having no ion-exchange group have an aromatic group. Such a polymer is more suitably a polyarylene polymer.

Here, a polyarylene polymer refers to a compound having a form in which aromatic rings constituting the main chain are substantially directly bonded. A higher proportion of direct bonds between aromatic rings constituting a polymer main chain to the total number of bonds between the aromatic rings, which is likely to successfully result in a more improvement in radical resistance, is preferred, and specifically, the proportion of direct bonds is preferably 80% or higher, more preferably 90% or higher, and still more preferably 95% or higher, based on 100% of the total number of bonds between the aromatic rings. Bonds except a direct bond are in a form in which aromatic rings are bonded together through a divalent atom or a divalent group of atoms.

Direct bonding of ion-exchange groups to aromatic rings constituting the main chain of a polyarylene can provide a polymer electrolyte membrane simultaneously satisfying both a high proton conductivity and a practically sufficient water resistance. Therefore, the higher the proportion of structural units in which an ion-exchange group is directly bonded to an aromatic ring constituting the main chain of a polyarylene polymer among structural units having ion-exchange groups in the polyarylene polymer, the more likely a proton conductive membrane excellent in water resistance will be obtained even if the ion-exchange capacity is increased. With respect to the amount of ion-exchange groups, the proportion of structural units having in the main chain aromatic rings to which ion-exchange groups are directly bonded is preferably 20 mol % or more, more preferably 30 mol % or more, and still more preferably 50 mol % or more, based on 100 mol % of the total of the structural units constituting a polyarylene polymer.

In the polyarylene polymer described above, part or all of aromatic rings constituting the main chain have at least one group (hereinafter, sometimes referred to as “aromatic ring substituent”) selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent.

Examples of the alkyl group having 1 to 20 carbon atoms that may have a substituent include alkyl groups having 1 to 20 carbon atoms, such as a methyl group, an ethyl group, a n-propyl group, an isopropyl group, a n-butyl group, a sec-butyl group, an isobutyl group, a n-pentyl group, a 2,2-dimethylpropyl group, a cyclopentylic group, a n-hexyl group, a cyclohexyl group, a 2-methylpentyl group, a 2-ethylhexyl group, a nonyl group, a dodecyl group, a hexadecyl group, an octadecyl group and an icosyl group, and include these alkyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the alkoxy group having 1 to 20 carbon atoms that may have a substituent include alkoxy groups having 1 to 20 carbon atoms, such as a methoxy group, an ethoxy group, a n-propyloxy group, an isopropyloxy group, a n-butyloxy group, a sec-butyloxy group, a tert-butyloxy group, an isobutyloxy group, a n-pentyloxy group, a 2,2-dimethylpropyloxy group, a cyclopentyloxy group, a n-hexyloxy group, a cyclohexyloxy group, a 2-methylpentyloxy group, 2-ethylhexyloxy group, a dodecyloxy group, a hexadecyloxy group and an eicosyloxy group, and include these alkoxy groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryl group having 6 to 20 carbon atoms that may have a substituent include aryl groups such as a phenyl group, a naphthyl group, a phenanthrenyl group and an anthracenyl group, and include these aryl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryloxy group having 6 to 20 carbon atoms that may have a substituent include aryloxy groups such as a phenoxy group, a naphthyloxy group, a phenanthrenyloxy group and an anthracenyloxy group, and include these aryloxy groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the acyl group having 2 to 20 carbon atoms that may have a substituent include acyl groups having 2 to 20 carbon atoms, such as an acetyl group, a propionyl group, a butyryl group, an isobutyryl group, a pivaloyl group, a benzoyl group, a 1-naphthoyl group and a 2-naphthoyl group, and include these acyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Among these aromatic ring substituents, aryl groups such as a phenyl group, a naphthyl group, a phenanthrenyl group and an anthracenyl group, aryloxy groups such as a phenoxy group, a naphthyloxy group, a phenanthrenyloxy group and an anthracenyloxy group, and acyl groups having an aromatic ring such as a benzoyl group, a 1-naphthoyl group or a 2-naphthoyl group are likely to provide a polymer with a good heat resistance, and can provide a more practical member for a fuel cell, which groups are preferable.

The polyarylene polymer described above comprises a structural unit having such an aromatic ring substituent and a structural unit having an ion-exchange group, but may be a polyarylene structure having one same structural unit which has an aromatic ring substituent and an ion-exchange group together, and in which the ion-exchange group is directly bonded to an aromatic ring constituting the main chain, or may be a polymer comprising such a structural unit.

A polymer may be a form which comprises separately a structural unit in which an ion-exchange group is directly bonded to an aromatic ring constituting the main chain, and a structural unit having no ion-exchange group, these structural units being copolymerized. In this case, the copolymerization mode is not especially limited, but is preferably random polymerization in consideration of the ease of polymer production and the uniform dispersibility of water in a polymer electrolyte membrane.

An example of the structural unit in which an ion-exchange group is directly bonded to an aromatic ring constituting the main chain includes a structural unit represented by the following formula (1):

[Chemical Formula 10]

Ar¹ (1)

In the formula (1), Ar¹ denotes a divalent aromatic group, and the divalent aromatic group may have at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. Ar¹ is an aromatic group to whose aromatic ring constituting the main chain at least one ion-exchange group is directly bonded. Specific examples of optional groups which Ar¹ may have, that is, alkyl groups, alkoxy groups, aryl groups, aryloxy groups and acyl groups, are the same as the examples described above as aromatic ring substituents.

Examples of Ar¹ include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. Above all, monocyclic aromatic groups are preferable as Ar¹.

The structural unit represented by the above formula (1) having a suitable monocyclic aromatic group preferably includes a structural unit represented by the following formula (2):

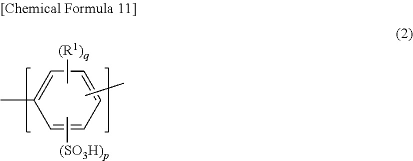

In the formula (2), R¹ denotes a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent, and specific examples of these are the same as the examples described above as the aromatic ring substituent. p denotes an integer of 1 to 3, q denotes an integer of 0 to 3, p+q is an integer of 4 or less, and in the case where q is 2 or 3, the plurality of le may be identical or different from each other. p, which indicates the number of sulfonic acid groups bonded, is more preferably 1 or 2.

Here, a suitable method for producing a polyarylene polymer comprising a structural unit represented by the above formula (2) will be described.

Here, a method for incorporating a sulfonic acid group may be a method in which a monomer having a sulfonic acid group in advance is polymerized, or a method in which after a prepolymer is produced from a monomer having a site to which a sulfonic acid group can be incorporated, a sulfonic acid group is incorporated. Among these, the former method is more preferable because the amount of a sulfonic acid group incorporated and the substitution position can accurately be controlled. In the case of using a monomer having a sulfonic acid group in advance, part or all of the sulfonic acid groups may be protected with a suitable protecting group to make protected sulfonic acid groups. Then, the monomer having the protected sulfonic acid group may be polymerized, and then the protected sulfonic acid groups present in an obtained polymer may be deprotected to obtain a polymer having sulfonic acid groups.

An example of a method for producing a polyarylene polymer by using a monomer having a sulfonic acid group include a method in which a monomer represented by the formula (3) shown below is polycondensed in the presence of a zero-valent transition metal complex.

Q-Ar¹⁰-Q (3)

In the formula (3), Ar¹⁰ denotes a divalent aromatic group that may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and one or more sulfonic acid groups and/or groups capable of being converted into sulfonic acid groups (sulfonic acid precursor groups) are bonded to aromatic rings constituting the main chain. Q denotes a group to leave in condensation reaction, and two Q may be identical or different from each other.

By copolymerizing a monomer represented by the above formula (3) and a monomer represented by the formula (4) shown below, a copolymer can be obtained which comprises a structural unit having a sulfonic acid group and a structural unit having no sulfonic acid group.

Q-Ar⁰-Q (4)

In the formula (4), Ar⁰ denotes a divalent aromatic group, and the divalent group has at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. Specific examples of an optional group which Ar⁰ may have, that is, an alkyl group, an alkoxy group, an aryl group, an aryloxy group and an acyl group, are the same as the examples described above as the aromatic ring substituent. Q denotes a group to leave in condensation reaction, and two Q may be identical or different from each other.

If, in such a way, a monomer represented by the formula (3) and a monomer represented by the formula (4) are copolymerized, and as required, sulfonic acid precursor groups are converted into a sulfonic acid group, a polymer can be obtained which has a polyarylene structure which comprises a structural unit represented by the formula (3a) and a structural unit represented by the formula (4a), and in which Ar¹⁰ and Ar⁰ are linked via a direct bonds.

[Chemical Formula 12]

Ar¹⁰ (3a)

In the formula (3a), Ar¹⁰ has the same meaning as described above.

[Chemical Formula 13]

Ar⁰ (4a)

In the formula (4a), Ar⁰ has the same meaning as described above.

In the formulae (3) and (4), Q each independently denote a group to leave in condensation reaction, and specific examples thereof include halogen atoms such as a chlorine atom, a bromine atom and an iodine atom, a p-toluenesulfonyloxy group, a methanesulfonyloxy group, a trifluoromethanesulfonyloxy group and groups containing a boron atom represented by the following formula (4b):

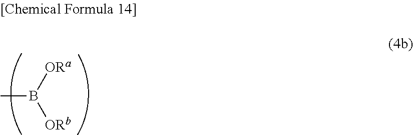

wherein in the formula (4b), R^{a} and R^{b} each independently denote a hydrogen atom or a monovalent organic group, and R^{a} and R^{b} may bond to form a ring.

Examples of the monomer represented by the formula (3) include 2,4-dichlorobenzenesulfonic acid, 2,5-dichlorobenzenesulfonic acid, 3,5-dichlorobenzenesulfonic acid, 2,4-dichloro-5-methylbenzenesulfonic acid, 2,5-dichloro-4-methylbenzenesulfonic acid, 2,4-dichloro-5-methoxybenzenesulfonic acid, 2,5-dichloro-4-methoxybenzenesulfonic acid, 3,3′-dichlorobiphenyl-2,2′-disulfonic acid, 4,4′-dichlorobiphenyl-2,2′-disulfonic acid, 4,4′-dichlorobiphenyl-3,3′-disulfonic acid and 5,5′-dichlorobiphenyl-2,2′-disulfonic acid. Monomers can be used in which chlorine atoms present in these monomers described above are replaced by groups to leave in the condensation reaction described before. Further, sulfonic acid groups of these monomers may form salts, and monomers having sulfonic acid precursor groups in place of sulfonic acid groups can be used. In the case where a sulfonic acid group forms a salt, a counter ion thereof is preferably alkaline metal ions, and especially preferably a Li ion, a Na ion and a K ion. The sulfonic acid precursor group is preferably one which can be converted into a sulfonic acid group by a simple operation such as hydrolysis treatment or oxidation treatment. Particularly in order to produce the polyarylene copolymer according to the present embodiment, use of a monomer having a sulfonic acid group in a form of a salt, or a monomer having a sulfonic acid precursor group is preferable from the viewpoint of polymerization reactivity.

The sulfonic acid precursor group is preferably one having a form in which a sulfonic acid group forms an ester or an amide and is protected, like sulfonate ester groups (—SO₃R^{c}, wherein R^{c} denotes an alkyl group having 1 to 20 carbon atoms), or sulfonamide groups (—SO₂N(R^{d})(R^{e}), wherein R^{d} and R^{e} each independently denote a hydrogen atom, an alkyl group having 1 to 20 carbon atoms, or an aromatic group having 3 to 20 carbon atoms). Examples of the sulfonate ester include methyl sulfonate, an ethyl sulfonate group, n-propyl sulfonate, isopropyl sulfonate, a n-butyl sulfonate group, a sec-butyl sulfonate group, tert-butyl sulfonate, n-pentyl sulfonate, neopentyl sulfonate, n-hexyl sulfonate, cyclohexyl sulfonate, n-heptyl sulfonate, n-octyl sulfonate, n-nonyl sulfonate, n-decylsulfonate, n-dodecylsulfonate, n-undecylsulfonate, n-tridecylsulfonate, n-tetradecylsulfonate, n-pentadecylsulfonate, n-hexadecylsulfonate, n-heptadecylsulfonate, n-octadecylsulfonate, n-nonadecylsulfonate and n-eicosyl sulfonate, and are preferably sec-butyl sulfonate, neopentyl sulfonate and cyclohexyl sulfonate. These sulfonate esters may be substituted with a substituent not influencing the polymerization reaction.

Examples of the sulfonamide include a sulfonamide group, an N-methylsulfonamide group, an N,N-dimethylsulfonamide group, an N-ethylsulfonamide group, an N,N-diethylsulfonamide group, an N-n-propyl sulfonamide group, a di-n-propylsulfonamide group, an N-isopropylsulfonamide group, an N,N-diisopropylsulfonamide group, an N-n-butylsulfonamide group, an N,N-di-n-butylsulfonamide group, an N-sec-butylsulfonamide group, an N,N-di-sec-butylsulfonamide group, an N-tert-butylsulfonamide group, an N,N-di-tert-butylsulfonamide group, an N-n-pentylsulfonamide group, an N-neopentylsulfonamide group, an N-n-hexylsulfonamide group, an N-cyclohexylsulfonamide group, an N-n-heptylsulfonamide group, an N-n-octylsulfonamide group, an N-n-nonylsulfonamide group, an N-n-decylsulfonamide group, an N-n-dodecylsulfonamide group, an N-n-undecylsulfonamide group, an N-n-tridecylsulfonamide group, an N-n-tetradecylsulfonamide group, an N-n-pentadecylsulfonamide group, an N-n-hexadecylsulfonamide group, an N-n-heptadecylsulfonamide group, an N-n-octadecylsulfonamide group, an N-n-nonadecylsulfonamide group, an N-n-eicosylsulfonamide group, an N,N-diphenylsulfonamide group, an N,N-bistrimethylsilylsulfonamide group, an N,N-bis-tert-butyldimethylsilylsulfonamide group, a pyrrolylsulfonamide group, a pyrrolidinylsulfonamide group, a piperidinylsulfonamide group, a carbazolylsulfonamide group, a dihydroindolylsulfonamide group and a dihydroisoindolylsulfonamide group, and are preferably an N,N-diethylsulfonamide group, an N-n-dodecylsulfonamide group, a pyrrolidinylsulfonamide group and a piperidinylsulfonamide group. These sulfonamide groups may be substituted with a substituent not influencing the polymerization reaction.

As the sulfonic acid precursor group, a mercapto group can be used. A mercapto group can be converted into a sulfonic acid group by using an appropriate oxidizing agent to oxidize the mercapto group. The sulfonic acid precursor group can be used in combination with sulfonate esters described before, an amide group, a mercapto group and the like.

Then, a method for producing the polyarylene copolymer according to the present embodiment by producing in advance a prepolymer having sites to which sulfonic acid groups can be incorporated, and incorporating sulfonic acid groups to the prepolymer, will be described. In this case, a monomer represented by the formula (5) shown below, and as required, a monomer having no sulfonic acid group are copolymerized by condensation reaction, and thereafter, sulfonic acid groups are incorporated according to a known method to produce a polyarylene copolymer.

Q-Ar²-Q (5)

In the formula (5), Ar² denotes a divalent aromatic group capable of becoming Ar¹ in the formula (1) described above by incorporating a sulfonic acid group; and Q has the same meaning as described above, and two Q may be identical or different from each other.

The polyarylene copolymer described above can be produced also by a series of operations in which a monomer represented by the formula (5) and a monomer represented by the formula (4) are copolymerized to synthesize a prepolymer comprising a structural unit represented by the formula (5a) shown below and a structural unit represented by the above formula (4a), and a sulfonic acid group is incorporated to an aromatic ring constituting the main chain in the structural unit represented by the formula (5a):

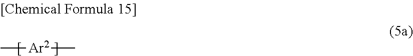

wherein in the formula (5a), Ar² has the same meaning as described above.

In the formula (5a), Ar² denotes a divalent aromatic group that may have at least one aromatic ring substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and Ar² is a divalent aromatic group having a structure in which at least one sulfonic acid group can be incorporated. Examples of the divalent aromatic group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. Examples of alkyl groups, alkoxy groups, aryl groups, aryloxy groups and acyl groups are the same as the examples described above as the aromatic ring substituent.

The structure of Ar² in which a sulfonic acid group can be incorporated indicates a structure in which an aromatic ring has a functional group, such as a hydrogen atom, directly bonded to the aromatic ring, to which a sulfonic acid group can be incorporated. In the case where a sulfonic acid group is incorporated to an aromatic ring by the electrophilic substitution reaction described later, a hydrogen atom bonded to an aromatic ring can be regarded as a functional group to which a sulfonic acid group can be incorporated.

Specific examples of the monomer represented by the above formula (5) include 1,3-dichlorobenzene, 1,4-dichlorobenzene, 1,3-dichloro-4-methoxybenzene, 1,4-dichloro-3-methoxybenzene, 4,4′-dichlorobiphenyl, 4,4′-dichloro-3,3′-dimethylbiphenyl, 4,4′-dichloro-3,3′-dimethoxybiphenyl, 1,4-dichloronaphthalene, 1,5-dichloronaphthalene, 2,6-dichloronaphthalene and 2,7-dichloronaphthalene. Monomers can also be used in which chloro groups are replaced by groups to leave, whose examples are described above, in condensation reaction.

A method for incorporating a sulfonic acid group to a structural unit represented by the formula (5a) includes a method in which an obtained prepolymer is dissolved or dispersed in concentrated sulfuric acid, or partially dissolved in an organic solvent, and thereafter, is reacted with concentrated sulfuric acid, chloro sulfuric acid, fuming sulfuric acid, sulfur trioxide or the like to convert hydrogen atoms to sulfonic acid groups.

Here, specific examples of structural units constituting a polyarylene copolymer will be described. Examples of structural units having an ion-exchange group, if shown in forms having a sulfonic acid group as an ion-exchange group, include structural units represented by the chemical formulae (6-1) to (6-12) shown below, respectively.

(Specific examples of structural units having a sulfonic acid group)

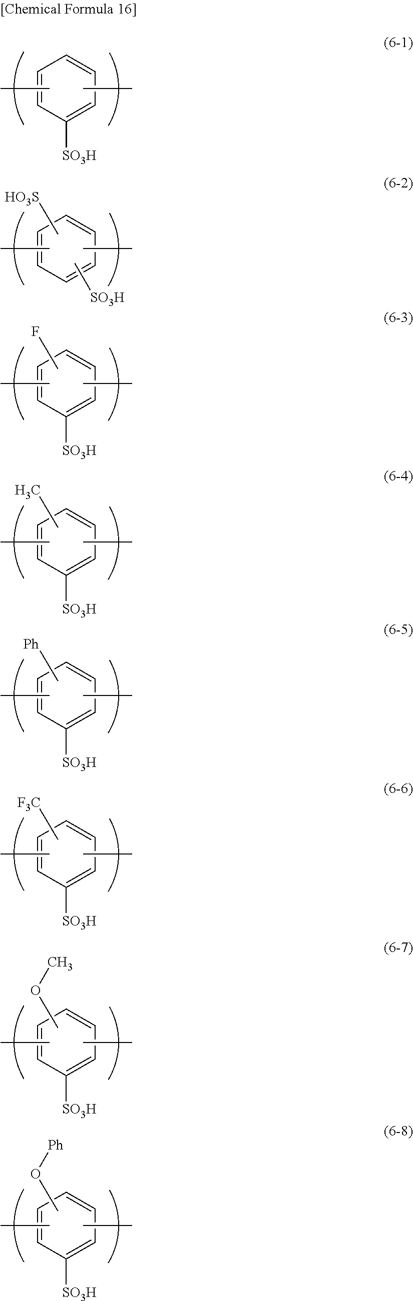

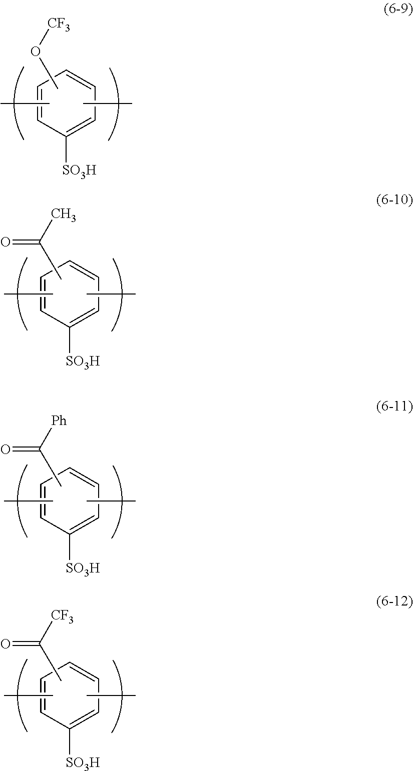

Specific examples of structural units having an aromatic ring substituent include structural units represented by the chemical formulae (6-13) to (6-32) shown below, respectively.

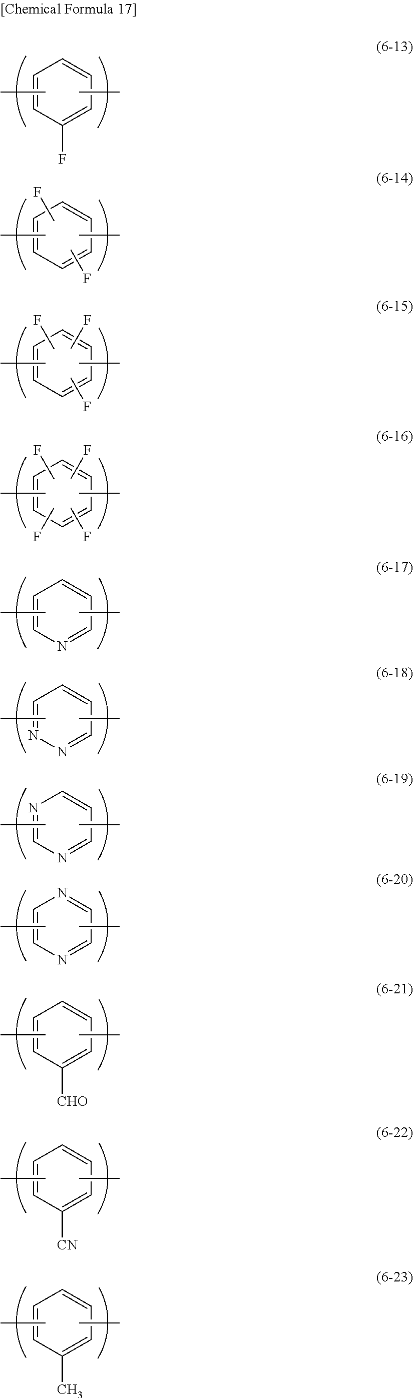

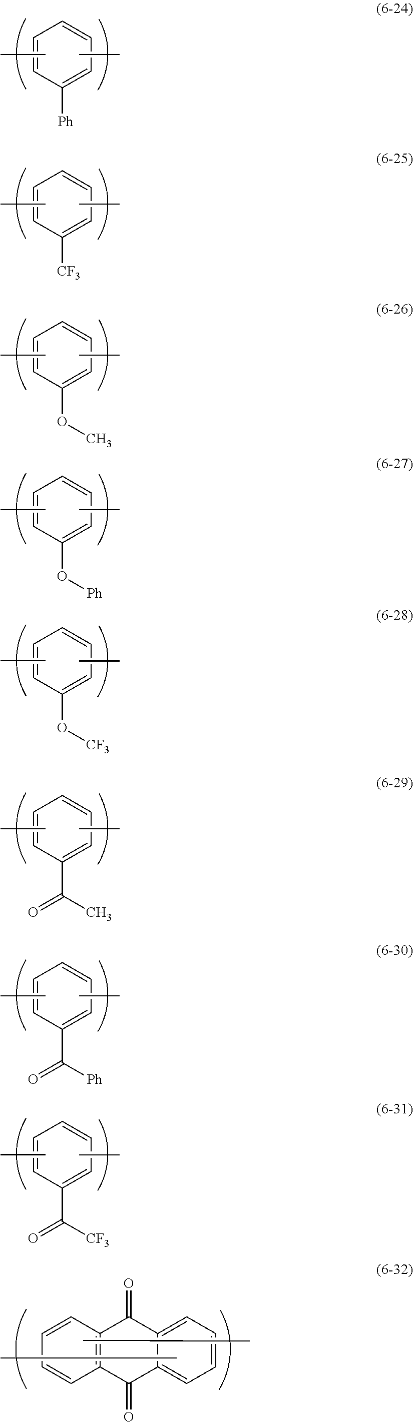

In these examples of structural units, “-Ph” denotes a phenyl group.

The polymer electrolyte membrane according to the present invention can become one having a better radical resistance by using the polyarylene copolymer as described above as a polymer electrolyte.

When the polymer electrolyte membrane according to the present invention is used as a member for a fuel cell, such as a proton conductive membrane, these aromatic ring substituents can develop a water resistance in a high level of the member. Among these aromatic ring substituents, an aryl group such as a phenyl group, a naphthyl group, a phenanthrenyl group or an anthracenyl group, an aryloxy group such as a phenoxy group, a naphthyloxy group, a phenanthrenyloxy group or an anthracenyloxy group, and an acyl group having an aromatic ring, such as a benzoyl group, a 1-naphthoyl group or a 2-naphthoyl group are likely to provide the polymer electrolyte membrane with a good heat resistance, then providing a more practical member for a fuel cell, which is preferable.

The present inventors have found that among such aromatic ring substituents, acyl groups having an aromatic ring are especially useful. A polymer electrolyte comprising a polymer having such acyl groups as an aromatic ring substituent is likely to develop a better proton conductivity. The cause has not been clarified, but it is presumed that the electrophilicity of acyl groups makes high the ion dissociability of sulfonic acid groups present in the polymer. Further in the case of having acyl groups as an aromatic ring substituent, two structural units each having the acyl group are adjacent, and the acyl groups in the two structural units are bonded, or after the acyl groups are bonded in such a way, the bonded acyl groups undergo the rearrangement reaction, in some cases. Whether or not aromatic ring substituents have been bonded or the rearrangement reaction has occurred after the bonding in such a way can be confirmed, for example, by the measurement of ¹³C-nuclear magnetic resonance spectra.

The polymer electrolyte according to the present invention may alternatively be a polyarylene block copolymer comprising a block having ion-exchange groups and a block having substantially no ion-exchange group, wherein the main chain of the block having ion-exchange groups has a polyarylene structure in which a plurality of aromatic rings are substantially directly bonded. Further, it is preferable that an ion-exchange group be directly bonded to an aromatic ring constituting the main chain, and specific examples of such a structural unit include ones described before. Here, “having substantially no ion-exchange group” means that the number of ion-exchange groups per repeating unit of a block is about 0.1 or less. “A polyarylene structure” is a form in which aromatic rings constituting the main chain are substantially bonded via a direct bond, and specifically has preferably a structure having a proportion of direct bonds of 80% or more, more preferably a structure having that of 90% or more, and still more preferably a structure having that of 95% or more, based on 100% of the total number of bonds of the aromatic rings. Bonds except a direct bond refer to a form in which aromatic rings are bonded together through a divalent atom or a divalent atom group.

The block having substantially no ion-exchange group is preferably a block having a structure represented by the formula (7) shown below, and more preferably a block having only the structure represented by the following formula (7):

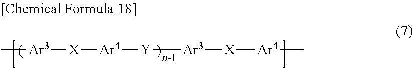

wherein n denotes an integer of 3 or more and 45 or less, and preferably 40 or less, more preferably 35 or less, and still more preferably 20 or less; and n is preferably 6 or more, more preferably 11 or more, and still more preferably 15 or more.

Ar³ and Ar⁴ in the above formula (7) each independently denote an arylene group. Examples of the arylene group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. The arylene group is preferably a divalent monocyclic aromatic group.

Ar³ and Ar⁴ each may have at least one substituent selected from the group consisting of aromatic ring substituents described before.

X in the above formula (7) denotes one of a carbonyl group (—C(═O)—) or a sulfonyl group (—S(═O)₂—). Y denotes one of an oxygen atom (—O—) and a sulfur atom (—S—).

In the polyarylene block copolymer according to the present invention, the block having substantially no ion-exchange group is preferably represented by the following formula (8):

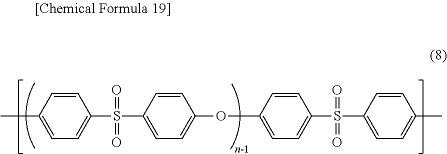

wherein in the formula (8), n has the same meaning as described above.

A suitable method for producing a block copolymer in which a polyarylene polymer having ion-exchange groups and a polymer comprising a structure represented by the above formula (7) are linked via a covalent bond to make a long chain includes a method using a block precursor having substantially no ion-exchange group represented by the formula (7a) shown below in place of the monomer represented by the formula (4) in the suitable method for producing the polyarylene polymer described above.

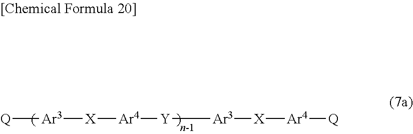

In the formula (7a), Ar³, Ar⁴, n, X and Y have the same meanings as described above.

A suitable typical example of a precursor represented by the above formula (7a) includes a monomer represented by the formula (8a) shown below. In the formula (8a), n and Q have the same meanings as described above.

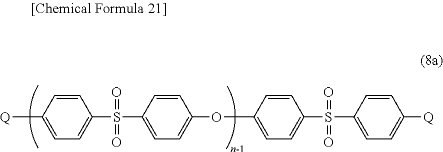

Then, a method for fabricating a polymer electrolyte membrane comprising the polymer electrolyte described above will be described. The polymer electrolyte membrane can be produced by an application step of applying a solution containing the polymer electrolyte described above on a predetermined base material, and a solvent removal step of removing a solvent from a membrane (applied membrane) of the solution applied.

Application of a solution containing a polymer electrolyte in the application step can be carried out, for example, by a cast method, a dip method, a grade coat method, a spin coat method, a gravure coat method, a flexographic printing method, an inkjet method or the like. It is important that the size and the thickness of the applied membrane obtained by the application step described above are suitably optimized depending on the capacity, the shape, the size and the like of an apparatus used for the solvent removal step. A criterion thereof involves an optimization of the application condition in the application step described above so as to make the removal of the solvent from the applied membrane in the solvent removal step to be relatively uniform and to hold the distribution of the remaining solvent amount in the plane of the applied membrane in a more uniform state. The cast method is a method having been broadly used in this field as a method for producing polymer electrolyte membranes, and industrially especially useful.

In production of a polymer electrolyte membrane by the cast method, specifically, the above-mentioned polymer electrolyte is dissolved in a solvent to first prepare a polymer electrolyte solution. At this time, as required, other components including other polymers and additives may be added.

The material of a base material on which a solution is applied is preferably a material which is chemically stable and insoluble in a solvent to be used. Further, the base material is more preferably one in which after the formation of a polymer electrolyte membrane, the obtained membrane can easily be washed, and moreover, the membrane can easily be peeled. Examples of such a base material include plates and films composed of glass, polytetrafluoroethylene, polyethylene or polyester (polyethylene terephthalate or the like).

As the base material, a long base material seamless in the plane direction is preferably used. If a base material with any seam is used, an applied membrane having a uniform membrane thickness can hardly be obtained, and there consequently arises trouble that the evaporation of a solvent in the evaporation step becomes relatively nonuniform in some cases. Use of a long base material allows a long polymer electrolyte membrane to be easily formed, and therefore brings about high productivity and is industrially advantageous. Therefore, as the base material, a seamless base material is suitable. Such a base material has, for example, preferably a length at least in one direction of 1 m or longer, more preferably 5 m or longer, and still more preferably 10 m or longer. If so, the productivity of a polymer electrolyte membrane can be made better.

The solvent described above is not especially limited as long as the solvent can dissolve the polymer electrolyte, and can be removed thereafter. Examples of the solvent to be suitably used are aprotic polar solvents such as dimethylformamide (DMF), dimethylacetamide (DMAc), N-methyl-2-pyrrolidone (NMP) and dimethyl sulfoxide (DMSO), chlorine-containing solvents such as dichloromethane, chloroform, 1,2-dichloroethane, chlorobenzene and dichlorobenzene, alcohols such as methanol, ethanol and propanol, and alkylene glycol monoalkyl ethers such as ethylene glycol monomethyl ether, ethylene glycol monoethyl ether, propylene glycol monomethyl ether and propylene glycol monoethyl ether. The solvent may be used singly or as a mixture of two or more. Above all, DMSO, DMF, DMAc, NMP or a mixed solvent composed of two or more solvents selected from these is preferably used because the solubility of the polymer electrolyte therein is high.

The thickness (membrane thickness) of a polymer electrolyte membrane is not especially limited, but is preferably 1 to 300 μm, more preferably 5 to 100 μm, and still more preferably 5 to 50 μm, in the practical range as a proton conductive membrane (diaphragm) for a fuel cell. A membrane having a membrane thickness of 1 μm or more has an excellent practical strength, which is preferable; and a membrane of 300 μm or less is likely to have a low membrane resistance itself, which is preferable. The membrane thickness can be controlled by the concentration of a polymer electrolyte solution and the application thickness of the polymer electrolyte membrane precursor described above on a support base material.

In order to improve various physical properties of a membrane, a polymer electrolyte membrane solution may be prepared by adding additives such as a plasticizer, a stabilizer and a release agent as used in common polymers. Further in order to facilitate water control in fuel cell applications, also addition of inorganic or organic microparticles as a water retention agent is known. Any of these known methods can be used unless being contrary to the object of the present invention. In order to improve the mechanical strength or the like, a polymer electrolyte membrane thus obtained may be subjected to a treatment such as irradiation of an electron beam, radiation or the like.

Although depending on types of polymer electrolyte membranes, if the water absorption rate of a polymer electrolyte membrane is high, since there arises a possibility of breakage of a fuel cell due to water absorption expansion of the membrane during driving of the fuel cell, the water absorption rate is preferably 340% or less, more preferably 300% or less, still more preferably 250% or less, and very preferably 200% or less.

The polymer according to the present invention is characterized in that it comprises a polyarylene structure in which the main chain is composed of a plurality of aromatic rings bonded substantially directly together, and that the polymer has sulfonic acid groups directly bonded to a part or all of the aromatic rings constituting the main chain, and also that the amount of the sulfonic acid groups is more than 3.0 meq/g in terms of the sulfonic acid group equivalent weight per unit weight of the polymer, that is, the ion-exchange capacity. Here, the ion-exchange capacity refers to a value measured by an ion-exchange capacity measurement described below. The sulfonic acid group mentioned in the present invention means a group represented by —SO₃H when represented by a form of a free acid.

[Measurement of the Ion-Exchange Capacity]

A polymer used for the measurement is formed as a polymer membrane by a solution cast method; the formed polymer membrane is cut into a suitable weight; and the dry weight of the cut polymer membrane is measured using a halogen moisture percentage tester set at a heating temperature of 105° C. Then, the membrane is immersed in 5 mL of 0.1 mol/L sodium hydroxide aqueous solution, and thereafter, 50 mL of ion-exchange water is further added thereto, and the solution is allowed to be left for 2 hours. Thereafter, 0.1 mol/L hydrochloric acid is gradually added to the solution in which the polymer membrane is immersed to titrate the solution to determine a point of neutralization, and the ion-exchange capacity (unit: meq/g) of the polymer is calculated from the dry weight of the polymer membrane used (the cut polymer membrane) and the amount of hydrochloric acid used for the neutralization.

In the polymer according to the present invention, part or all of aromatic rings constituting the main chain has at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. Hereinafter, such a group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, is referred to as “an aromatic ring substituent”.

Here, the above polyarylene structure will be described. The polymer according to the present invention has a Rain in which aromatic rings constituting the main chain are substantially bonded through direct bonds, and a higher proportion of direct bonds of aromatic rings constituting the polymer main chain to the total number of bonds of the aromatic rings is likely to achieve a more improvement in the water resistance, which is preferable. Specifically, the proportion of direct bonds is preferably 80% or higher, more preferably 90% or higher, and still more preferably 95% or higher, based on 100% of the total number of bonds of the aromatic rings. Bonds except a direct bond refer to a form in which aromatic rings are bonded together through a divalent atom or a divalent atom group.

The present inventors have found that the case where sulfonic acid groups present in a polymer are directly bonded to aromatic rings constituting the main chain of the polymer is more advantageous from the viewpoint of simultaneously satisfying both a proton conductivity in a high level and an excellent water resistance than the case where the sulfonic acid groups are bonded to the aromatic rings constituting the main chain of the polymer through appropriate linking groups. Therefore, a higher proportion of structural units in which a sulfonic acid group is directly bonded to an aromatic ring constituting the main chain in structural units having a sulfonic acid group in the polymer is more likely to provide a proton conductive membrane excellent in water resistance even if the sulfonic acid group equivalent weight, that is, the ion-exchange capacity is increased. The amount of sulfonic acid groups is determined such that the ion-exchange capacity of a polymer exceeds 3.0 meq/g. The proportion of structural units having aromatic rings to which sulfonic acid groups are directly bonded, in the main chain is preferably 20 mol % or more, more preferably 30 mol % or more, and still more preferably 50 mol % or more, based on 100 mol % of the total of the structural units constituting the polymer. These sulfonic acid groups may be partially or wholly replaced by metal ions, quaternary ammonium ions and the like to form salts, but these are preferably substantially wholly in a form of a free acid.

In the polymer according to the present invention, part or all of aromatic rings constituting the main chain have aromatic ring substituents. As examples of the aromatic ring substituents, examples of the alkyl group having 1 to 20 carbon atoms that may have a substituent include alkyl groups having 1 to 20 carbon atoms, such as a methyl group, an ethyl group, a n-propyl group, an isopropyl group, a n-butyl group, a sec-butyl group, an isobutyl group, a n-pentyl group, a 2,2-dimethylpropyl group, a cyclopentylic group, a n-hexyl group, a cyclohexyl group, a 2-methylpentyl group, a 2-ethylhexyl group, a nonyl group, a dodecyl group, a hexadecyl group, an octadecyl group and an icosyl group, and include these alkyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the alkoxy group having 1 to 20 carbon atoms that may have a substituent include alkoxy groups having 1 to 20 carbon atoms, such as a methoxy group, an ethoxy group, a n-propyloxy group, an isopropyloxy group, a n-butyloxy group, a sec-butyloxy group, a tert-butyloxy group, an isobutyloxy group, a n-pentyloxy group, a 2,2-dimethylpropyloxy group, a cyclopentyloxy group, a n-hexyloxy group, a cyclohexyloxy group, a 2-methylpentyloxy group, 2-ethylhexyloxy group, a dodecyloxy group, a hexadecyloxy group and an eicosyloxy group, and include these alkoxy groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryl group having 6 to 20 carbon atoms that may have a substituent include aryl groups such as a phenyl group, a naphthyl group, a phenanthrenyl group and an anthracenyl group, and include these aryl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryloxy group having 6 to 20 carbon atoms that may have a substituent include aryloxy groups such as a phenoxy group, a naphthyloxy group, a phenanthrenyloxy group and an anthracenyloxy group, and include these aryloxy groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the acyl group having 2 to 20 carbon atoms that may have a substituent include acyl groups having 2 to 20 carbon atoms, such as an acetyl group, a propionyl group, a butyryl group, an isobutyryl group, a pivaloyl group, a benzoyl group, 1-naphthoyl group and a 2-naphthoyl group, and include these acyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

When the polymer according to the present invention is used as a member for a fuel cell, such as a proton conductive membrane, these aromatic ring substituents can highly develop the water resistance of the member. Among these aromatic ring substituents, aryl groups such as a phenyl group, a naphthyl group, a phenanthrenyl group and an anthracenyl group, aryloxy groups such as a phenoxy group, a naphthyloxy group, a phenanthrenyloxy group and an anthracenyloxy group, and acyl groups having an aromatic ring such as a benzoyl group, a 1-naphthoyl group or 2-naphthoyl group are likely to provide a polymer with a good heat resistance, and can provide a more practical member for a fuel cell, which groups are preferable.

The present inventors have found that among such aromatic ring substituents, an acyl group having an aromatic ring is especially useful. The polymer according to the present invention having such acyl groups as an aromatic ring substituent is likely to develop a better proton conductivity. The cause has not been clarified, but it is presumed that the electrophilicity of acyl groups makes high the ion dissociability of sulfonic acid groups present in the polymer. Further in the case of having acyl groups as an aromatic ring substituent, two structural units each having the acyl group are adjacent, and the acyl groups present in the two structural units are bonded, or after the acyl groups are bonded in such a way, the bonded acyl groups undergo the rearrangement reaction, in some cases. Even in the case where aromatic ring substituents are linked, the case where an aromatic ring substituent after the bonding (after the rearrangement reaction) corresponds to any one of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, is included in the polymer according to the present invention. Whether or not a reaction has occurred such as bonding of aromatic ring substituents, or the rearrangement reaction after the bonding has occurred in such a way can be confirmed, for example, by the measurement of a ¹³C-nuclear magnetic resonance spectrum.

The polymer according to the present invention is a polymer having a polyarylene structure comprising a structural unit having such an aromatic ring substituent and a structural unit having a sulfonic acid group, but may have a polyarylene structure comprising a structural unit in which the same structural unit has an aromatic ring substituent and a sulfonic acid group together, and the sulfonic acid group is directly bonded to an aromatic ring constituting the main chain.

The polyarylene structure may be a form comprising a structural unit in which a sulfonic acid group is directly bonded to an aromatic ring constituting the main chain, and a structural unit having no sulfonic acid group (hereinafter, referred to as “non-sulfonic acid group structural unit”, which may have an aromatic ring substituent), and having these structural units copolymerized. In consideration of both the ease of making the ion-exchange capacity exceed 3.0 meq/g and the ease of production of a polymer, a copolymer comprising together a structural unit having a sulfonic acid group and a non-sulfonic acid group structural unit is especially preferable as the polymer according to the present invention. In the case where the polymer according to the present invention is such a copolymer, the copolymerization mode is not especially limited, but is preferably random polymerization from the viewpoint that the polymer according to the present invention can easily be produced.

An example of a structural unit in which a sulfonic acid group is directly bonded to an aromatic ring constituting the main chain includes the following formula (A-1).

[Chemical Formula 22]

Ar¹ (A-1)

In the formula (A-1), Ar¹ denotes a divalent aromatic group. The divalent aromatic group may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. Ar¹ is an aromatic group in which at least one sulfonic acid group is directly bonded to an aromatic ring constituting the main chain.

Examples of the optional groups (aromatic ring substituents) which may be contained in the formula (A-1) are the same as the examples described above as the aromatic ring substituent.

Examples of Ar¹ in the above formula (A-1) include aromatic groups in which a sulfonic acid group is directly bonded to an aromatic ring of a monocyclic aromatic group such as a 1,3-phenylene group and a 1,4-phenylene group, aromatic groups in which a sulfonic acid group is directly bonded to an aromatic ring of a condensed ring aromatic group such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and aromatic groups in which a sulfonic acid group is directly bonded to an aromatic ring of an aromatic heterocyclic group such as a pyridinediyl group, a quinoxalinediyl group and a thiophenediyl group, and include, further in addition to the aromatic groups described here as examples, aromatic groups having aromatic ring substituents. Above all, Ar¹ is preferably aromatic groups in which a sulfonic acid group is directly bonded to the monocyclic aromatic group or an aromatic ring of the monocyclic aromatic group, or aromatic groups in which a sulfonic acid group is directly bonded to the monocyclic aromatic group or an aromatic ring of the monocyclic aromatic group, and the monocyclic aromatic group or the aromatic ring of the monocyclic aromatic group further has an aromatic ring substituent. Further in consideration of the ease of production, Ar¹ is preferably aromatic groups in which a sulfonic acid group is directly bonded to the aromatic ring of the monocyclic aromatic group, or aromatic groups in which a sulfonic acid group is directly bonded to the monocyclic aromatic group, and the monocyclic aromatic group further has an aromatic ring substituent.

A structural unit represented by the formula (A-1) having a suitable monocyclic aromatic group preferably comprises a structural unit represented by the formula (A-2) shown below. Such a structural unit has advantages that a raw material commercially easily available can be used in production of the polymer according to the present invention described later, and the production itself of the raw material used in the production of the polymer is easy. Further, since the structural unit represented by the formula (A-2) has a low molar weight and thus the molar weight per sulfonic acid group is low, the structural unit represented by the formula (A-2) is advantageous in that the ion-exchange capacity of the polymer according to the present invention can easily be made more than 3.0 meq/g.

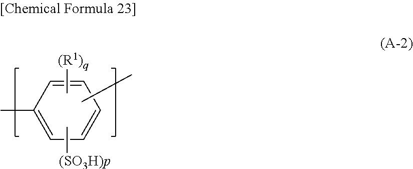

In the formula (A-2), R¹ denotes a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent. p denotes an integer of 1 or more and 3 or less, q denotes an integer of 0 or more and 3 or less, and p+q is an integer of 4 or less. In the case where q is 2 or more, the plurality of R¹ may be identical or different from each other. p, which indicates the number of sulfonic acid groups bonded, is more preferably 1 or 2.

Examples of groups represented by R¹ in the formula (A-2), that is, alkyl groups, alkoxy groups, aryl groups and acyl groups, are the same as the examples described above as the aromatic ring substituent, and such R¹ is preferably selected which does not inhibit the polymerization reaction in production (polymerization reaction) of a polymer described later.

While the polymer according to the present invention has an amount of the sulfonic acid group exceeding 3.0 meq/g in terms of ion-exchange capacity, the ion-exchange capacity is preferably 3.1 meq/g or more, and more preferably 3.2 meq/g or more. On the other hand, the upper limit of the ion-exchange capacity, which is determined according to the type of the structural unit constituting the polymer of the present invention, is preferably 6.0 meq/g or less, and more preferably 5.0 meq/g. If the upper limit of the ion-exchange capacity is in this range, the production of a polymer is easy, and an improvement in water resistance can be achieved more. The measurement method of the ion-exchange capacity is as already described.

The polymer according to the present invention has a molecular weight of preferably 5000 to 1000000, and especially preferably 15000 to 600000, in the polystyrene-equivalent number-average molecular weight.

Then, a suitable method for producing the polymer according to the present invention will be described.

A method for incorporating a sulfonic acid group may be a method in which a monomer having a sulfonic acid group (or a sulfonic acid precursor group) in advance is polymerized, or a method in which after a prepolymer is produced from a monomer having a site to which a sulfonic acid group can be incorporated, a sulfonic acid group is incorporated to the incorporatable site. Among these, the former method is more preferable because the amount of a sulfonic acid group incorporated and the substitution position can accurately be controlled. In the case of using the former method, the sulfonic acid group may be in a form of a free acid, or a form of a salt. The sulfonic acid group may be a sulfonic acid precursor group capable of easily being converted into a sulfonic acid group by hydrolysis treatment or the like. Details of the sulfonic acid precursor group mentioned here will be described later.

A method for producing the polymer according to the present invention by using a monomer having a sulfonic acid group will be described. The polymer according to the present invention can be produced, for example, by subjecting a monomer represented by the formula (A-3) to a condensation reaction in the presence of a zero-valent transition metal complex.

Q-Ar¹⁰-Q (A-3)

Here, Ar¹⁰ is a divalent aromatic group that may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and a sulfonic acid group and/or a sulfonic acid precursor group is bonded to an aromatic ring constituting the main chain. Q denotes a leaving group, and two Q may be identical or different from each other.

In the case of using a substance in which at least one monomer, among the monomers represented by the above formula (A-3), has an aromatic ring substituent, a resulting polymer is to have both a sulfonic acid group and an aromatic ring substituent together. However, in order to produce the polymer according to the present invention so that the ion-exchange capacity may exceed 3.0 meq/g, a method in which a first monomer from which a structural unit having a sulfonic acid group will be derived, and a second monomer from which a non-sulfonic acid structural unit will be derived are prepared separately as described below and these are then copolymerized is preferred because of its simplicity.

This method will be described: if a monomer represented by the above formula (A-3) is assigned to the first monomer, and is copolymerized with the second monomer described above represented by the formula (A-4) shown below, a copolymer comprising a structural unit having a sulfonic acid group, and a non-sulfonic acid structural unit can be obtained.

Q-Ar⁰-Q (A-4)

In the formula (A-4), Ar⁰ denotes a divalent aromatic group, and the divalent aromatic group has at least one group (aromatic ring substituent) selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. Here, examples of these aromatic ring substituents are the same as described before. The definition of Q is the same as in the above formula (A-3), and two Q may be identical or different from each other also in the formula (A-4).

If a monomer represented by the formula (A-3) and a monomer represented by the formula (A-4) are copolymerized in such a way, and as required, sulfonic acid precursor groups are converted into sulfonic acid groups, an obtained polymer comprises a structural unit represented by the formula (A-3a) and a structural unit represented by the formula (A-4a), and the polymer is obtained which has a polyarylene structure in which Ar¹⁰ and Ar⁰ are linked via a direct bond.

[Chemical Formula 24]

Ar¹⁰ (A-3a)

In the formula (A-3a), Ar¹⁰ has the same meaning as described above.

[Chemical Formula 25]

Ar⁰ (A-4a)

In the formula (A-4a), Ar⁰ has the same meaning as described above.

Q in the formula (A-3) and the formula (A-4) denotes a leaving group, and specific examples thereof include halogen atoms such as a chlorine atom, a bromine atom and an iodine atom, a p-toluenesulfonyloxy group, a methanesulfonyloxy group, a trifluoromethanesulfonyloxy group and groups containing a boron atom as described below:

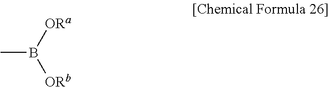

wherein R^{a} and R^{b} each independently denote a hydrogen atom or an organic group, and R^{a} and R^{b} may bond to form a ring.

Examples of the monomer represented by the formula (A-3) include 2,4-dichlorobenzenesulfonic acid, 2,5-dichlorobenzenesulfonic acid, 3,5-dichlorobenzenesulfonic acid, 2,4-dichloro-5-methylbenzenesulfonic acid, 2,5-dichloro-4-methylbenzenesulfonic acid, 2,4-dichloro-5-methoxybenzenesulfonic acid, 2,5-dichloro-4-methoxybenzenesulfonic acid, 3,3-dichlorobiphenyl-2,2′-disulfonic acid, 4,4′-dichlorobiphenyl-2,2′-disulfonic acid, 4,4′-dichlorobiphenyl-3,3′-disulfonic acid and 5,5′-dichlorobiphenyl-2,2′-disulfonic acid. Monomers can be used in which chlorine atoms present in these monomers are replaced by groups except the chlorine atoms among the leaving groups described above as examples. Further, sulfonic acid groups of these monomers may form salts, and monomers having sulfonic acid precursor groups in place of sulfonic acid groups can be used. In the case where a sulfonic acid group forms a salt, a counter ion thereof is preferably alkaline metal ions, and especially preferably Li ions, Na ions and K ions. The sulfonic acid precursor group is preferably one which can be converted into a sulfonic acid group by a simple operation such as hydrolysis treatment or oxidation treatment. Particularly in order to produce the polymer according to the present invention, use of a monomer having a sulfonic acid group in a form of a salt, or a monomer having a sulfonic acid precursor group is preferable from the viewpoint of polymerization reactivity.

The sulfonic acid precursor group is preferably a group in which a sulfonic acid group forms an ester or an amide and is protected, like a sulfonate ester group (—SO₃R^{c}, wherein R^{c} denotes an alkyl group having 1 to 20 carbon atoms), or a sulfonamide group (—SO₂N(R^{d})(R^{e}), wherein R^{d} and R^{e} each independently denote a hydrogen atom, an alkyl group having 1 to 20 carbon atoms, or an aromatic group having 3 to 20 carbon atoms). Examples of the sulfonate ester group include a methyl sulfonate group, an ethyl sulfonate group, a n-propyl sulfonate group, an isopropyl sulfonate group, a n-butyl sulfonate group, a sec-butyl sulfonate group, a tert-butyl sulfonate group, a n-pentyl sulfonate group, a neopentyl sulfonate group, a n-hexyl sulfonate group, a cyclohexyl sulfonate group, a n-heptyl sulfonate group, a n-octyl sulfonate group, a n-nonyl sulfonate group, a n-decylsulfonate group, a n-dodecyl sulfonate group, a n-undecylsulfonate group, a n-tridecylsulfonate group, a n-tetradecylsulfonate group, a n-pentadecylsulfonate group, a n-hexadecylsulfonate group, a n-heptadecylsulfonate group, a n-octadecylsulfonate group, a n-nonadecylsulfonate group and a n-eicosyl sulfonate group, and are preferably a sec-butyl sulfonate group, a neopentyl sulfonate group and a cyclohexyl sulfonate group. These sulfonate esters may be substituted with a substituent not influencing the polymerization reaction.

Examples of the sulfonamide group include a sulfonamide group, an N-methylsulfonamide group, an N,N-dimethylsulfonamide group, an N-ethylsulfonamide group, an N,N-diethylsulfonamide group, an N-n-propylsulfonamide group, a di-n-propylsulfonamide group, an N-isopropylsulfonamide group, an N,N-diisopropylsulfonamide group, an N-n-butylsulfonamide group, an N,N-di-n-butylsulfonamide group, an N-sec-butylsulfonamide group, an N,N-di-sec-butylsulfonamide group, an N-tert-butylsulfonamide group, an N,N-di-tert-butylsulfonamide group, an N-n-pentylsulfonamide group, an N-neopentylsulfonamide group, an N-n-hexylsulfonamide group, an N-cyclohexylsulfonamide group, an N-n-heptylsulfonamide group, an N-n-octylsulfonamide group, an N-n-nonylsulfonamide group, an N-n-decylsulfonamide group, an N-n-dodecylsulfonamide group, an N-n-undecylsulfonamide group, an N-n-tridecylsulfonamide group, an N-n-tetradecylsulfonamide group, an N-n-pentadecylsulfonamide group, an N-n-hexadecylsulfonamide group, an N-n-heptadecylsulfonamide group, an N-n-octadecylsulfonamide group, an N-n-nonadecylsulfonamide group, an N-n-eicosylsulfonamide group, an N,N-diphenylsulfonamide group, an N,N-bistrimethylsilylsulfonamide group, an N,N-bis-tert-butyldimethylsilylsulfonamide group, a pyrrolylsulfonamide group, a pyrrolidinylsulfonamide group, a piperidinylsulfonamide group, a carbazolylsulfonamide group, a dihydroindolylsulfonamide group and a dihydroisoindolylsulfonamide group, and are preferably an N,N-diethylsulfonamide group, an N-n-dodecylsulfonamide group, a pyrrolidinylsulfonamide group and a piperidinyl sulfonamide group. These sulfonamide groups may be substituted with a substituent not influencing the polymerization reaction.

As the sulfonic acid precursor group, a mercapto group can be used. A mercapto group can be converted into a sulfonic acid group by using an appropriate oxidizing agent to oxidize the mercapto group.

Then, another method for producing the polymer according to the present invention will be described.

This method is a method for producing the polymer according to the present invention, in which a prepolymer having sites to which sulfonic acid groups can be incorporated is produced in advance, and sulfonic acid groups are incorporated to the incorporatable sites of the prepolymer. In this case, the polymer according to the present invention can be produced by subjecting a monomer represented by the formula (5) shown below, and as required, a monomer having no sulfonic acid group to copolymerization by the condensation reaction, and thereafter incorporating sulfonic acid groups according to a known method.

Q-Ar²-Q (A-5)

In the formula (A-5), Ar² denotes a divalent aromatic group capable of becoming Ar¹ in the above formula (1) by incorporating sulfonic acid groups; and Q has the same meaning as described above, and two Q may be identical or different from each other.

The polymer according to the present invention can be produced also by a series of operations in which a monomer represented by the formula (A-5) and a monomer represented by the formula (A-4) are copolymerized to obtain a prepolymer comprising a structural unit represented by the formula (A-5a) shown below and a structural unit represented by the above formula (A-4a), and a sulfonic acid group is incorporated to an aromatic ring constituting the main chain in the structural unit represented by the formula (A-5a) of the prepolymer.

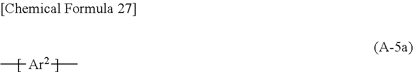

In the formula (A-5a), Ar² has the same meaning as described above.

Here, Ar² may be an aromatic group having an aromatic ring substituent described above. Ar² is a divalent aromatic group having a structure in which at least one sulfonic acid group can be incorporated. Examples of the divalent aromatic group include monocyclic aromatic groups such as a 1,3-phenylene group and a 1,4-phenylene group, condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and aromatic heterocyclic groups such as a pyridinediyl group, quinoxalinediyl group and a thiophenediyl group.

The structure of Ar² in which a sulfonic acid group can be incorporated indicates a structure in which an aromatic ring has a functional group, such as a hydrogen atom directly bonded to the aromatic ring. In the case where a sulfonic acid group is incorporated to an aromatic ring by the electrophilic substitution reaction, a hydrogen atom bonded to the aromatic ring can be regarded as a functional group (site) to which a sulfonic acid group can be incorporated. Specific examples of the monomer represented by the formula (A-5) include 1,3-dichlorobenzene, 1,4-dichlorobenzene, 1,3-dichloro-4-methoxybenzene, 1,4-dichloro-3-methoxybenzene, 4,4′-dichlorobiphenyl, 4,4′-dichloro-3,3′-dimethylbiphenyl, 4,4′-dichloro-3,3′-dimethoxybiphenyl, 1,4-dichloronaphthalene, 1,5-dichloronaphthalene, 2,6-dichloronaphthalene and 2,7-dichloronaphthalene, and monomers can be used in which chlorine atoms present in these monomers described above are replaced by groups except the chlorine atoms among the leaving groups described above as examples.

A method for incorporating a sulfonic acid group to a structural unit represented by the formula (A-5a) includes a method in which an obtained prepolymer is dissolved or dispersed in concentrated sulfuric acid, or partially dissolved in an organic solvent, and thereafter is reacted with concentrated sulfuric acid, chlorosulfuric acid, fuming sulfuric acid, sulfur trioxide or the like to convert hydrogen atoms to sulfonic acid groups.

Next, The polymerization (condensation reaction) for producing the polymer according to the present invention (for example, a polymer comprising a structural unit represented by the above formula (A-3a) and a structural unit represented by the above formula (A-4a)), or a prepolymer which can produce the polymer according to the present invention (for example, a prepolymer comprising a structural unit represented by the above formula (A-5a) and a structural unit represented by the above formula (A-4a)), will be described. In descriptions of the production methods described below, the polymer according to the present invention and a prepolymer which can produce the polymer according to the present invention are collectively referred to as “polymers” in some cases.

The polymerization for forming a polyarylene structure is a condensation polymerization carried out in the presence of a zero-valent transition metal complex. The polymerization in the presence of the zero-valent transition metal complex has an advantage of allowing the relatively easy formation of a polyarylene structure. The zero-valent transition metal complex is a complex in which a halogen or a ligand described later is coordinated to a transition metal, and is preferably one having at least one ligand described later. The zero-valent transition metal complex may be a commercially available product, or a synthesized one. The synthesis of the zero-valent transition metal complex can be made by a known method, for example, a method in which a transition metal salt or a transition metal oxide and a ligand are reacted. A zero-valent transition metal complex synthesized may be used after refining by a suitable method, or may be used in situ without refining.

Examples of the ligand include acetate, acetylacetonato, 2,2″-bipyridyl, 1,10-phenanthroline, methylenebisoxazoline, N,N,N′,N′-tetramethylethylenediamine, triphenylphosphine, tritolylphosphine, tributylphosphine, triphenoxyphosphine, 1,2-bisdiphenylphosphinoethane and 1,3-bisdiphenylphosphinopropane.

Examples of the zero-valent transition metal complex include zero-valent nickel complexes, zero-valent palladium complexes, zero-valent platinum complexes and zero-valent copper complexes. Among these transition metal complexes, zero-valent nickel complexes and zero-valent palladium complexes are preferably used, and zero-valent nickel complexes are more preferably used.

Examples of the zero-valent nickel complexes include bis(1,5-cyclooctadiene)nickel(0), (ethylene)bis(triphenylphosphine)nickel(0) and tetrakis(triphenylphosphine)nickel, and above all, bis(1,5-cyclooctadiene)nickel(0) is preferably used from the viewpoint of the reactivity, the yield of polymers obtained and the high polymerization of polymers obtained. Examples of the zero-valent palladium complex include tetrakis(triphenylphosphine)palladium(0).

These zero-valent transition metal complexes may be synthesized as described above, or commercially available ones may be used. In the synthesis method of a zero-valent transition metal complex, the zero-valent transition metal complex can also be produced by making the atomic valence of a monovalent or multivalent metal of a transition metal compound to be zero-valent by action of a reducing agent such as zinc or magnesium.

As a transition metal compound used for generating a zero-valent transition metal complex by the action of a reducing agent, compounds of a divalent transition metal are preferably used. Particularly divalent nickel compounds and divalent palladium compounds are preferable. The divalent nickel compounds include nickel chloride, nickel bromide, nickel iodide, nickel acetate, nickel acetylacetonato, bis(triphenylphosphine)nickel chloride, bis(triphenylphosphine)nickel bromide and bis(triphenylphosphine)nickel iodide, and divalent palladium compounds include palladium chloride, palladium bromide, palladium iodide and palladium acetate.

The reducing agent includes zinc, magnesium, sodium hydride, hydrazine and derivatives thereof and lithium aluminum hydride. As required, ammonium iodide, trimethylammonium iodide, triethylammonium iodide, lithium iodide, sodium iodide and potassium iodide can be used concurrently.

In the condensation reaction using the transition metal complexes described above, a compound to become a ligand of a zero-valent transition metal complex used is preferably added from the viewpoint of an improvement in the yield of polymers obtained. The added compound may be the same as or different from the ligand of the zero-valent transition metal complex used.

Examples of the compound to become a ligand include the compounds described before as examples of ligands, and are preferably triphenylphosphine and 2,2′-bipyridyl from the viewpoint of the versatility, the economic efficiency, the reactivity, the yield of polymers obtained and the high polymerization of polymers obtained. Particularly use of 2,2′-bipyridyl is especially advantageous from the viewpoint of an improvement in the yield of polymers and the high polymerization. The amount of a ligand added is usually about 0.2 to 10 mol times, and preferably about 1 to 5 mol times, based on a transition metal atom in a zero-valent transition metal complex.

The amount of a zero-valent transition metal complex used is 0.1 mol time or more to the total molar amount (hereinafter, referred to as “total molar amount of all monomers”) of a monomer represented by the formula (A-3), a monomer represented by the formula (A-4) and a monomer represented by the formula (A-5), which are used in production of polymers. Since too small a use amount thereof is likely to make the molecular weight low, the use amount is preferably 1.5 mol times or more, more preferably 1.8 mol times or more, and still more preferably 2.1 mol times or more. On the other hand, the upper limit of the use amount is not especially limited, but since too large a use amount thereof brings about complexities in post-treatments in some cases, the use amount is preferably 5.0 mol times or less.

In the case of synthesizing a zero-valent transition metal complex from a transition metal compound by using a reducing agent, it suffices if the use amounts and the like of the transition metal compound and the reducing agent are set so that the zero-valent transition metal complex produced is in the above-mentioned range, and it suffices if the amount of the transition metal compound is, for example, 0.01 mol time or more, and preferably 0.03 mol time or more, to the total amount of all monomers. The upper limit of the use amount thereof is not limited, but since too large a use amount thereof is likely to bring about complexities in post-treatments, the use amount is preferably 5.0 mol times or less. It suffices if the amount of a reducing agent used is, for example, 0.5 mol time or more, and preferably 1.0 mol time or more, to the total amount of all monomers. The upper limit of the use amount thereof is not limited, but since too large a use amount thereof is likely to bring about complexities in post-treatments, the use amount is preferably 10 mol times or less.

The reaction temperature is usually about 20° C. to 200° C., and preferably about 20° C. to 100° C. The reaction time is usually about 0.5 to 24 hours.

A method for mixing a zero-valent transition metal complex, and a monomer selected from a monomer represented by the formula (A-3), a monomer represented by the formula (A-4) and a monomer represented by the formula (A-5), which are used in production of polymers, may be a method in which one thereof is added to the other, or a method in which the both are simultaneously added to a reaction vessel. The addition thereof may be addition at a stroke, but is preferably addition in little by little in consideration of heat generation, and the addition is preferably in the presence of a solvent, and a suitable solvent in this case will be described later.

The condensation reaction is carried out preferably in the presence of a solvent from the viewpoint of well preventing remarkable heat generation as described before. Examples of the solvent in this case include aprotic polar solvents such as N,N-dimethylformamide (DMF), N,N-dimethylacetamide (DMAc), N-methylpyrrolidone (NMP), dimethyl sulfoxide (DMSO) and hexamethylphosphoric triamide; aromatic hydrocarbon solvents such as toluene, xylene, mesitylene, benzene and n-butylbenzene; etheric solvents such as tetrahydrofuran, 1,4-dioxane, dibutyl ether and tert-butyl methyl ether; esteric solvents such as ethyl acetate, butyl acetate and methyl benzoate; and alkyl halide solvents such as chloroform and dichloroethane. Notes in the parentheses indicate abbreviations of solvents, and in notes described later, these abbreviations may be used.

In order to make the molecular weight of polymers higher, since use of a solvent capable of sufficiently dissolving polymers is desirable, use of tetrahydrofuran, 1,4-dioxane, DMF, DMAc, NMP, DMSO or toluene, which is a good solvent to polymers produced, is preferable. These may be used as a mixture of two or more. Above all, at least one solvent selected from the group consisting of DMF, DMAc, NMP and DMSO, or a mixture of two or more solvents selected therefrom is preferably used.

The amount of a solvent is not especially limited, but since too low a concentration thereof can hardly recover polymers produced in some cases, and since too high a concentration thereof brings about a difficulty in agitation in some cases, the amount of a solvent used is determined so that the weight proportion of the solvent is preferably 99.95 to 50% by weight, and more preferably 99.9 to 75% by weight, to the total weight amount of the solvent and a monomer (a monomer selected from a monomer represented by the formula (A-3), a monomer represented by the formula (A-4) and a monomer represented by the formula (A-5)) used for production of polymers.

The polymer according to the present invention, or a prepolymer capable of being converted into the polymer according to the present invention is thus obtained, and for taking out polymers produced from a reaction mixture, conventional methods can be applied. For example, the polymers are separated by adding a poor solvent, and target materials can be taken out by an operation such as filtration. As required, the materials may be refined by an ordinary refining method such as water washing or the reprecipitation using a good solvent and a poor solvent.

In the case where the sulfonic acid group of a polymer produced has a form of a salt, in order to use the polymer as a member for a fuel cell, the sulfonic acid group is preferably made in a form of a free acid, and the conversion to the form of a free acid can be carried out by washing with a common acidic solution. Examples of an acid to be used include hydrochloric acid, sulfuric acid and nitric acid, and are preferably dilute hydrochloric acid and dilute sulfuric acid.

Also in the case where a polymer having sulfonic acid groups protected, in order to use the polymer as a member for a fuel cell, the protected sulfonic acid groups need to be converted into sulfonic acid groups in a form of a free acid. For such a conversion to the sulfonic acid group, the hydrolysis with an acid or a base, or a deprotection reaction by a halogenated substance can be used. In the case of using a base, washing with an acidic solution as described above allows conversion to sulfonic acid groups in the form of a free acid. Examples of the acid or base include hydrochloric acid, sulfuric acid, nitric acid, sodium hydroxide and potassium hydroxide. Examples of the halogenated substance to be used include lithium bromide, sodium iodide, tetramethylammonium chloride and tetrabutylammonium bromide, and are preferably lithium bromide and tetrabutylammonium bromide. The conversion rate to a sulfonic acid group can be determined by quantitatively determining the degree of the presence of characteristic peaks of a sulfonate ester group or a sulfonamide group in an infrared absorption spectrum or a nuclear magnetic resonance spectrum.

In the case where the polymer according to the present invention is a copolymer comprising a structural unit having a sulfonic acid group and a non-sulfonic acid structural unit having an aromatic ring substituent as described before, production of the polymer so that the ion-exchange capacity exceeds 3.0 meq/g is easier, which is preferable. Here, suitable examples of the structural unit represented by the above formula (A-3a) and the structural unit represented by the formula (A-4a) are as follows.

<Specific Examples of the Structural Unit Represented by the Formula (A-3a)>

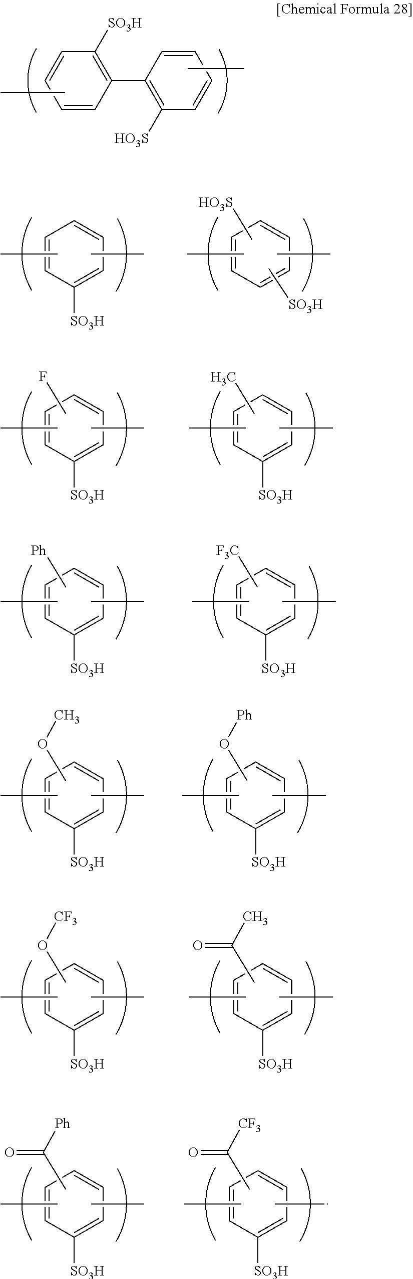

<Specific Examples of the Structural Unit Represented by the Formula (A-4a)>

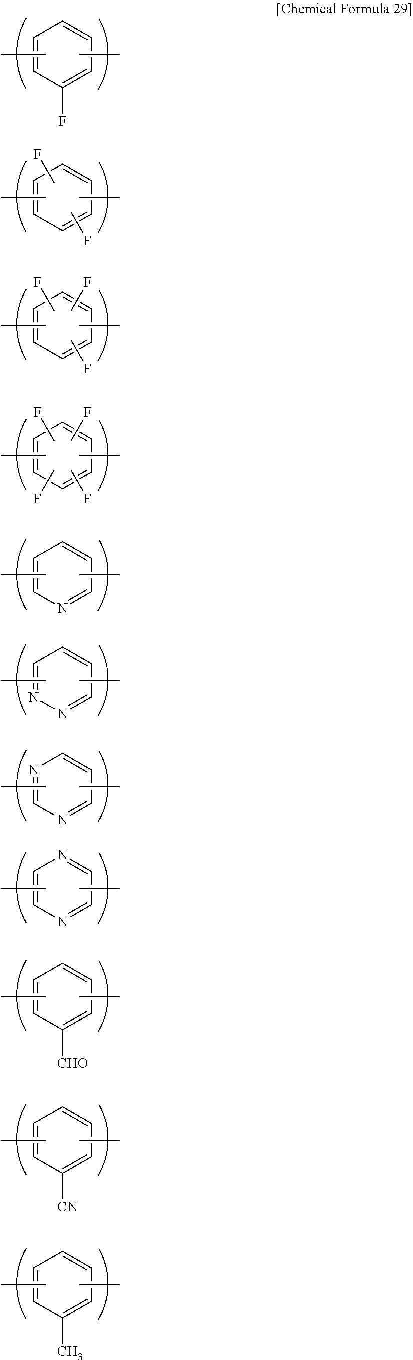

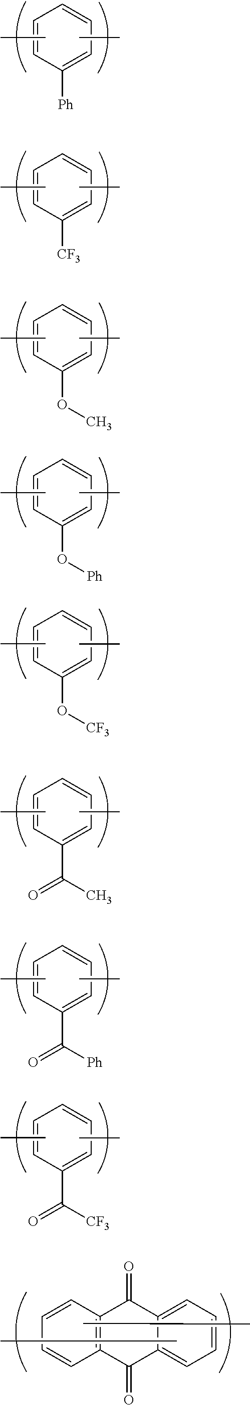

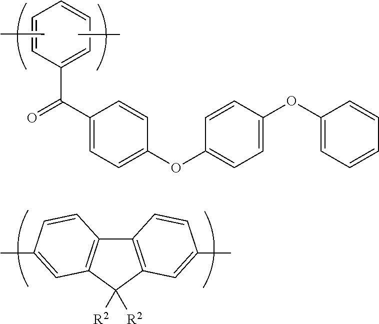

In these examples of the structural units, “-Ph” denotes a phenyl group. “R²” denotes an alkyl group having 1 to 20 carbon atoms that may have a substituent, or an aryl group having 6 to 20 carbon atoms that may have a substituent.

Any of the polymers according to the present invention can suitably be used as a member for a fuel cell. The polymer according to the present invention is especially preferably used as a proton conductive membrane (polymer electrolyte membrane) of electrochemical devices such as fuel cells. In descriptions hereinafter, mainly the case of a proton conductive membrane will be described.

In this case, the polymer according to the present invention, or a polymer electrolyte comprising the polymer according to the present invention is converted into a form of a membrane. This method (membrane forming method) is not especially limited, but membrane formation using a method of forming a membrane from a solution state (solution cast method) is preferable. The solution cast method is a method usually used in the field concerned as production of polymer electrolyte membranes, and industrially especially useful.

The solution cast method refers to a method in which the polymer according to the present invention or a polymer electrolyte comprising the polymer according to the present invention is dissolved in an appropriate solvent to prepare a polymer electrolyte solution, which is then cast (cast membrane formation) on a support base material such as a glass plate or a PET (polyethylene terephthalate) film to form an applied membrane; volatile components such as the cast solvent is removed from the applied membrane to produce a polymer electrolyte membrane on the support base material. Then, the support base material is removed by peeling or otherwise to obtain a polymer electrolyte membrane.

The solvent (cast solvent) used in the solution cast method is not especially limited as long as the solvent can sufficiently dissolve the polymer according to the present invention, and can be removed thereafter, and suitably used are aprotic polar solvents such as DMF, DMAc, NMP and DMSO; chlorine-based solvents such as dichloromethane, chloroform, 1,2-dichloroethane, chlorobenzene and dichlorobenzene; alcohols such as methanol, ethanol and propanol; and alkylene glycol monoalkyl ethers such as ethylene glycol monomethyl ether, ethylene glycol monoethyl ether, propylene glycol monomethyl ether and propylene glycol monoethyl ether. These can be used singly, but as required, may be sued as a mixture of two or more thereof. Above all, DMSO, DMF, DMAc and NMP are preferable because the solubility of the polymer according to the present invention is high.

The thickness of a polymer electrolyte membrane thus obtained is preferably 5 to 300 μm in a practical range for use as a proton conductive membrane (diaphragm) for a fuel cell. The membrane having a membrane thickness of 5 μm or higher provides an excellent practical strength, which is preferable; and the membrane of 300 μm or lower is likely to make the membrane resistance itself small, which is preferable. The membrane thickness can be controlled by the weight concentration of the solution described above and the application thickness of an applied membrane on a support base material.

In order to improve various physical properties of a membrane, a polymer electrolyte may be prepared by adding additives, such as a plasticizer, a stabilizer and a release agent as used in common polymers, to the polymer according to the present invention. Alternatively, a polymer electrolyte can be prepared by composite alloying another polymer with the polymer according to the present invention by a method in which the polymers are mixed in the same solvent and concurrently cast. In the case where a polymer electrolyte is prepared by combining the polymer according to the present invention with additives and/or another polymer, the types and the use amounts of the additives and/or the another polymer are determined such that desired characteristics can be obtained when the polymer electrolyte is applied to a member for a fuel cell.

Further in order to facilitate water control in fuel cell applications, also addition of inorganic or organic microparticles as a water retention agent is known. Any of these known methods can be used unless being contrary to the object of the present invention. In order to improve the mechanical strength or the like, a polymer electrolyte membrane thus obtained may be subjected to a treatment such as irradiation of an electron beam, radiation or the like.

In order to improve the strength, flexibility and durability of a proton conductive membrane using the polymer according to the present invention, a polymer electrolyte comprising the polymer according to the present invention as an effective component may be impregnated and composited in a porous base material to make a polymer electrolyte composite membrane (hereinafter, referred to as “composite membrane”). As the compositing method, known methods can be used.

The porous base material is not especially limited as long as it satisfies the above-mentioned use object, and examples thereof include porous membranes, woven fabrics, non-woven fabrics and fibrils, and can be used not depending on the shapes and the materials. The material of the porous base material is, in consideration of the viewpoint of heat resistance and a reinforcement effect of physical strength, preferably an aliphatic polymer, an aromatic polymer or a fluorine-containing polymer.

In the case of using a composite membrane using the polymer according to the present invention as a proton conductive membrane, the membrane thickness of a porous base material to be used is preferably 1 to 100 μm, more preferably 3 to 30 μm, and especially preferably 5 to 20 μm. The pore diameter of the porous base material is preferably 0.01 to 100 μm, and more preferably 0.02 to 10 μm. The porosity of the porous base material is preferably 20 to 98%, and more preferably 40 to 95%.

If the membrane thickness of the porous base material is 1 μm or more, an effect on reinforcement of the strength after the compositing, and a reinforcing effect of imparting flexibility and durability are better, and gas leakage (cross leak) hardly occurs. If the membrane thickness is 100 μm or less, the electric resistance becomes lower to thereby make an obtained composite membrane a better one as a proton conductive membrane for a fuel cell. If the pore diameter is 0.01 μm or more, filling of the polymer according to the present invention becomes easy; and if the pore diameter is 100 μm or less, a reinforcing effect becomes larger. If the porosity is 20% or more, the resistance as a polymer electrolyte membrane becomes smaller; and if the porosity is 98% or less, the strength of a porous base material itself becomes larger to thereby more improve the reinforcing effect, which is preferable.

A composite membrane prepared by using the polymer according to the present invention and a polymer electrolyte membrane prepared by using the polymer according to the present invention are laminated, and the laminate may be used as a proton conductive membrane.

The polyarylene block copolymer according to the present invention is a polyarylene block copolymer obtained by polymerizing a polymer having substantially no ion-exchange group and a polystyrene-equivalent weight-average molecular weight of 4000 to 25000 with a polymer having ion-exchange groups, and comprising a block having ion-exchange groups and a block having substantially no ion-exchange group, wherein the block having ion-exchange groups comprises a structural unit represented by the formula (B-1) shown below, and the block having substantially no ion-exchange group comprises a structural unit represented by the formula (B-2) shown below.

[Chemical Formula 30]

Ar¹ (B-1)

Ar²—X¹ (B-2)

In the formula (B-1), Ar¹ denotes an arylene group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group. Ar¹ and the groups substituting Ar¹ contain no fluorine atom. At least one ion-exchange group is directly bonded to an aromatic ring constituting the main chain in Ar¹. The plurality of Ar¹ may be identical or different from each other. In the formula (B-2), Ar² denotes a divalent aromatic group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group. Ar² and the groups substituting Ar² contain no fluorine atom. X¹ denotes a group represented by —O— or a group represented by —S—. In the polyarylene block copolymer according to the present invention, the content of a fluorine atom is 5.0% by weight or less, and preferably 2.0% by weight or less.

The block having ion-exchange groups in the polyarylene block copolymer according to the present invention will be described.

The block having ion-exchange groups preferably comprises only a repeating unit represented by the above formula (B-1), and has the number of the ion-exchange group of 0.5 or more on average per the repeating unit, and more preferably the number of the ion-exchange group of 1.0 or more on average per the repeating unit.

“Ion-exchange group” described above refers to a group relevant to ionic conduction, particularly, protonic conduction. As an ion-exchange group, an acid group is usually used. The acid group includes acid groups such as weak acids, strong acids and superstrong acids, but is preferably strong acids and superstrong acids. Examples of the acid group include weak acids such as a phosphonic acid group and a carboxylic acid group; and strong acids such as a sulfonic acid group and a sulfonimide group (—SO₂—NH—SO₂—R, wherein R denotes a monovalent substituent such as an alkyl group or an aryl group), and above all, a sulfonic acid group and a sulfonimide group as strong acid groups are preferably used. It is also preferable to replace a hydrogen atom on the substituent (—R) of the aromatic ring and/or the sulfonimide group by an electrophilic group and thereby cause the strong acid group described above to function as a superstrong acid group by utilizing an effect of the electrophilic group. These ion-exchange groups may be partially or wholly replaced by metal ions, quaternary ammonium ions or the like to form salts, but are preferably substantially wholly in the state of being free acids when the polyarylene block copolymer is used as a polymer electrolyte membrane for a fuel cell or the like.

Ar¹ in the above formula (B-1) denotes an arylene group. Examples of the arylene group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. The arylene group is preferably a divalent monocyclic aromatic group.

Ar¹ may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group.

Here, examples of the alkyl group having 1 to 20 carbon atoms that may have a substituent include alkyl groups having 1 to 20 carbon atoms, such as a methyl group, an ethyl group, a n-propyl group, an isopropyl group, a n-butyl group, a sec-butyl group, an isobutyl group, a n-pentyl group, a 2,2-dimethylpropyl group, a cyclopentylic group, a n-hexyl group, a cyclohexyl group, a 2-methylpentyl group, a 2-ethylhexyl group, a nonyl group, a dodecyl group, a hexadecyl group, an octadecyl group and an icosyl group, and include these alkyl groups substituted with a substituent such as a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the alkoxy group having 1 to 20 carbon atoms that may have a substituent include alkoxy groups having 1 to 20 carbon atoms, such as a methoxy group, an ethoxy group, a n-propyloxy group, an isopropyloxy group, a n-butyloxy group, a sec-butyloxy group, a tert-butyloxy group, an isobutyloxy group, a n-pentyloxy group, a 2,2-dimethylpropyloxy group, a cyclopentyloxy group, a n-hexyloxy group, a cyclohexyloxy group, a 2-methylpentyloxy group, 2-ethylhexyloxy group, a dodecyloxy group, a hexadecyloxy group and an eicosyloxy group, and include these alkoxy groups substituted with a substituent such as a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryl group having 6 to 20 carbon atoms that may have a substituent include aryl groups such as a phenyl group, a naphthyl group, a phenanthrenyl group and an anthracenyl group, and include these aryl groups substituted with a substituent such as a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryloxy group having 6 to 20 carbon atoms that may have a substituent include aryloxy groups such as a phenoxy group, a naphthyloxy group, a phenanthrenyloxy group and an anthracenyloxy group, and include these aryloxy groups substituted with a substituent such as a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the acyl group having 2 to 20 carbon atoms that may have a substituent include acyl groups having 2 to 20 carbon atoms, such as an acetyl group, a propionyl group, a butyryl group, an isobutyryl group, a benzoyl group, 1-naphthoyl group and a 2-naphthoyl group, and include these acyl groups substituted with a substituent such as a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

In Ar¹, an aromatic ring constituting the main chain has at least one ion-exchange group. Here, “main chain” refers to the longest chain forming a polymer. This chain is constituted of carbon atoms mutually bonded through covalent bonds, and then, may be interrupted by nitrogen atoms, oxygen atoms, sulfur atoms and the like.

The block having ion-exchange groups comprises a structural unit represented by the above formula (B-1), and preferably, the structural unit represented by the above formula (B-1) has a structure represented by the formula (1-a) shown below. In the formula (1-a), Ar¹ denotes the same meaning as described above. m denotes an integer of 2 or more, and is preferably 3 or more. m is more preferably in the range of 5 to 200, and still more preferably in the range of 10 to 100. If the value of m is 2 or more, the proton conductivity as a polymer electrolyte for a fuel cell is sufficient, which is preferable. If the value of m is 200 or less, the production is easy, which is preferable.

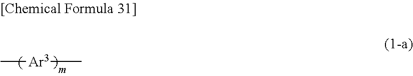

A preferable example of the structural unit represented by the above formula (B-1) include a structural unit represented by the formula (B-3) shown below. For a block having such a structural unit, a raw material industrially easily available can be used in production of the polyarylene block copolymer according to the present invention as described later, or a raw material easily produced can be used, which are preferable.

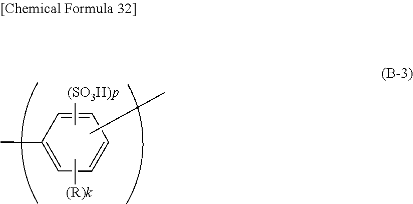

In the formula (B-3), R denotes an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, or a cyano group. R contains no fluorine atom. k denotes an integer of 0 to 3, p denotes an integer of 1 or 2, and k+p is an integer of 4 or less. The plurality of R are each identical or different from each other.

Here, R is a group described above as examples of the substituent of Ar¹, which group is selected from an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, or a cyano group, and does not inhibit the reaction in the polymerization reaction described later. The number k of the substituent is preferably 0 or 1, and especially preferably, k is 0, that is, the repeating unit has no substituent.

The structure represented by the formula (1-a) is preferably a structure represented by the formula (3-a) shown below. In the formula, m, R, p and k denote the same meaning as described above.

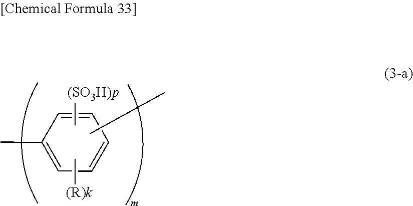

Then, the block having substantially no ion-exchange group in the polyarylene block copolymer according to the present invention will be described.

The block having substantially no ion-exchange group preferably comprises only a structural unit represented by the above formula (B-2) (wherein the terminals of the block may lack X¹), and has the number of ion-exchange groups of 0.1 or less per repeating unit, and especially preferably, the number of ion-exchange groups per repeating unit is 0, that is, there is substantially completely no ion-exchange group.

Ar² in the formula (B-2) denotes a divalent aromatic group having no group represented by —O— and/or no group represented by S— in the main chain. That is, a combination of one divalent aromatic group and one group represented by —O— or one group represented by S— present in the main chain is regarded as one structural unit. The divalent aromatic group having no group represented by —O— and/or no group represented by S— in the main chain has preferably 4 to 40, more preferably 5 to 30, and still more preferably 6 to 25 carbon atoms. Such a structural unit is preferred because an industrially easily available raw material can be used, or a raw material that is easily produced can be used. Examples of the divalent aromatic group having no group represented by —O— and/or no group represented by S— in the main chain include aromatic groups such as the formulae (a) to (z) shown below (in the formulae, each * denotes a bond, and bonds with other substituents are omitted).

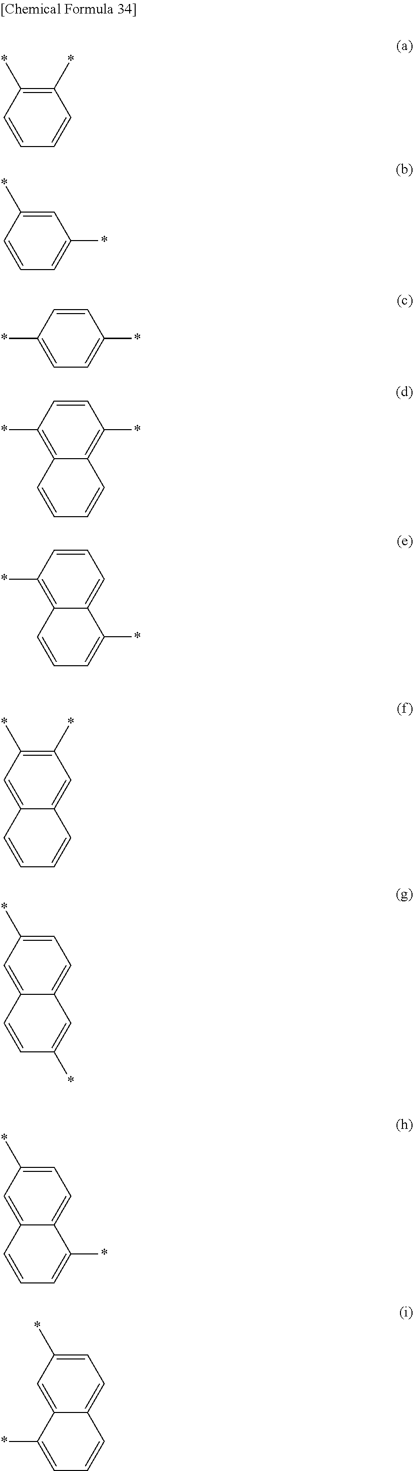

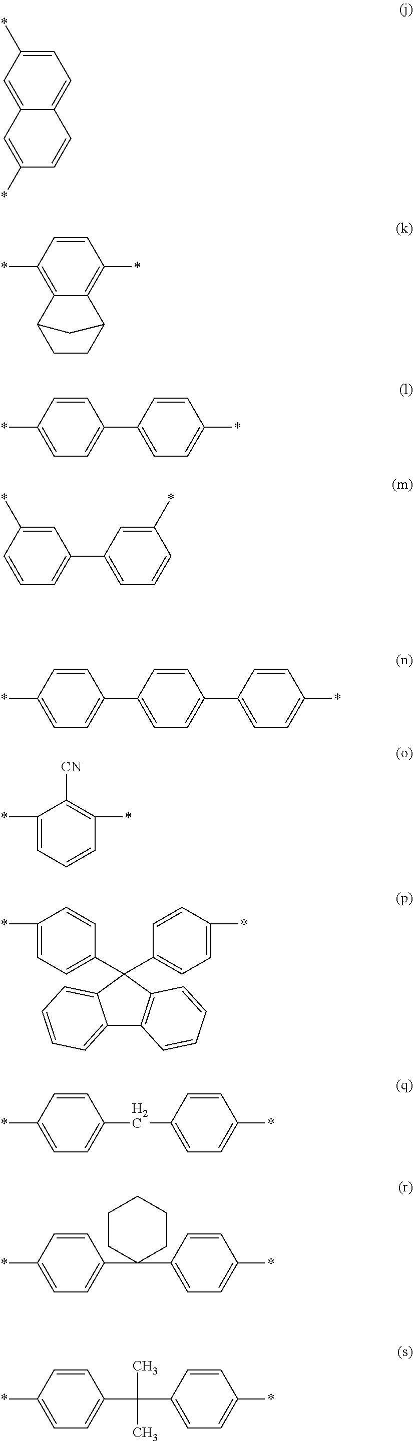

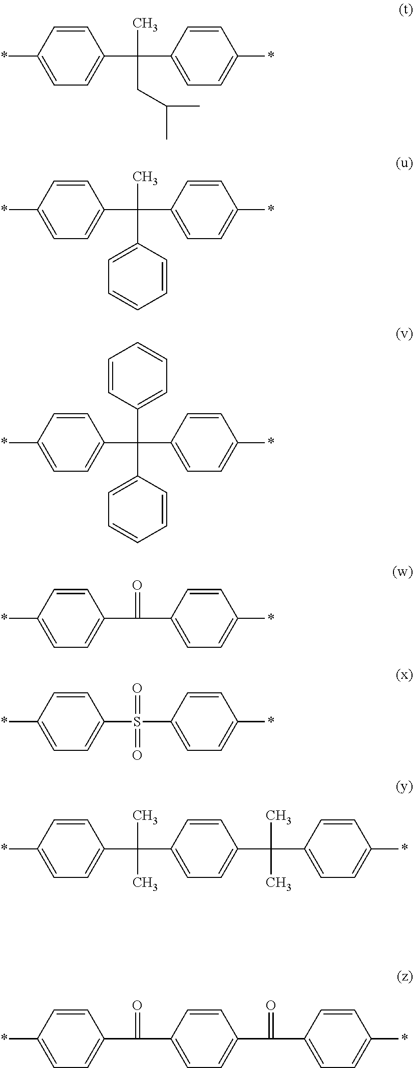

Ar² may be substituted with the same group as that for Ar¹, and particularly, Ar² is preferably a group that may have a substituent and is represented by (c), (g), (l), (o), (p), (s), (v), (w) or (x) shown above. For a block having such a structural unit, a raw material industrially easily available can be used, which is preferable.

Preferred examples of the structural unit represented by the formula (B-2) include structural units represented by the formulae shown below. A block having such a structural unit is preferred because it can be easily produced and can be produced using an industrially easily available raw material. In the formulae shown below, “a” denotes a molar composition ratio, and a is preferably 0.51 to 0.90, more preferably 0.55 to 0.90, and still more preferably 0.60 to 0.85.

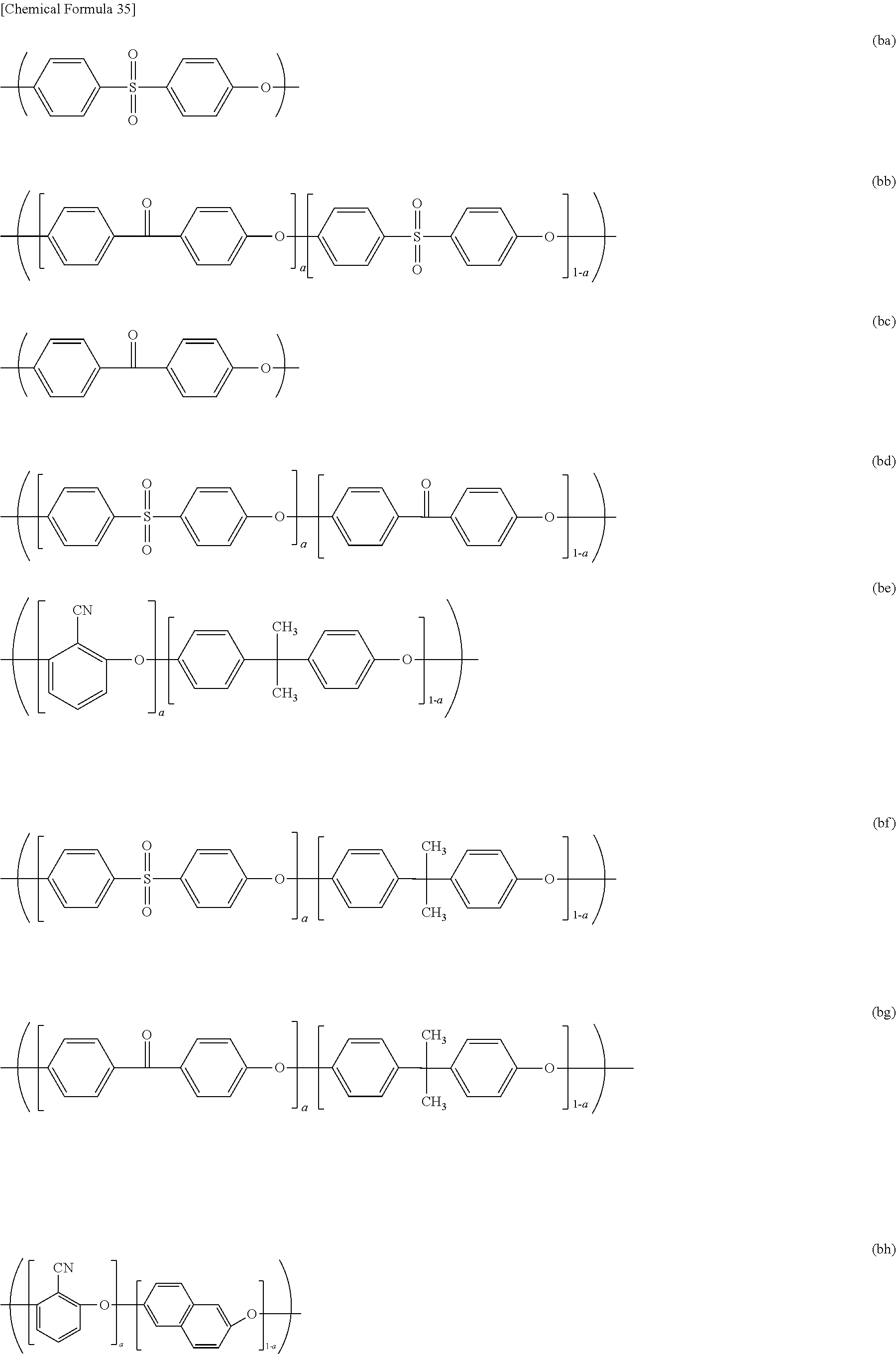

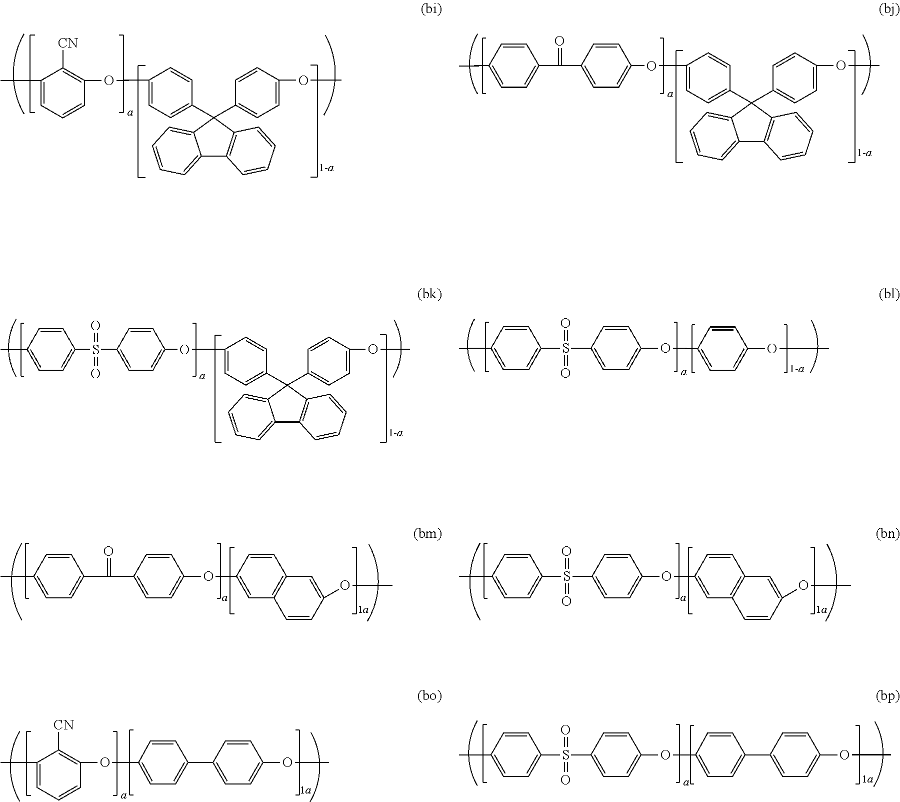

Next, a suitable method for producing the polyarylene block copolymer according to the present invention will be described. In the polyarylene block copolymer, the block having ion-exchange groups comprises a structural unit represented by the above formula (B-1). A method for incorporating an ion-exchange group to be bonded to an aromatic ring constituting the main chain in Ar¹ may be a method in which a monomer having an ion-exchange group in advance is polymerized, or a method in which after a polyarylene block copolymer precursor is produced from a monomer having no ion-exchange group in advance, ion-exchange groups are incorporated. Above all, the former method is more preferable because the amount of an ion-exchange group incorporated and the substitution position can accurately be controlled.

An example of methods of producing the polyarylene block copolymer according to the present invention by using a monomer having an ion-exchange group includes a method in which a monomer represented by the formula (1-h) shown below and a polymer represented by the formula (B-4) described later and having substantially no ion-exchange group are polymerized by condensation reaction to produce the polyarylene block copolymer.

Q-Ar¹⁰-Q (1-h)

Here, Ar¹⁰ is a divalent arylene group that may have at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and the divalent arylene group in which an ion-exchange group and/or an ion-exchange precursor group is bonded to an aromatic ring constituting the main chain. Q denotes a leaving group, and two Q may be identical or different from each other.

Ar¹⁰ in the formula (1-h) includes the same group as the specific examples of Ar¹. Ar¹⁰ may be substituted with the same group as the specific example of the substituents of Ar¹. The leaving group described above denotes a group to leave in condensation reaction, and specific examples thereof include halogen atoms such as a chlorine atom, a bromine atom and an iodine atom, and sulfonyloxy groups such as a p-toluenesulfonyloxy group, a methanesulfonyloxy group and a trifluoromethanesulfonyloxy group.

Examples of the monomer represented by the above formula (1-h) and having a sulfonic acid group as a preferable ion-exchange group include 2,4-dichlorobenzenesulfonic acid, 2,5-dichlorobenzenesulfonic acid, 3,5-dichlorobenzenesulfonic acid, 2,4-dibromobenzenesulfonic acid, 2,5-dibromobenzenesulfonic acid, 3,5-dibromobenzenesulfonic acid, 2,4-diiodobenzenesulfonic acid, 2,5-diiodobenzenesulfonic acid, 3,5-diiodobenzenesulfonic acid, 2,4-dichloro-5-methylbenzenesulfonic acid, 2,5-dichloro-4-methylbenzenesulfonic acid, 2,4-dibromo-5-methylbenzenesulfonic acid, 2,5-dibromo-4-methylbenzenesulfonic acid, 2,4-diiodo-5-methylbenzenesulfonic acid, 2,5-diiodo-4-methylbenzenesulfonic acid, 2,4-dichloro-5-methoxybenzenesulfonic acid, 2,5-dichloro-4-methoxybenzenesulfonic acid, 2,4-dibromo-5-methoxybenzenesulfonic acid, 2,5-dibromo-4-methoxybenzenesulfonic acid, 2,4-diiodo-5-methoxybenzenesulfonic acid, 2,5-diiodo-4-methoxybenzenesulfonic acid, 3,3′-dichlorobiphenyl-2,2′-disulfonic acid, 3,3′-dibromobiphenyl-2,2′-disulfonic acid, 3,3′-diiodobiphenyl-2,2′-disulfonic acid, 4,4′-dichlorobiphenyl-2,2′-disulfonic acid, 4,4′-dibromobiphenyl-2,2′-disulfonic acid, 4,4′-diiodobiphenyl-2,2′-disulfonic acid, 4,4′-dichlorobiphenyl-3,3′-disulfonic acid, 4,4′-dibromobiphenyl-3,3′-disulfonic acid, 4,4′-diiodobiphenyl-3,3′-disulfonic acid, 5,5′-dichlorobiphenyl-2,2′-disulfonic acid, 5,5′-dibromobiphenyl-2,2′-disulfonic acid and 5,5′-diiodobiphenyl-2,2′-disulfonic acid.

In the case of other ion-exchange groups, the other ion-exchange groups can be selected by replacing the sulfonic acid groups of monomers described above as examples by ion-exchange groups such as carboxylic acid groups and phosphoric acid groups. Also monomers having these other ion-exchange groups are industrially easily available, or can be produced using known production methods.

The ion-exchange group of the monomers described above as examples may be in the form of a salt, and especially use of monomers having ion-exchange groups in the form of a salt is preferable from the viewpoint of polymerization reactivity. The form of a salt is preferably alkaline metal salts, and especially preferably forms of Li salts, Na salts and K salts.

The ion-exchange precursor group includes sulfonic acid precursor groups, phosphonic acid precursor groups and carboxylic acid precursor groups. The ion-exchange precursor group refers to a group to become an ion-exchange group without changing a structure of a polyarylene block copolymer precursor except the ion-exchange precursor groups. An ion-exchange precursor group is converted into an ion-exchange group preferably through a three or less stage-reaction, more preferably a two or less stage-reaction, and still more preferably one-stage reaction.

The ion-exchange precursor group is preferably one having a form in which an ion-exchange group forms an ester or an amide and is protected. Examples of sulfonic acid precursor groups as preferable ion-exchange precursor groups include sulfonate ester (—SO₃R^{c}, wherein R^{c} denotes an alkyl group having 1 to 20 carbon atoms), or sulfonamide (—SO₂N(R^{d})(R^{e}), wherein R^{d} and R^{e} each independently denote a hydrogen atom, an alkyl group having 1 to 20 carbon atoms, or an aromatic group having 3 to 20 carbon atoms).

Examples of the sulfonate ester include methyl sulfonate, ethyl sulfonate, n-propyl sulfonate, isopropyl sulfonate, n-butyl sulfonate, sec-butyl sulfonate, tert-butyl sulfonate, n-pentyl sulfonate, neopentyl sulfonate, n-hexyl sulfonate, cyclohexyl sulfonate, n-heptyl sulfonate, n-octyl sulfonate, n-nonyl sulfonate, n-decylsulfonate, n-dodecyl sulfonate, n-undecylsulfonate, n-tridecylsulfonate, n-tetradecyl sulfonate, n-pentadecylsulfonate, n-hexadecylsulfonate, n-heptadecyl sulfonate, n-octadecylsulfonate, n-nonadecylsulfonate and n-eicosyl sulfonate, and are preferably sec-butyl sulfonate, neopentyl sulfonate and cyclohexyl sulfonate. These sulfonate esters may be substituted with a substituent not influencing the polymerization reaction.

Examples of the sulfonamides include sulfonamide, N-methylsulfonamide, N,N-dimethylsulfonamide, N-ethylsulfonamide, N,N-diethylsulfonamide, N-n-propyl sulfonamide, di-n-propylsulfonamide, N-isopropyl sulfonamide, N,N-diisopropylsulfonamide, N-n-butylsulfonamide, N,N-di-n-butylsulfonamide, N-sec-butylsulfonamide, N,N-di-sec-butyl sulfonamide, N-tert-butylsulfonamide, N,N-di-tert-butylsulfonamide, N-n-pentylsulfonamide, N-neopentylsulfonamide, N-n-hexylsulfonamide, N-cyclohexylsulfonamide, N-n-heptylsulfonamide, N-n-octylsulfonamide, N-n-nonylsulfonamide, N-n-decylsulfonamide, N-n-dodecylsulfonamide, N-n-undecylsulfonamide, N-n-tridecylsulfonamide, N-n-tetradecylsulfonamide, N-n-pentadecylsulfonamide, N-n-hexadecylsulfonamide, N-n-heptadecylsulfonamide, N-n-octadecylsulfonamide, N-n-nonadecylsulfonamide, N-n-eicosylsulfonamide, N,N-diphenylsulfonamide, N,N-bistrimethylsilylsulfonamide, N,N-bis-tert-butyldimethylsilylsulfonamide, pyrrolylsulfonamide, pyrrolidinylsulfonamide, piperidinylsulfonamide, carbazolylsulfonamide, dihydroindolylsulfonamide and dihydroisoindolylsulfonamide, and are preferably N,N-diethylsulfonamide, N-n-dodecylsulfonamide, pyrrolidinylsulfonamide and piperidinylsulfonamide. These sulfonamide groups may be substituted with a substituent not influencing the polymerization reaction.

As the sulfonic acid precursor group, a mercapto group can be used. A mercapto group can be converted into a sulfonic acid group by using an appropriate oxidizing agent to oxidize the mercapto group.

Then, a method will be described in which after a polyarylene block copolymer precursor is produced from a monomer having no ion-exchange group in advance, ion-exchange groups are incorporated. In this case, a polyarylene block copolymer precursor can be produced, for example, by polymerizing by condensation reaction a monomer represented by the formula (1-i) shown below and a polymer represented by the formula (B-4) described later and having substantially no ion-exchange group.

Q-Ar¹¹-Q (1-i)

In the formula (1-i), Ar¹¹ denotes a divalent arylene group capable of becoming Ar¹⁰ of the above formula (1-h) by incorporating an ion-exchange group, and Q has the same meaning as described above, and two Q may be identical or different from each other.

The polymer according to the present invention can be produced by a series of operations in which a monomer represented by the formula (1-i) and a polymer represented by the formula (B-4) and having substantially no ion-exchange group are copolymerized by condensation reaction to obtain a polyarylene block copolymer precursor comprising both of a structural unit represented by the formula (1-j) described below and a structural unit represented by the above formula (B-2), and an ion-exchange group is incorporated to an aromatic ring constituting the main chain in the structural unit represented by the formula (1-j) of the polyarylene block copolymer precursor.

[Chemical Formula 36]

Ar¹² (1-j)

In the formula (1-j), Ar¹² denotes a divalent arylene group capable of becoming Ar¹ of the above formula (B-1) by incorporating an ion-exchange group.

Ar¹¹ and Ar¹² have a structure capable of incorporating at least one ion-exchange group. The structure capable of incorporating the ion-exchange group in Ar¹¹ and Ar¹² means a structure having a functional group, such as a hydrogen atom directly bonded to an aromatic ring, capable of incorporating an ion-exchange group. In the case where a sulfonic acid group is incorporated to an aromatic ring by an electrophilic substitution reaction, the hydrogen atom bonded to an aromatic ring is regarded as a functional group capable of incorporating a sulfonic acid group. Specific examples of the monomer represented by the formula (1-i) include 1,3-dichlorobenzene, 1,4-dichlorobenzene, 1,3-dichloro-4-methoxybenzene, 1,4-dichloro-3-methoxybenzene, 4,4′-dichlorobiphenyl, 4,4′-dichloro-3,3′-dimethylbiphenyl, 4,4′-dichloro-3,3′-dimethoxybiphenyl, 1,4-dichloronaphthalene, 1,5-dichloronaphthalene, 2,6-dichloronaphthalene and 2,7-dichloronaphthalene. Monomers may be used in which chlorine atoms in these monomers are replaced by halogen atoms such as a bromine atom and an iodine atom, and sulfonyloxy groups such as a p-toluenesulfonyloxy group, a methanesulfonyloxy group and a trifluoromethanesulfonyloxy group.

A method for incorporating sulfonic acid groups as preferable ion-exchange groups to a structural unit represented by the formula (1-i) includes a method in which an obtained polyarylene block copolymer precursor is dissolved or dispersed in concentrated sulfuric acid, or at least partially dissolved in an organic solvent, and thereafter is acted on by concentrated sulfuric acid, chlorosulfuric acid, fuming sulfuric acid, sulfur trioxide or the like to convert hydrogen atoms to sulfonic acid groups.

Then, the polymer having substantially no ion-exchange group is preferably a polymer represented by the following formula (B-4):

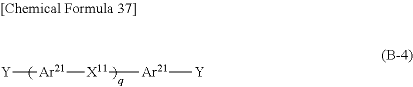

In the formula (B-4), Ar²¹ denotes a divalent aromatic group not having a group represented by —O— and/or S—. That is, a combination of one divalent aromatic group and one group represented by —O— or one group represented by S— present in the main chain is regarded as one structural unit. The plurality of Ar²¹ may be identical or different from each other. The aromatic group may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group. The aromatic group and substituents thereof have no fluorine atom. X¹¹ denotes a group represented by —O— or a group represented by S—. The plurality of X¹¹ may be identical or different from each other. Y denotes a leaving group. Two Y may be identical or different from each other. q denotes an integer of 4 or more. Preferable examples of the divalent aromatic group represented by Ar²¹ include the same groups as in Ar² described above. Ar²¹ may be substituted with the same group as Ar².

q in the formula (B-4) is an integer of 4 or more. In order to improve the shape stability when a polymer electrolyte membrane is made, q is preferably 7 or more, and more preferably 10 or more. In order to raise the proton conductivity, q is preferably 35 or less, more preferably 30 or less, and still more preferably 25 or less.

Y in the formula (B-4) denotes a leaving group, that is, a group to leave in condensation reaction, and specific examples thereof include halogen atoms such as a chlorine atom, a bromine atom and an iodine atom, and sulfonyloxy groups such as a p-toluenesulfonyloxy group, a methanesulfonyloxy group and a trifluoromethanesulfonyloxy group.

Next, the calculation method of a hydrophobicity parameter of a polymer represented by the formula (B-4) will be described. The hydrophobicity parameter of a polymer represented by the above formula (B-4) and having substantially no ion-exchange group is determined from a Log P of each structural unit by the following method.

First, the molar composition ratio of each structural unit of the polymer is determined. The molar composition ratio of each structural unit of the polymer can be determined from a ratio of monomers charged. When the monomer charge ratio is unclear, the molar composition ratio can be determined from an NMR measurement result of the polymer. The Log P of a structural unit represented by the formula (B-4-a) shown below, which is a structural unit of a polymer represented by the above formula (B-4), is calculated as a compound represented by the formula (B-5) shown below obtained by bonding two bonds of the structural unit by using ChemDraw ver.11 (CambridgeSoft Corp.). When a Log P of a structural unit is calculated, the calculation is conducted by ignoring terminal groups Y and assuming that Ar²¹ not having X¹¹ among both the Ar²¹ present on both terminals also has X¹¹. In the case where a polymer represented by the above formula (B-4) is composed of one kind of structural unit alone, the Log P of the structural unit itself is used as a hydrophobicity parameter of the polymer. In the case where a polymer represented by the above formula (B-4) comprises a plurality of structural units, the hydrophobicity parameter is determined by calculating the Log P of each structural unit and averaging the results as a weighted average in a molar composition ratio. For example, in the case where a polymer represented by the above formula (B-4) comprises a plurality of structural units (in the case where x types of Ar²¹ are present, respective Ar²¹ are denoted as Ar²¹⁻¹, Ar²¹⁻², . . . , Ar^{21-x}, wherein x is 2 or more and q+1 or less.), respective Log P of structural units represented by —(Ar²¹⁻¹—X¹¹)—, —(Ar²¹⁻²—X¹¹)—, . . . , —(Ar^{21-x}—X¹¹)— are calculated, and the results are averaged as a weighted average in a molar composition ratio of Ar²¹⁻¹, Ar²¹⁻², . . . , Ar^{21-x} to determine a hydrophobicity parameter. In the case where a polymer represented by the above formula (B-4) has a group represented by —O— and a group represented by S—, respective Log P of a structural unit represented by —(Ar²¹—O)— and a structural unit represented by —(Ar²¹—S)— are calculated for respective Ar²¹, and the results are averaged as a weighted average in a molar composition ratio of the group represented by —O— and the group represented by S— to determine a hydrophobicity parameter.

The polymer preferably comprises one type of a polymer, but in the case where the polymer is a mixture of a plurality of types of polymers having different structures, the hydrophobicity parameters are calculated for respective polymers, and then, the result is averaged as a weighted average in a mixing weight ratio to be able to calculate a hydrophobicity parameter of the block.

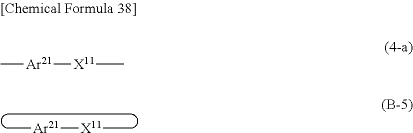

The calculation values of Log P of the formulae (ca) to (cf) as examples of the compound represented by the above formula (B-5) are as follows.

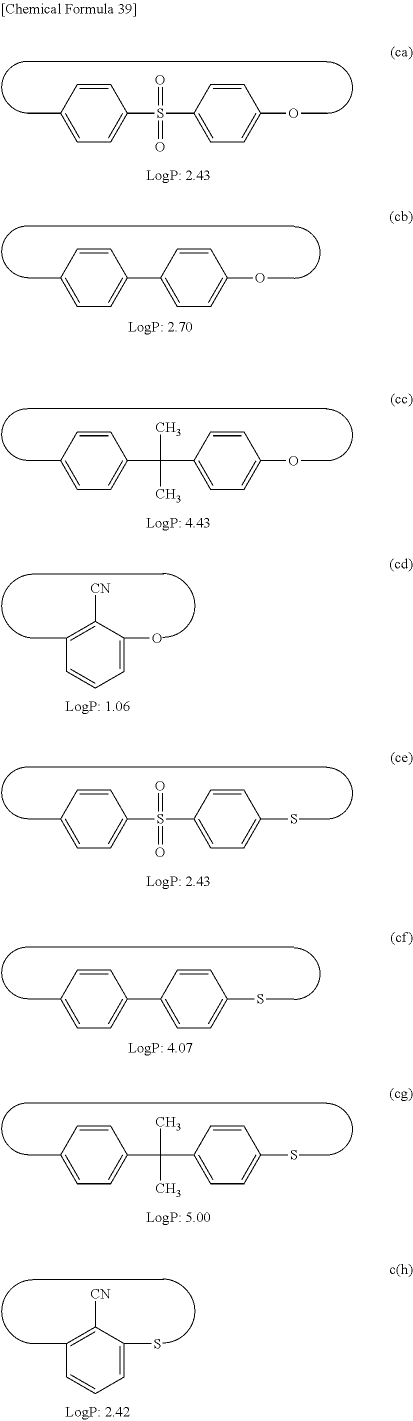

Examples of preferable polymers represented by the formula (B-4) include polymers represented by the formulae (ba) to (bp) shown below. Such a polymer is preferable because the polymer can be synthesized using a raw material industrially easily available. In the formulae shown below, b denotes a molar composition ratio, and b is preferably 0.50 to 0.90, more preferably 0.55 to 0.90, and still more preferably 0.60 to 0.85. q has the same meaning as described above.

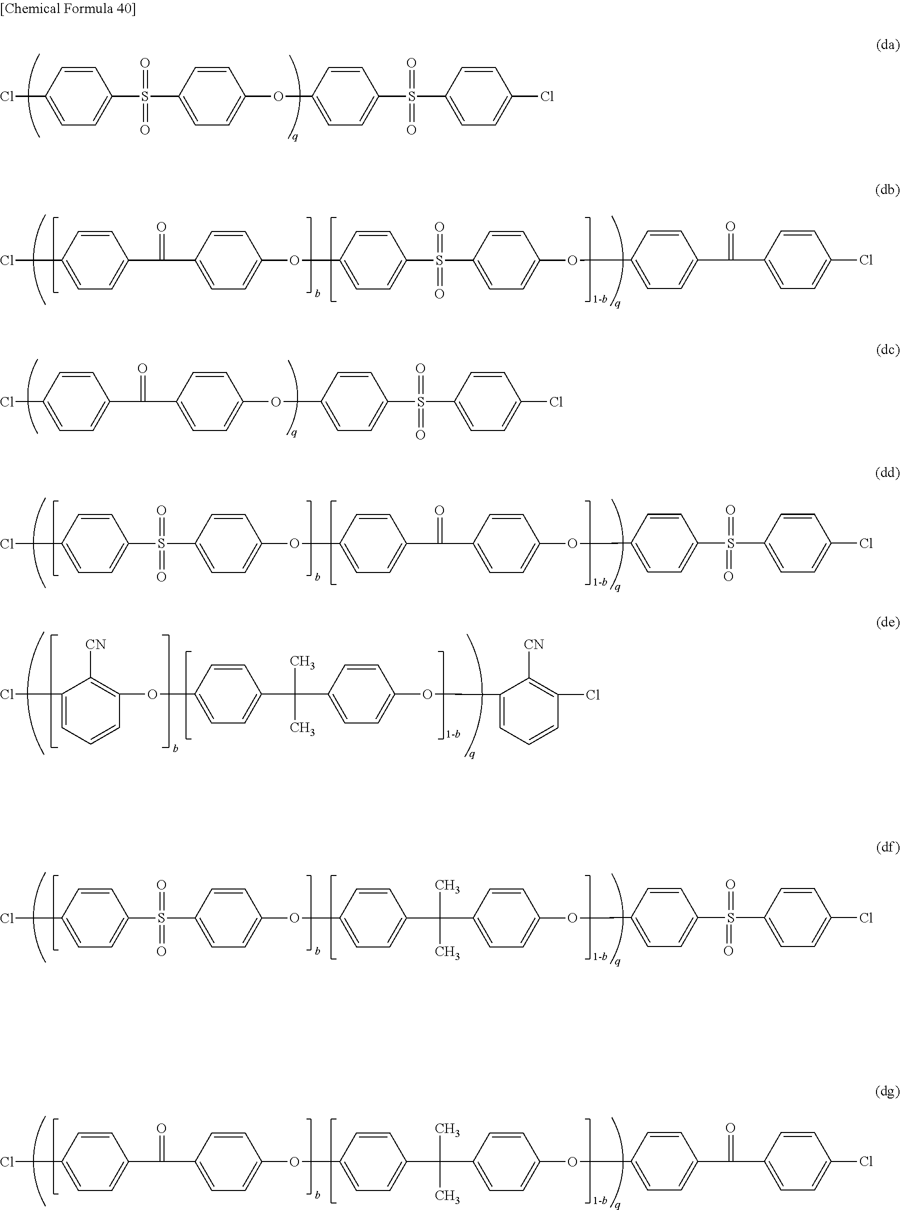

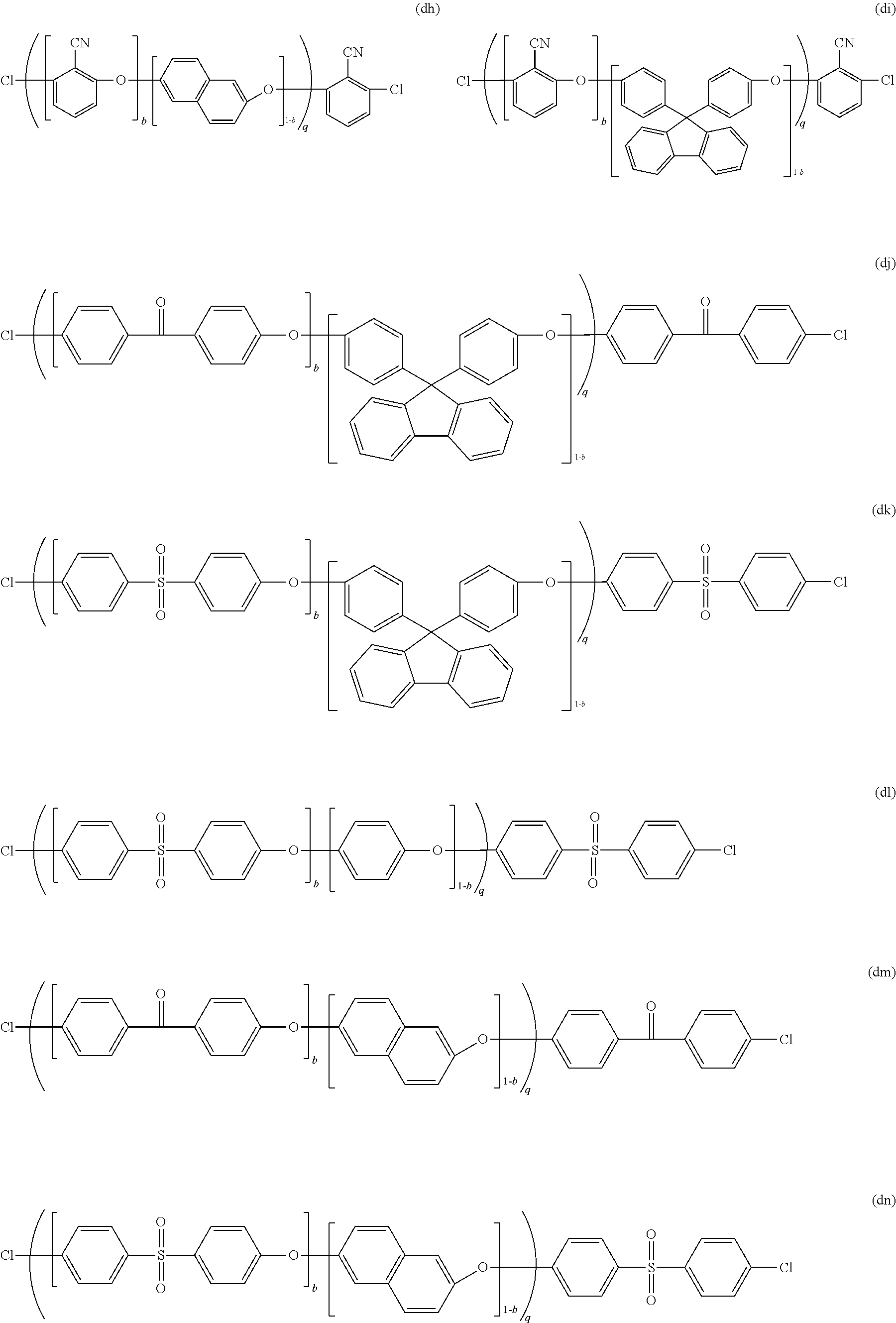

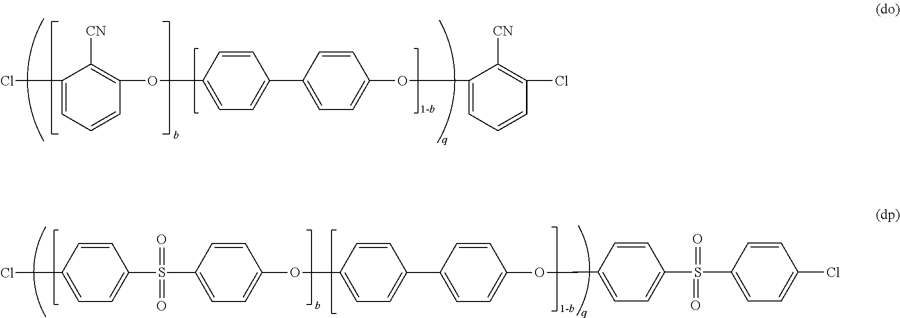

In the present invention, the hydrophobicity parameter of the polymer represented by the above formula (B-4) is preferably 1.7 or more, more preferably 2.5 or more, and still more preferably 2.7 or more, in order to raise the water resistance. The hydrophobicity parameter thereof is preferably 6.0 or less, more preferably 4.0 or less, and still more preferably 3.4 or less, in order to raise the proton conductivity.

In the present invention, the polystyrene-equivalent weight-average molecular weight of the polymer having substantially no ion-exchange group is 4000 to 25000, preferably 6000 to 22000, and more preferably 8000 to 20000. If the polystyrene-equivalent weight-average molecular weight of the polymer is less than 4000, the shape stability when the polymer is used as a polymer electrolyte membrane is likely to decrease; and by contrast, if the weight-average molecular weight is higher than 25000, the proton conductivity is likely to decrease. The weight-average molecular weight is measured by gel permeation chromatography (GPC).

Then, the polymerization reaction (condensation reaction) of the present invention will be described. In descriptions of the production methods described below, the polyarylene block copolymer according to the present invention and a polyarylene block copolymer precursor which can produce the polyarylene block copolymer according to the present invention are collectively referred to as “polymers” in some cases.

The polymerization by condensation reaction is carried out in the presence of a zero-valent transition metal complex. The zero-valent transition metal complex is a complex in which a halogen or a ligand described later is coordinated to a transition metal, and is preferably one having at least one ligand described later. As the zero-valent transition metal complex, either of a commercially available product and a separately synthesized one may be used.

An example of the synthesis method of a zero-valent transition metal complex includes a known method in which a transition metal salt or a transition metal oxide and a ligand are reacted. A zero-valent transition metal complex synthesized may be used after taken out, or may be used in situ without being taken out.

Examples of the ligand include acetate, acetylacetonato, 2,2′-bipyridyl, 1,10-phenanthroline, methylenebisoxazoline, N,N,N′,N′-tetramethylethylenediamine, triphenylphosphine, tritolylphosphine, tributylphosphine, triphenoxyphosphine, 1,2-bisdiphenylphosphinoethane and 1,3-bisdiphenylphosphinopropane.

Examples of the zero-valent transition metal complex include zero-valent nickel complexes, zero-valent palladium complexes, zero-valent platinum complexes and zero-valent copper complexes. Among these transition metal complexes, zero-valent nickel complexes and zero-valent palladium complexes are preferably used, and zero-valent nickel complexes are more preferably used.

Examples of the zero-valent nickel complexes include bis(1,5-cyclooctadiene)nickel(0), (ethylene)bis (triphenylphosphine)nickel(0) and tetrakis(triphenylphosphine)nickel. Above all, bis(1,5-cyclooctadiene)nickel(0) is preferably used from the viewpoint of the reactivity, the yield of polymers obtained and the high polymerization of polymers obtained. An example of the zero-valent palladium complex includes tetrakis(triphenylphosphine)palladium(0).

These zero-valent transition metal complexes may be synthesized as described above, or commercially available ones may be used. Examples of the synthesis method of a zero-valent transition metal complex include known methods such as a method in which a transition metal compound is made zero-valent by a reducing agent such as zinc or magnesium. A zero-valent transition metal complex may be used after taken out, or may be used in situ without being taken out.

In the case where a zero-valent transition metal complex is made to be generated from a transition metal compound by a reducing agent, as a transition metal compound to be used, compounds of a zero-valent transition metal may be used, but compounds of a divalent transition metal are preferably used. Particularly divalent nickel compounds and divalent palladium compounds are preferable. The divalent nickel compounds include nickel chloride, nickel bromide, nickel iodide, nickel acetate, nickel acetylacetonato, bis(triphenylphosphine)nickel chloride, bis(triphenylphosphine)nickel bromide and bis(triphenylphosphine)nickel iodide. Divalent palladium compounds include palladium chloride, palladium bromide, palladium iodide and palladium acetate.

Examples of the reducing agent includes zinc, magnesium, sodium hydride, hydrazine and derivatives thereof and lithium aluminum hydride. As required, ammonium iodide, trimethylammonium iodide, triethylammonium iodide, lithium iodide, sodium iodide and potassium iodide can be used concurrently.

In the condensation reaction using the transition metal complexes described above, a compound to become a ligand of a zero-valent transition metal complex used is preferably added from the viewpoint of an improvement in the yield of polymers obtained. The added compound may be the same as or different from the ligand of the zero-valent transition metal complex used. Examples of the compound to become a ligand include the compounds described before as examples of ligands, and are preferably triphenylphosphine and 2,2′-bipyridyl from the viewpoint of the versatility, the economic efficiency, the reactivity, the yield of polymers obtained and the high polymerization of polymers obtained. Particularly use of 2,2′-bipyridyl is especially advantageous from the viewpoint of an improvement in the yield of polymers and the high polymerization. The amount of a ligand added is usually about 0.2 to 10 mol times, and preferably about 1 to 5 mol times, based on a transition metal atom in a zero-valent transition metal complex.

The amount of a zero-valent transition metal complex used is 0.1 mol time or more to the total molar amount (hereinafter, referred to as “total molar amount of all monomers”) of a monomer represented by the formula (1-h), a monomer represented by the formula (1-i) and a polymer represented by the formula (B-4), which are used in production of polymers. Since too small a use amount thereof is likely to make the molecular weight low, the use amount is preferably 1.5 mol times or more, more preferably 1.8 mol times or more, and still more preferably 2.1 mol times or more. On the other hand, the upper limit of the use amount is not especially limited, but since too large a use amount thereof brings about complexities in post-treatments in some cases, the use amount is preferably 5.0 mol times or less.

In the case of synthesizing a zero-valent transition metal complex from a transition metal compound by using a reducing agent, it suffices if the use amounts and the like of the transition metal compound and the reducing agent are set so that the zero-valent transition metal complex produced is in the above-mentioned range, and it suffices if the amount of the transition metal compound is, for example, 0.01 mol time or more, and preferably 0.03 mol time or more, to the total amount of all monomers. The upper limit of the use amount thereof is not limited, but since too large a use amount thereof is likely to bring about complexities in post-treatments, the use amount is preferably 5.0 mol times or less. It suffices if the amount of a reducing agent used is, for example, 0.5 mol time or more, and preferably 1.0 mol time or more, to the total amount of all monomers. The upper limit of the use amount thereof is not limited, but since too large a use amount thereof is likely to bring about complexities in post-treatments, the use amount is preferably 10 mol times or less.

The reaction temperature is usually about 0° C. to 200° C., and preferably about 10° C. to 100° C. The reaction time is usually about 0.5 to 48 hours.

A method for mixing a zero-valent transition metal complex, and a monomer represented by the formula (1-h) and/or a monomer represented by the formula (1-i) and a polymer represented by the formula (B-4), which are used in production of polymers, may be a method in which one thereof is added to the other, or a method in which the both are simultaneously added to a reaction vessel. The addition thereof may be addition at a stroke, but is preferably addition in little by little in consideration of heat generation, and is preferably in the presence of a solvent, and a suitable solvent in this case will be described later.

The condensation reaction is carried out usually in the presence of a solvent. Examples of such a solvent include aprotic polar solvents such as N,N-dimethylformamide (DMF), N,N-dimethylacetamide (DMAc), N-methylpyrrolidone (NMP), dimethyl sulfoxide (DMSO) and hexamethylphosphoric triamide; aromatic hydrocarbon solvents such as toluene, xylene, mesitylene, benzene and n-butylbenzene; etheric solvents such as tetrahydrofuran, 1,4-dioxane, dibutyl ether and tert-butyl methyl ether; esteric solvents such as ethyl acetate, butyl acetate and methyl benzoate; and alkyl halide solvents such as chloroform and dichloroethane. Notes in the parentheses indicate abbreviations of solvents, and in notes described later, these abbreviations may be used.

In order to make the molecular weight of produced polymers higher, since use of a solvent capable of sufficiently dissolving the polymers is desirable, use of tetrahydrofuran, 1,4-dioxane, DMF, DMAc, NMP, DMSO or toluene, which is a good solvent to the polymers produced, is preferable. These may be used as a mixture of two or more. Above all, at least one solvent selected from the group consisting of DMF, DMAc, NMP and DMSO, or a mixture of two or more solvents selected therefrom is preferably used.

The amount of a solvent is not especially limited, but since too low a concentration thereof can hardly recover polymers produced in some cases, and since too high a concentration thereof brings about a difficulty in agitation in some cases, the amount of a solvent to be used is determined so that the weight proportion of the solvent is preferably 1 weight times to 999 weight times, and more preferably 3 weight times to 199 weight times, with respect to the solvent and the monomers used in production of polymers (monomers selected from a monomer represented by the formula (1-h), a monomer represented by the formula (1-i) and a polymer represented by the formula (B-4)).

Polymers are thus obtained, but the produced polymers can be taken out from reaction mixtures by conventional methods. For example, the polymers are separated by adding a poor solvent, and target materials can be taken out by filtration or the like. As required, the materials may be refined by an ordinary refining method such as water washing or the reprecipitation using a good solvent and a poor solvent.

In the case where the ion-exchange group of a polymer produced has a form of a salt, in order to use the polymer as a member for a fuel cell, the ion-exchange group is preferably made in a form of a free acid, and the conversion to the form of a free acid can be carried out by washing with a common acidic solution. Examples of an acid to be used include hydrochloric acid, sulfuric acid and nitric acid, and are preferably dilute hydrochloric acid and dilute sulfuric acid.

Also in the case where a prepolymer having an ion-exchange group protected is obtained, in order to use the prepolymer as a member for a fuel cell, the protected ion-exchange group needs to be converted into an ion-exchange group in a form of a free acid. For such a conversion to an ion-exchange group in a form of a free acid, the hydrolysis with an acid or a base, or a deprotection reaction by a halogenated substance can be used. In the case of using a base, washing with an acidic solution as described above allows conversion into an ion-exchange group in the form of a free acid. Examples of the acid or base to be used include hydrochloric acid, sulfuric acid, nitric acid, sodium hydroxide and potassium hydroxide. Examples of the halogenated substance to be used include lithium bromide, sodium iodide, tetramethylammonium chloride and tetrabutylammonium bromide, and are preferably lithium bromide and tetrabutylammonium bromide. The conversion rate to an ion-exchange group can be determined by quantitatively determining the degree of the presence of characteristic peaks of a sulfonate ester or a sulfonamide in an infrared absorption spectrum and a nuclear magnetic resonance spectrum.

The amount of ion-exchange groups incorporated of a polyarylene block copolymer as a whole is, in terms of the ion-exchange capacity, preferably 1.5 meq/g or more, more preferably 2.0 meq/g or more, and still more preferably 2.5 meq/g or more. The amount thereof is preferably 7.0 meq/g or less, more preferably 6.0 meq/g or less, still more preferably 5.0 meq/g or less, and especially preferably 4.0 meq/g or less. If the ion-exchange capacity indicating the amount of ion-exchange groups incorporated is 1.0 meq/g or more, the proton conductivity becomes higher, and a function as a polymer electrolyte of a fuel cell is excellent, which is preferable. On the other hand, if the ion-exchange capacity indicating the amount of ion-exchange groups incorporated is 7.0 meq/g or less, the water resistance becomes better, which is preferable. The ion-exchange capacity is measured by acid-base titration.

The molecular weight of the polyarylene block copolymer according to the present invention is, in the polystyrene-equivalent weight-average molecular weight, preferably 50000 to 2000000, and particularly preferably 100000 to 1500000. The weight-average molecular weight is measured by gel permeation chromatography (GPC).

Any of the polyarylene block copolymers according to the present invention can suitably be used as a member for a fuel cell. The polyarylene block copolymer according to the present invention is preferably used as a polymer electrolyte of electrochemical devices such as fuel cells, and especially preferably used as a polymer electrolyte membrane. In descriptions hereinafter, mainly the case of the polymer electrolyte membrane described above will be described.

In this case, the polymer electrolyte according to the present invention is converted into a form of a membrane. This method (membrane forming method) is not especially limited, but membrane formation using a method of forming a membrane from a solution state (solution cast method) is preferable. The solution cast method is a method so far broadly used in the field concerned as production of a polymer electrolyte membrane, and industrially especially useful.

Specifically, a membrane is produced by dissolving the polymer electrolyte according to the present invention in an appropriate solvent to prepare a polymer electrolyte solution, which is then cast on a support base material, and removing the solvent. Examples of such a support base material include glass plates, and plastic films such as polyethylene (PE), polypropylene (PP), polyethylene terephthalate (PET), polyethylenenaphthalate (PEN) and polyimide (PI).

The solvent (cast solvent) used in the solution cast method is not especially limited as long as the solvent can sufficiently dissolve the polymer electrolyte according to the present invention, and can thereafter be removed, and suitably used are aprotic polar solvents such as NMP, DMAc, DMF, 1,3-dimethyl-2-imidazolidinone (DMI) and DMSO; chlorine-containing solvents such as dichloromethane, chloroform, 1,2-dichloroethane, chlorobenzene and dichlorobenzene; alcohols such as methanol, ethanol and propanol; and alkylene glycol monoalkyl ethers such as ethylene glycol monomethyl ether, ethylene glycol monoethyl ether, propylene glycol monomethyl ether and propylene glycol monoethyl ether. These may be used singly, but as required, as a mixture of two or more thereof. Above all, NMP, DMAc, DMF and DMI are preferable because these can provide a high solubility of the polymer electrolyte according to the present invention, and a polymer electrolyte membrane having a high water resistance, and NMP is more preferably used.

The thickness of a polymer electrolyte membrane thus obtained is not especially limited, but is preferably 5 to 300 μm in the practical range as a polymer electrolyte membrane (diaphragm) for a fuel cell. A membrane having a membrane thickness of 5 μm or more has an excellent practical strength, which is preferable; and a membrane of 300 μm or less is likely to have a low membrane resistance itself, which is preferable. The membrane thickness can be controlled by the weight concentration of the solution described above and the application thickness of the applied membrane on a support base material.

In order to improve various physical properties of a membrane, a polymer electrolyte may be prepared by adding additives such as a plasticizer, a stabilizer and a release agent as used in common polymers to the polyarylene block copolymer according to the present invention. Alternatively, a polymer electrolyte can be prepared by composite alloying another polymer with the polyarylene block copolymer according to the present invention by a method in which the polymers are mixed in the same solvent and concurrently cast. In the case where a polymer electrolyte is prepared by combining the polyarylene block copolymer according to the present invention with additives and/or another polymer, the types and the use amounts of the additives and/or the another polymer are determined such that desired characteristics can be obtained when the polymer electrolyte is applied to a member for a fuel cell.

Further in order to facilitate water control in fuel cell applications, also addition of inorganic or organic microparticles as a water retention agent is known. Any of these known methods can be used unless being contrary to the object of the present invention. In order to improve the mechanical strength or the like, a polymer electrolyte membrane thus obtained may be subjected to a treatment such as irradiation of an electron beam, radiation or the like.

In order to improve the strength, flexibility and durability of a polymer electrolyte membrane using the polymer electrolyte according to the present invention, a polymer electrolyte comprising the polyarylene block copolymer according to the present invention may be impregnated and composited in a porous base material to make a polymer electrolyte composite membrane (hereinafter, referred to as “composite membrane”). As the compositing method, known methods can be used.

The porous base material is not especially limited as long as it satisfies the above-mentioned use object, and examples thereof include porous membranes, woven fabrics, non-woven fabrics and fibrils, and a porous base material can be used not depending on the shapes and the materials. The material of the porous base material is, in consideration of the viewpoint of heat resistance and a reinforcement effect of physical strength, preferably an aliphatic polymer, or an aromatic polymer.

In the case of using a composite membrane using the polymer electrolyte according to the present invention as a polymer electrolyte membrane, the membrane thickness of a porous base material is preferably 1 to 100 μm, more preferably 3 to 30 μm, and especially preferably 5 to 20 μm. The pore diameter of the porous base material is preferably 0.01 to 100 μm, and more preferably 0.02 to 10 μm. The porosity of the porous base material is preferably 20 to 98%, and more preferably 40 to 95%.

If the membrane thickness of the porous base material is 1 μm or more, an effect on reinforcement of the strength after the compositing, and a reinforcing effect of imparting flexibility and durability are better, and gas leakage (cross leak) hardly occurs. If the membrane thickness is 100 μm or less, the electric resistance becomes lower to thereby make an obtained composite membrane a better one as a polymer electrolyte membrane for a fuel cell. If the pore diameter is 0.01 μm or more, filling of the polymer according to the present invention becomes easier; and if the pore diameter is 100 μm or less, a reinforcing effect becomes larger. If the porosity is 20% or more, the resistance as a polymer electrolyte membrane becomes smaller; and if the porosity is 98% or less, the strength of a porous base material itself becomes larger to thereby more improve the reinforcing effect, which is preferable.

A composite membrane prepared by using the polymer electrolyte according to the present invention and a polymer electrolyte membrane prepared by using the polymer electrolyte according to the present invention are laminated, and the laminate may be used as a proton conductive membrane.

In the present invention, “a block copolymer” refers to a molecular structure in which two or more polymers having different chemical properties have been linked via covalent bonds to form a long chain. In the present invention, the polymer described above is referred to as “a block”. A block refers to a structure in which 3 or more of repeating units having the same skeleton have been linked. In the case where the repeating unit has divalent groups in the main chain, the divalent groups at block terminals may lack. The divalent group at the terminal includes an oxygen atom (—O—) and a sulfur atom (—S—). The block is preferably a block having 3 or more of one type of a repeating unit linked. Here, the skeleton refers to a skeleton which is the main chain constituting a polymer and contains no substituent. In the present invention, polymers “having different chemical properties” refer to a polymer having ion-exchange groups and a polymer having substantially no ion-exchange group. Here, “the ion-exchange group” is a group that will participate ionic conduction, particularly protonic conduction when the polyarylene block copolymer according to the present invention is used as a membrane; “having an ion-exchange group” means that the number of ion-exchange groups which one repeating unit has is about 0.5 or more on average; and “having substantially no ion-exchange group” means that the number of ion-exchange groups which one repeating unit has is about 0.1 or less on average.

The block having substantially no ion-exchange group in the polyarylene block copolymer according to the present invention will be described.

The block having substantially no ion-exchange group is a block having the number of the ion-exchange group of 0.1 or less as calculated as the number per the repeating unit, and especially preferably a block having the number of the ion-exchange group of 0, that is, having substantially nil ion-exchange group.

The block having substantially no ion-exchange group is preferably a block comprising a structure represented by the following formula (C-1), and preferably a block comprising only a structure represented by the following formula (C-1):

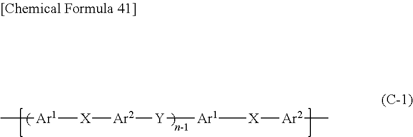

Here, n in the formula (C-1) denotes an integer of 3 to 45, and is preferably 6 or more, and more preferably 11 or more. On the other hand, n is preferably 40 or less, and more preferably 35 or less. Although the reason why the regulation of n in such a range develops the effect as described above is not necessarily clear, the present inventors presume the reason as follows. A polymer electrolyte membrane prepared by using a polymer electrolyte comprising the polyarylene block copolymer according to the present invention is presumed to form a high-order structure having a micro phase separation structure having a hydrophobic region and a hydrophilic region. The micro phase separation structure of the polymer electrolyte membrane according to the present invention is presumed to have a smaller period length, and to be a structure in which moisture necessary for protonic conduction more hardly transpires from the membrane by the capillary phenomenon, than known membranes. Therefore, it is conceivable that even under high-temperature and low-moisture conditions, the proton conductivity is easily secured and good power generation characteristics are exhibited. n can be determined by ¹H-NMR. In the case where n in a polymer has a distribution, n can be determined by taking an average value of n of blocks having substantially no ion-exchange group.

Ar¹ and Ar² in the above formula (C-1) each independently denote an arylene group. Examples of the arylene group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. Divalent monocyclic aromatic groups are preferable.

Ar¹ and Ar² may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent.

Here, examples of the alkyl group having 1 to 20 carbon atoms that may have a substituent include alkyl groups having 1 to 20 carbon atoms, such as a methyl group, an ethyl group, a n-propyl group, an isopropyl group, a n-butyl group, a sec-butyl group, an isobutyl group, a n-pentyl group, a 2,2-dimethylpropyl group, a cyclopentylic group, a n-hexyl group, a cyclohexyl group, a 2-methylpentyl group, a 2-ethylhexyl group, a nonyl group, a dodecyl group, a hexadecyl group, an octadecyl group and an icosyl group, and include these alkyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the alkoxy group having 1 to 20 carbon atoms that may have a substituent include alkoxy groups having 1 to 20 carbon atoms, such as a methoxy group, an ethoxy group, a n-propyloxy group, an isopropyloxy group, a n-butyloxy group, a sec-butyloxy group, a tert-butyloxy group, an isobutyloxy group, a n-pentyloxy group, a 2,2-dimethylpropyloxy group, a cyclopentyloxy group, a n-hexyloxy group, a cyclohexyloxy group, a 2-methylpentyloxy group, 2-ethylhexyloxy group, a dodecyloxy group, a hexadecyloxy group and an eicosyloxy group, and include these alkoxy groups substituted with a substituent such as a fluorine atom, a hydroxyl group, a nitrite group, an amino group, a methoxy group, an ethoxy group, an isopropyloxy group, a phenyl group, a naphthyl group, a phenoxy group and a naphthyloxy group, and having 20 or less carbon atoms in total.

Examples of the aryl group having 6 to 20 carbon atoms that may have a substituent include aryl groups such as a phenyl group, a naphthyl group, a phenanthrenyl group and an anthracenyl group, and include these aryl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the aryloxy group having 6 to 20 carbon atoms that may have a substituent include aryloxy groups such as a phenoxy group, a naphthyloxy group, a phenanthrenyloxy group and an anthracenyloxy group, and include these aryloxy groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Examples of the acyl group having 2 to 20 carbon atoms that may have a substituent include acyl groups having 2 to 20 carbon atoms, such as an acetyl group, a propionyl group, a butyryl group, an isobutyryl group, a benzoyl group, 1-naphthoyl group and a 2-naphthoyl group, and include these acyl groups substituted with a substituent such as a fluorine atom, a hydroxyl group, a nitrile group, an amino group, a methoxy group, an ethoxy group, an isopropyloxy group, a phenyl group, a naphthyl group, a phenoxy group and a naphthyloxy group, and having 20 or less carbon atoms in total.

Substituents, which the alkyl groups described above having 1 to 20 carbon atoms, the alkoxy groups described above having 1 to 20 carbon atoms, the aryl groups described above having 6 to 20 carbon atoms, the aryloxy groups described above having 6 to 20 carbon atoms and the acyl groups described above having 2 to 20 carbon atoms may have, include a fluorine atom, a hydroxyl group, a nitrile group, an amino group, a methoxy group, an ethoxy group, an isopropyloxy group, a phenyl group, a naphthyl group, a phenoxy group and a naphthyloxy group.

X in the above formula (C-1) denotes a carbonyl group (—C(═O)—) or a sulfonyl group (—S(═O)₂—). Y denotes an oxygen atom (—O—) or a sulfur atom (—S—).

In the polyarylene block copolymer according to the present invention, the block having substantially no ion-exchange group preferably comprises the following formula (C-2):

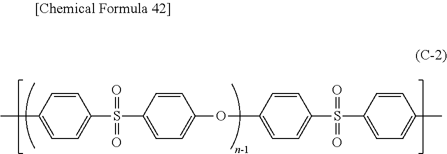

wherein in the formula (C-2), n has the same meaning as in the above formula (C-1).

The block having ion-exchange groups relevant to the polyarylene block copolymer according to the present invention has a polyarylene structure in which a plurality of aromatic rings are linked together substantially directly, wherein part or all of the ion-exchange groups are directly bonded to the aromatic rings constituting the main chain. Here, the polyarylene structure will be described. The block having ion-exchange groups of the polyarylene block copolymer according to the present invention has a form in which aromatic rings constituting the main chain are substantially directly bonded, and a higher proportion of direct bonds of aromatic rings constituting the main chain of the block to the total number of bonds of the aromatic rings is likely to achieve a more improvement in the proton conductivity, which is preferable. Specifically, in the polyarylene structure, the proportion of direct bonds is preferably 80% or higher, more preferably 90% or higher, and still more preferably 95% or higher, based on 100% of the total number of bonds of the aromatic rings. Bonds except a direct bond refer to a form in which aromatic rings are bonded together through a divalent atom or a divalent atom group. Examples of the divalent atom include groups represented by —O— and —S—. Examples of the divalent atom group include groups represented by —C(CH₃)₂—, —C(CF₃)₂—, —CH═CH—, —S(═O)₂— and —C(═O)—.

The present inventors have found that the case where ion-exchange groups of a block having the ion-exchange groups are directly bonded to aromatic rings constituting the main chain of the block is more advantageous from the viewpoint of a proton conductivity in a high level. Therefore, a higher proportion of aromatic rings constituting the main chain to which ion-exchange groups are directly bonded among aromatic rings having ion-exchange groups in the block is more likely to provide a polymer electrolyte membrane excellent in the proton conductivity. The proportion of aromatic rings to which ion-exchange groups are directly bonded is preferably 20 mol % or more, more preferably 30 mol % or more, and still more preferably 50 mol % or more, based on 100 mol % of the total of the aromatic rings linked via direct bonds. When the polyarylene block copolymer is used as a member for a fuel cell, substantially all of ion-exchange groups are preferably in a form of a free acid. Here, “main chain of a block” or “main chain” refers to the longest chain forming a block. This chain is constituted of carbon atoms mutually bonded through covalent bonds, and then, may be interrupted by nitrogen atoms, oxygen atoms and the like. “Aromatic ring to constitute the main chain of a block” or “aromatic ring constituting the main chain of a block” refers to an aromatic ring whose two bonds among all bonds thereof constitutes a part of the main chain of the block.

As the ion-exchange group described above, an acid group is usually used. The acid group includes acid groups such as weak acids, strong acids and superstrong acids, but is preferably strong acids and superstrong acids. Examples of the acid group include weak acids such as a phosphonic acid group and a carboxylic acid group; and strong acids such as a sulfonic acid group and a sulfonimide group (—SO₂—NH—SO₂—R, wherein R denotes a monovalent substituent such as an alkyl group or an aryl group), and above all, a sulfonic acid group and a sulfonimide group as strong acid groups are preferably used. It is also preferable to replace a hydrogen atom on the substituent (—R) of the aromatic ring and/or the sulfonimide group by an electrophilic group such as a fluorine atom and thereby cause the strong acid group described above to function as a superstrong acid group by utilizing an effect of the electrophilic group such as a fluorine atom. These ion-exchange groups may be partially or wholly replaced by metal ions, quaternary ammonium ions or the like to form salts.

The block having ion-exchange groups relevant to the polyarylene block copolymer according to the present invention is suitably a block represented by the following formula (C-3):

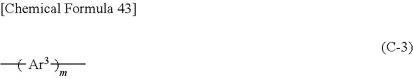

In the formula (C-3), m denotes an integer of 3 or more, and Ar³ denotes an arylene group. Here, the arylene group may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent. At least one ion-exchange group is directly bonded to an aromatic ring constituting the main chain of Ar³. The plurality of Ar³ may be identical or different from each other.

The block may be a copolymerized block of a block represented by the above formula (C-3) and another repeating structure, and having the number of ion-exchange groups of 0.5 or more on average as calculated as the number of the ion-exchange groups per the repeating unit. In the case of a copolymerized block with another repeating structure, the content of the block represented by the formula (C-3) is preferably 50 mol % to 100 mol %, and the content of 70 mol % to 100 mol % is especially preferable because the proton conductivity as a polymer electrolyte for a fuel cell is sufficient.

Here, m in the formula (C-3) denotes an integer of 3 or more, and is preferably in the range of 5 to 100, and more preferably in the range of 10 to 100. If the value of m is 3 or more, the proton conductivity as a polymer electrolyte for a fuel cell is sufficient, which is preferable. If the value of m is 100 or less, the production is easier, which is preferable. In the case where a block having ion-exchange groups is a copolymerized block with another repeating structure, the copolymerized block comprises a block represented by the above formula (C-3).

Ar³ in the above formula (C-3) denotes an arylene group. Examples of the arylene group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and divalent aromatic heterocyclic groups such as a pyridinediyl group, a quinoxalinediyl group and a thiophenediyl group. Monocyclic aromatic groups are preferable.

Ar³ may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent, and specific examples thereof include ones described above.

A preferable example of a structure represented by the above formula (C-3) includes a structure represented by the formula (C-4) shown below. A block having such a structure is preferable because a raw material industrially easily available can be used in production of the block.

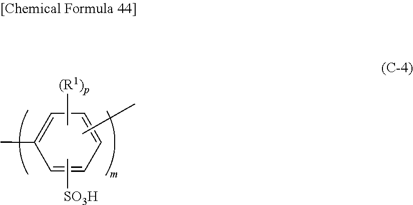

In the formula (C-4), m has the same meaning as in the above formula (C-3). R¹ denotes at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent. p is an integer of 0 to 3. In the case where R¹ are present in a plural number, R¹ may be identical or different from each other.

Here, specific examples of R¹ include specific examples described above of the alkyl groups, the alkoxy groups, the aryl groups, the aryloxy groups and the acyl groups. The number of the substituent, p, is preferably 0 or 1, and especially preferably, p is 0, that is, the repeating unit has no substituent.

The amount of the ion-exchange group incorporated of a block having ion-exchange groups of the polyarylene block copolymer according to the present invention is, in to ins of the ion-exchange capacity, preferably 2.5 meq/g to 10.0 meq/g, more preferably 5.5 meq/g to 9.0 meq/g, and especially preferably 5.5 meq/g to 7.0 meq/g. If the ion-exchange capacity indicating the amount of the ion-exchange group incorporated is 2.5 meq/g or more, ion-exchange groups are closely adjacent and the proton conductivity becomes higher when a polyarylene block copolymer is made, which is preferable. On the other hand, If the ion-exchange capacity indicating the amount of the ion-exchange group incorporated is 10.0 meq/g or less, the production is easier, which is preferable.

The amount of ion-exchange groups incorporated of a polyarylene block copolymer as a whole is, in terms of the ion-exchange capacity, preferably 0.5 meq/g to 5.0 meq/g, and 1.0 meq/g to 4.5 meq/g. If the ion-exchange capacity indicating the amount of ion-exchange groups incorporated is 0.5 meq/g or more, the proton conductivity becomes higher, and a function as a polymer electrolyte of a fuel cell is excellent, which is preferable. On the other hand, if the ion-exchange capacity indicating the amount of ion-exchange groups incorporated is 5.0 meq/g or less, the water resistance becomes better, which is preferable.

The molecular weight of the polyarylene block copolymer according to the present invention is preferably 5000 to 1000000, and particularly preferably 15000 to 400000, in the polystyrene-equivalent number-average molecular weight. The number-average molecular weight is measured by gel permeation chromatography (GPC).

Next, a suitable method for producing the polyarylene block copolymer according to the present invention will be described. A suitable block having ion-exchange groups in the polyarylene block copolymer is a block represented by the above formula (C-1), and a method for incorporating ion-exchange group bonded to aromatic rings constituting the main chain in Ar¹ may be a method in which a monomer having an ion-exchange group in advance is polymerized, or a method in which after a block is produced from a monomer having no ion-exchange group in advance, ion-exchange groups are incorporated. Above all, the former method is more preferable because the amount of an ion-exchange group incorporated and the substitution position can accurately be controlled.

An example of methods of producing the polyarylene block copolymer according to the present invention by using a monomer having an ion-exchange group includes a method in which a monomer represented by the formula (C-6) shown below and a precursor of a block represented by the formula (C-7) shown below and having substantially no ion-exchange group are polymerized by condensation reaction to produce the polyarylene block copolymer.

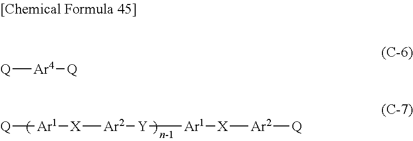

In the formula (C-6), Ar⁴ is an aryl group that may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and is the aryl group in which an ion-exchange group and/or a group to become an ion-exchange group (ion-exchange precursor group) is bonded to an aromatic ring constituting the main chain. Q denotes a group to leave in condensation reaction, and the plurality of Q may be identical or different from each other. Ar¹, Ar², n, X and Y have the same meaning as described above.

Examples of the monomer represented by the above (C-6) and having a sulfonic acid group as a preferable ion-exchange group include 2,4-dichlorobenzenesulfonic acid, 2,5-dichlorobenzenesulfonic acid, 3,5-dichlorobenzenesulfonic acid, 2,4-dichloro-5-methylbenzenesulfonic acid, 2,5-dichloro-4-methylbenzenesulfonic acid, 2,4-dichloro-5-methoxybenzenesulfonic acid, 2,5-dichloro-4-methoxybenzenesulfonic acid, 3,3′-dichlorobiphenyl-2,2′-disulfonic acid, 4,4′-dichlorobiphenyl-2,2′-disulfonic acid, 4,4′-dichlorobiphenyl-3,3′-disulfonic acid and 5,5′-dichlorobiphenyl-2,2′-disulfonic acid. Monomers can be used in which chlorine atoms present in these monomers described above are replaced by groups to leave in the condensation reaction described before. Further, sulfonic acid groups of these monomers may form salts, and monomers having sulfonic acid precursor groups in place of sulfonic acid groups can be used. In the case where a sulfonic acid group forms a salt, a counter ion thereof is preferably alkaline metal ions, and especially preferably a Li ion, a Na ion and a K ion. The sulfonic acid precursor group is preferably one which can be converted into a sulfonic acid group by a simple operation such as hydrolysis treatment or oxidation treatment. Particularly in order to produce the polymer according to the present invention, use of a monomer having a sulfonic acid group in a form of a salt, or a monomer having a sulfonic acid precursor group is preferable from the viewpoint of polymerization reactivity.

The sulfonic acid precursor group is preferably one having a form in which a sulfonic acid group forms an ester or an amide and is protected, like sulfonate ester (—SO₃R^{c}, wherein R^{c} denotes an alkyl group having 1 to 20 carbon atoms), or sulfonamide (—SO₂N(R^{d})(R^{e}), wherein R^{d} and R^{e} each independently denote a hydrogen atom, an alkyl group having 1 to 20 carbon atoms, or an aromatic group having 3 to 20 carbon atoms). Examples of the sulfonate ester include methyl sulfonate, an ethyl sulfonate group, n-propyl sulfonate, isopropyl sulfonate, a n-butyl sulfonate group, a sec-butyl sulfonate group, tert-butyl sulfonate, n-pentyl sulfonate, neopentyl sulfonate, n-hexyl sulfonate, cyclohexyl sulfonate, n-heptyl sulfonate, n-octyl sulfonate, n-nonyl sulfonate, n-decylsulfonate, n-dodecylsulfonate, n-undecyl sulfonate, n-tridecylsulfonate, n-tetradecylsulfonate, n-pentadecyl sulfonate, n-hexadecylsulfonate, n-heptadecylsulfonate, n-octadecyl sulfonate, n-nonadecylsulfonate and n-eicosyl sulfonate, and are preferably sec-butyl sulfonate, neopentyl sulfonate and cyclohexyl sulfonate. These sulfonate esters may be substituted with a substituent not influencing the polymerization reaction.

Examples of the sulfonamide include sulfonamide, N-methylsulfonamide, N,N-dimethylsulfonamide, N-ethylsulfonamide, N,N-diethylsulfonamide, N-n-propylsulfonamide, di-n-propylsulfonamide, N-isopropylsulfonamide, N,N-diisopropylsulfonamide, N-n-butyl sulfonamide, N,N-di-n-butylsulfonamide, N-sec-butylsulfonamide, N,N-di-sec-butylsulfonamide, N-tert-butylsulfonamide, N,N-di-tert-butylsulfonamide, N-n-pentylsulfonamide, N-neopentylsulfonamide, N-n-hexylsulfonamide, N-cyclohexylsulfonamide, N-n-heptylsulfonamide, N-n-octylsulfonamide, N-n-nonylsulfonamide, N-n-decylsulfonamide, N-n-dodecylsulfonamide, N-n-undecylsulfonamide, N-n-tridecylsulfonamide, N-n-tetradecylsulfonamide, N-n-pentadecylsulfonamide, N-n-hexadecylsulfonamide, N-n-heptadecylsulfonamide, N-n-octadecylsulfonamide, N-n-nonadecylsulthnamide, N-n-eicosylsulfonamide, N,N-diphenyl sulfonamide, N,N-bistrimethylsilylsulfonamide, N,N-bis-tert-butyldimethylsilylsulfonamide, pyrrolylsulfonamide, pyrrolidinylsulfonamide, piperidinylsulfonamide, carbazolylsulfonamide, dihydroindolylsulfonamide and dihydroisoindolylsulfonamide, and are preferably N,N-diethylsulfonamide, N-n-dodecylsulfonamide, pyrrolidinylsulfonamide and piperidinylsulfonamide. These sulfonamides may be substituted with a substituent not influencing the polymerization reaction.

As the sulfonic acid precursor group, a mercapto group can be used. A mercapto group can be converted into a sulfonic acid group by using an appropriate oxidizing agent to oxidize the mercapto group.

In the case of other ion-exchange groups, the other ion-exchange groups can be selected by replacing the sulfonic acid groups of monomers described above as examples by ion-exchange groups such as carboxylic acid groups and phosphoric acid groups. Also monomers having these other ion-exchange groups are commercially easily available, or can be produced using known production methods.

In the formulae (C-6) and (C-7), Q denotes a group to leave in condensation reaction, and specific examples thereof include halogen atoms such as a chlorine atom, a bromine atom and an iodine atom, a p-toluenesulfonyloxy group, a methanesulfonyloxy group, a trifluoromethanesulfonyloxy group and groups containing a boron atom shown below:

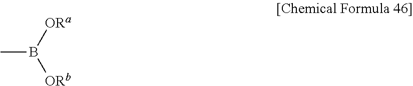

wherein R^{a} and R^{b} each independently denote a hydrogen atom or an organic group, and R^{a} and R^{b} may bond to form a ring.

An example of a method of carrying out the incorporation of ion-exchange groups after polymerization to produce the polyarylene block copolymer according to the present invention include a method in which a compound represented by the formula (C-8) shown below and a precursor of a block represented by the above formula (C-6) and having substantially no ion-exchange group are polymerized by condensation reaction, and thereafter ion-exchange groups are incorporated according to a known method to produce the polyarylene block copolymer.

[Chemical Formula 47]

Q-Ar⁵-Q (C-8)

In the formula (C-8), Ar⁵ denotes an aryl group which can be converted into Ar³ of the above formula (C-3) by the incorporation of ion-exchange groups, and Q has the same meaning as in the above formula (C-6).

Here, Ar⁵ may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent, but Ar⁵ is an aryl group having a structure capable of incorporating at least one ion-exchange group. Examples of the aryl group include divalent monocyclic aromatic groups such as a 1,3-phenylene group and a 1,4-phenylene group, divalent condensed ring aromatic groups such as a 1,3-naphthalenediyl group, a 1,4-naphthalenediyl group, a 1,5-naphthalenediyl group, a 1,6-naphthalenediyl group, a 1,7-naphthalenediyl group, a 2,6-naphthalenediyl group and a 2,7-naphthalenediyl group, and heterocyclic groups such as a pyridinediyl group, a quinoxalinediyl group and a thiophenediyl group. Examples of the alkyl group having 1 to 20 carbon atoms that may have a substituent, the alkoxy group having 1 to 20 carbon atoms that may have a substituent, the aryl group having 6 to 20 carbon atoms that may have a substituent, the aryloxy group having 6 to 20 carbon atoms that may have a substituent, and the acyl group having 2 to 20 carbon atoms that may have a substituent include the same as the examples describe above as substituents in Ar³.

A structure of Ar⁵ to which an ion-exchange group can be incorporated indicates having a hydrogen atom directly bonded to an aromatic ring, or having a substituent capable of being converted into an ion-exchange group. The substituent capable of being converted into an ion-exchange group is not especially limited as long as the substituent does not inhibit the polymerization reaction, but examples thereof include a mercapto group, a methyl group, a formyl group, a hydroxy group and a bromo group.

Taking an incorporation method of an sulfonic acid group as an example of an incorporation method of an ion-exchange group, there is a method in which a polyarylene block copolymer obtained by polymerization is dissolved or dispersed in concentrated sulfuric acid, or at least partially dissolved in an organic solvent, and thereafter, is acted on by concentrated sulfuric acid, chlorosulfuric acid, fuming sulfuric acid, sulfur trioxide or the like to convert hydrogen atoms to sulfonic acid groups. Typical examples of these monomers include 1,3-dichlorobenzene, 1,4-dichlorobenzene, 1,3-dibromobenzene, 1,4-dibromobenzene, 1,3-diiodobenzene, 1,4-diiodobenzene, 1,3-dichloro-4-methoxybenzene, 1,4-dichloro-3-methoxybenzene, 1,3-dibromo-4-methoxybenzene, 1,4-dibromo-3-methoxybenzene, 1,3-diiodo-4-methoxybenzene, 1,4-diiodo-3-methoxybenzene, 1,3-dichloro-4-acetoxybenzene, 1,4-dichloro-3-acetoxybenzene, 1,3-dibromo-4-acetoxybenzene, 1,4-dibromo-3-acetoxybenzene, 1,3-diiodo-4-acetoxybenzene, 1,4-diiodo-3-acetoxybenzene, 4,4′-dichlorobiphenyl, 4,4′-dibromobiphenyl, 4,4′-diiodobiphenyl, 4,4′-dichloro-3,3′-dimethylbiphenyl, 4,4′-dibromo-3,3′-dimethylbiphenyl, 4,4′-diiodo-3,3′-dimethylbiphenyl, 4,4′-dichloro-3,3′-dimethoxybiphenyl, 4,4′-dibromo-3,3′-dimethoxybiphenyl and 4,4′-diiodo-3,3′-dimethoxybiphenyl.

If a monomer represented by the above formula (C-8) has a mercapto group, a block having mercapto groups at the completion of the polymerization reaction can be obtained, and the mercapto groups can be converted into sulfonic acid groups by oxidation reaction. Typical such monomers include 2,4-dichlorobenzenethiol, 2,5-dichlorobenzenethiol, 3,5-dichlorobenzenethiol, 2,4-dibromobenzenethiol, 2,5-dibromobenzenethiol, 3,5-dibromobenzenethiol; 2,4-diiodobenzenethiol, 2,5-diiodobenzenethiol, 3,5-diiodobenzenethiol, 2,5-dichloro-1,4-benzenedithiol, 3,5-dichloro-1,2-benzenedithiol, 3,6-dichloro-1,2-benzenedithiol, 4,6-dichloro-1,3-benzenedithiol, 2,5-dibromo-1,4-benzenedithiol, 3,5-dibromo-1,2-benzenedithiol, 3,6-dibromo-1,2-benzenedithiol, 4,6-dibromo-1,3-benzenedithiol, 2,5-diiodo-1,4-benzenedithiol, 3,5-diiodo-1,2-benzenedithiol, 3,6-diiodo-1,2-benzenedithiol and 4,6-diiodo-1,3-benzenedithiol, and further include monomers obtained by protecting the mercapto groups of the monomers described above as examples.

Examples of methods for incorporating a carboxylic acid group include known methods such as a method of converting a methyl group or a formyl group to a carboxylic acid group by oxidation reaction, and a method in which a bromo group is converted into —MgBr by the action of Mg, and thereafter, is converted into a carboxylic acid group by the action of carbon dioxide. Here, typical monomers having a methyl group include 2,4-dichlorotoluene, 2,5-dichlorotoluene, 3,5-dichlorotoluene, 2,4-dibromotoluene, 2,5-dibromotoluene, 3,5-dibromotoluene, 2,4-diiodotoluene, 2,5-diiodotoluene and 3,5-diiodotoluene.

Examples of methods for incorporating a phosphonic acid group include known methods such as a method in which a bromo group is converted into a phosphonic acid diester group by the action of trialkyl phosphite in the presence of a nickel compound such as nickel chloride, and thereafter, is converted into a phosphonic acid group by hydrolysis, a method in which a C—P bond is formed by using phosphorus trichloride, phosphorus pentachloride or the like in the presence of a Lewis acid catalyst, and then, is converted into a phosphonic acid group, by oxidation and hydrolysis as required, and a method in which a hydrogen atom is converted into a phosphonic acid by the action of a phosphoric acid anhydride at a high temperature.

Examples of methods for incorporating a sulfonimide group include known methods such as a method in which the above-mentioned sulfonic acid group is converted into a sulfonimide group by condensation reaction, substitution reaction or the like.

Here, Q is a group to leave in condensation reaction, and the same as described as the examples of the above formulae (C-6) and (C-7).

Suitable typical examples of the precursor represented by the above formula (C-7) include monomers shown below as examples. In these examples, n and Q have the same meaning as described above.

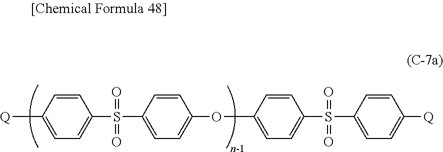

The polymerization by condensation reaction is carried out in the presence of a zero-valent transition metal complex. The zero-valent transition metal complex is a complex in which a halogen or a ligand described later is coordinated to a transition metal, and is preferably one having at least one ligand described later. The zero-valent transition metal complex to be used may be either of a commercially available product and a separately synthesized one. Examples of methods for synthesizing a zero-valent transition metal complex include known methods such as a method in which a transition metal salt or a transition metal oxide and a ligand are reacted. A zero-valent transition metal complex synthesized may be used after being taken out, or may be used in situ without being taken out.

Examples of the ligand include acetate, acetylacetonato, 2,2′-bipyridyl, 1,10-phenanthroline, methylenebisoxazoline, N,N,N′,N′-tetramethylethylenediamine, triphenylphosphine, tritolylphosphine, tributylphosphine, triphenoxyphosphine, 1,2-bisdiphenylphosphinoethane and 1,3-bisdiphenylphosphinopropane.

Examples of the zero-valent transition metal complex include zero-valent nickel complexes, zero-valent palladium complexes, zero-valent platinum complexes and zero-valent copper complexes. Among these transition metal complexes, zero-valent nickel complexes and zero-valent palladium complexes are preferably used, and zero-valent nickel complexes are more preferably used.

Examples of the zero-valent nickel complexes include bis(1,5-cyclooctadiene)nickel(0), (ethylene)bis (triphenylphosphine)nickel(0) and tetrakis(triphenylphosphine)nickel. Above all, bis(1,5-cyclooctadiene)nickel(0) is preferably used from the viewpoint of the reactivity, the yield of polymers obtained and the high polymerization of polymers obtained. Examples of the zero-valent palladium complex include tetrakis(triphenylphosphine)palladium(0).

These zero-valent transition metal complexes may be synthesized as described above, or commercially available ones may be used. Examples of the synthesis methods of a zero-valent transition metal complex include known methods such as a method of making the atomic valence of a transition metal compound to be zero-valent by a reducing agent such as zinc or magnesium. The zero-valent transition metal complex synthesized may be used after being taken out, or may be used in situ without being taken out.

In the case where a zero-valent transition metal complex is generated from a transition metal compound by a reducing agent, as the transition metal compound to be used, compounds of a zero-valent transition metal may be used, but use of divalent ones is usually preferable. Above all, divalent nickel compounds and divalent palladium compounds are preferable. The divalent nickel compounds include nickel chloride, nickel bromide, nickel iodide, nickel acetate, nickel acetylacetonato, bis(triphenylphosphine)nickel chloride, bis(triphenylphosphine)nickel bromide and bis(triphenylphosphine)nickel iodide. Divalent palladium compounds include palladium chloride, palladium bromide, palladium iodide and palladium acetate.

The reducing agent includes zinc, magnesium, sodium hydride, hydrazine and derivatives thereof and lithium aluminum hydride. As required, ammonium iodide, trimethylammonium iodide, triethylammonium iodide, lithium iodide, sodium iodide and potassium iodide can be used concurrently.

In the condensation reaction using the transition metal complexes described above, a compound to become a ligand of a zero-valent transition metal complex used is preferably added from the viewpoint of an improvement in the yield of polymers obtained. The compound to be added may be the same as or different from the ligand of the zero-valent transition metal complex used.

Examples of the compound to become a ligand include the compounds described before as examples of ligands, and are preferably triphenylphosphine and 2,2′-bipyridyl from the viewpoint of the versatility, the economic efficiency, the reactivity, the yield of polymers obtained and the high polymerization of polymers obtained. Particularly use of 2,2′-bipyridyl is especially advantageous from the viewpoint of an improvement in the yield of polymers and the high polymerization. The amount of a ligand to be added is usually about 0.2 to 10 mol times, and preferably about 1 to 5 mol times, based on a transition metal atom present in a zero-valent transition metal complex.

The amount of a zero-valent transition metal complex to be used is 0.1 mol time or more to the total molar amount (hereinafter, referred to as “total molar amount of all monomers”) of a monomer represented by the formula (C-6), a precursor represented by the formula (C-7) and a monomer represented by the formula (C-8), which are used in production of polymers. Since too small a use amount thereof is likely to make the molecular weight low, the use amount is preferably 1.5 mol times or more, more preferably 1.8 mol times or more, and still more preferably 2.1 mol times or more. On the other hand, the upper limit of the use amount is not especially limited, but since too large a use amount thereof brings about complexities in post-treatments in some cases, the use amount is preferably 5.0 mol times or less.

In the case of synthesizing a zero-valent transition metal complex from a transition metal compound by using a reducing agent, it suffices if the use amounts and the like of the transition metal compound and the reducing agent are set so that the zero-valent transition metal complex produced is in the above-mentioned range, and it suffices if the amount of the transition metal compound is, for example, 0.01 mol time or more, and preferably 0.03 mol time or more, to the total amount of all monomers. The upper limit of the use amount thereof is not limited, but since too large a use amount thereof is likely to bring about complexities in post-treatments, the use amount is preferably 5.0 mol times or less. It suffices if the amount of a reducing agent used is, for example, 0.5 mol time or more, and preferably 1.0 mol time or more, to the total amount of all monomers. The upper limit of the use amount thereof is not limited, but since too large a use amount thereof is likely to bring about complexities in post-treatments, the use amount is preferably 10 mol times or less.

The reaction temperature is usually about 20° C. to 200° C., and preferably about 20° C. to 100° C. The reaction time is usually about 0.5 to 24 hours.

A method for mixing a zero-valent transition metal complex, and a monomer selected from a monomer represented by the formula (C-6), a precursor represented by the formula (C-7) and a monomer represented by the formula (C-8), which are used in production of polymers, may be a method in which one thereof is added to the other, or a method in which the both are simultaneously added to a reaction vessel. The addition thereof may be addition at a stroke, but is preferably addition in little by little in consideration of heat generation, and the addition is preferably in the presence of a solvent, and a suitable solvent in this case will be described later.

The condensation reaction is usually carried out in the presence of a solvent. Examples of such a solvent include aprotic polar solvents such as N,N-dimethylformamide N,N-dimethylacetamide (DMAc), N-methylpyrrolidone (NMP), dimethyl sulfoxide (DMSO) and hexamethylphosphoric triamide; aromatic hydrocarbons such as toluene, xylene, mesitylene, benzene and n-butylbenzene; etheric solvents such as tetrahydrofuran, 1,4-dioxane, dibutyl ether and tert-butyl methyl ether; esteric solvents such as ethyl acetate, butyl acetate and methyl benzoate; and halogen-containing solvents such as chloroform and dichloroethane. Notes in the parentheses indicate abbreviations of solvents, and in notes described later, these abbreviations may be used.

In order to make the molecular weight of polymers higher, since use of a solvent capable of sufficiently dissolving polymers, that is, a good solvent to polymers, is desirable. As the good solvent to polymers produced, tetrahydrofuran, 1,4-dioxane, DMF, DMAc, NMP, DMSO or toluene is preferable. These may be used as a mixture of two or more. Above all, at least one solvent selected from the group consisting of DMF, DMAc, NMP and DMSO, or a mixture of two or more solvents selected therefrom is preferably used.

The amount of a solvent is not especially limited, but since too low a concentration thereof can hardly recover polymers produced in some cases, and since too high a concentration thereof brings about a difficulty in agitation in some cases, the amount of the solvent used is preferably determined so that the amount of the solvent is 1 weight time to 999 weight times, and more preferably 3 weight times to 199 weight times, with respect to monomers (monomers selected from a monomer represented by the formula (C-6), a precursor represented by the formula (C-7) and a monomer represented by the formula (C-8)), which are used for production of polymers.

The polyarylene block copolymer according to the present invention, or a prepolymer capable of being converted into the polyarylene block copolymer according to the present invention is thus obtained, but the polyarylene block copolymer and the like produced can be taken out from a reaction mixture by a conventional method. For example, the polyarylene block copolymer and the like are separated by adding a poor solvent, and target materials can be taken out by filtration or the like. As required, the materials may be refined by an ordinary refining method such as water washing or the reprecipitation using a good solvent and a poor solvent.

In the case where the sulfonic acid group of the polymer produced has a form of a salt, in order to use the polymer as a member for a fuel cell, the sulfonic acid group is preferably made in a form of a free acid, and the conversion to the form of a free acid can be carried out by washing with a common acidic solution. Examples of an acid to be used include hydrochloric acid, sulfuric acid and nitric acid, and are preferably dilute hydrochloric acid and dilute sulfuric acid.

Also in the case where a prepolymer having sulfonic acid groups protected is obtained, in order to use the polymer as a member for a fuel cell, the protected sulfonic acid groups need to be converted into sulfonic acid groups in the form of a free acid. The conversion to the sulfonic acid group in the form of a free acid can be carried out, for example, by the hydrolysis with an acid or a base, or a deprotection reaction by a halogenated substance. In the case of using a base, washing with an acidic solution as described above allows conversion to sulfonic acid groups in the form of a free acid. Examples of the acid and base include hydrochloric acid, sulfuric acid, nitric acid, sodium hydroxide and potassium hydroxide. Examples of the halogenated substance to be used include lithium bromide, sodium iodide, tetramethylammonium chloride and tetrabutylammonium bromide, and are preferably lithium bromide and tetrabutylammonium bromide. The conversion rate to a sulfonic acid group can be determined by quantitatively determining the degree of the presence of characteristic peaks of a sulfonate ester or a sulfonamide in an infrared absorption spectrum or a nuclear magnetic resonance spectrum.

Typical examples of the polyarylene block copolymer according to the present invention, if shown using the block represented by the above formula (C-4) and having suitable ion-exchange groups, include following structures:

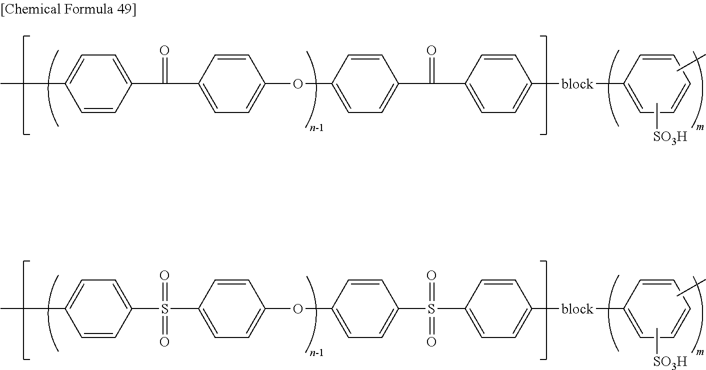

wherein n and m have the same meaning as described above.

Any of polyarylene block copolymers according to the present invention shown above can suitably be used as a member for a fuel cell. The polyarylene block copolymer according to the present invention is preferably used as a polymer electrolyte for electrochemical devices such as fuel cells.

The polymer electrolyte according to the present invention is usually used in a form of a membrane, and a method of conversion to a membrane is not especially limited, and for example, a method of producing a membrane from a solution state (solution cast method) is preferably used. Specifically, a membrane is produced by dissolving the polymer electrolyte according to the present invention in an appropriate solvent to prepare a solution, which is then cast on a support base material, and removing the solvent. Examples of such a support base material include glass plates, and plastic films such as polyethylene (PE), polypropylene (PP), polyethylene terephthalate (PET), polyethylenenaphthalate (PEN) and polyimide (PT). The solvent used in the membrane production is not especially limited as long as the solvent can sufficiently dissolve the polymer electrolyte according to the present invention, and can thereafter be removed, and suitably used are aprotic polar solvents such as DMF, DMAc, NMP and DMSO; chlorine-containing solvents such as dichloromethane, chloroform, 1,2-dichloroethane, chlorobenzene and dichlorobenzene; alcohols such as methanol, ethanol and propanol; and alkylene glycol monoalkyl ethers such as ethylene glycol monomethyl ether, ethylene glycol monoethyl ether, propylene glycol monomethyl ether and propylene glycol monoethyl ether. These may be used singly, but as required, as a mixture of two or more thereof. Above all, DMSO, DMF, DMAc, NMP and the like are preferable because these can provide a high solubility of the polymer.

The thickness of a membrane is not especially limited, but is preferably 10 to 300 μm. A membrane having a membrane thickness of 10 μm or more has a better practical strength, which is preferable; and a membrane of 300 μm or less is likely to have a low membrane resistance, which is preferable because characteristics of an electrochemical device is likely to be improved more. The membrane thickness can be controlled by the concentration of the solution and the application thickness on a support base material.

In order to improve various physical properties of a membrane, a plasticizer, a stabilizer, a release agent and the like which are used in common polymers may be added to the polyarylene block copolymer according to the present invention. Alternatively, another polymer can be composite alloyed with the polyarylene block copolymer according to the present invention by a method in which the polymers are mixed in the same solvent and concurrently cast. In the case where a polymer electrolyte is prepared by combining the polyarylene block copolymer according to the present invention with additives and/or another polymer, the types and the use amounts of the additives and/or the another polymer are determined such that desired characteristics can be obtained when the polymer electrolyte is applied to a member for a fuel cell.

Further in order to facilitate water control in fuel cell applications, also addition of inorganic or organic microparticles as a water retention agent is known. Any of these known methods can be used unless being contrary to the object of the present invention. In order to improve the mechanical strength or the like, a polymer electrolyte membrane thus obtained may be subjected to a treatment such as irradiation of an electron beam, radiation or the like.

In order to improve the strength, flexibility and durability of a polymer electrolyte membrane using the polymer electrolyte according to the present invention, a polymer electrolyte comprising the polyarylene block copolymer according to the present invention may be impregnated and composited in a porous base material to make a composite membrane. As the compositing method, known methods can be used.

The porous base material is not especially limited as long as it satisfies the above-mentioned use object, and examples thereof include porous membranes, woven fabrics, non-woven fabrics and fibrils, and a porous base material can be used not depending on the shapes and the materials. The material of the porous base material is, from the viewpoint of the heat resistance and in consideration of the reinforcement effect of physical strength, preferably an aliphatic, aromatic or fluorine-containing polymer.

In the case of using a polymer electrolyte composite membrane using the polyarylene block copolymer according to the present invention as a polymer electrolyte membrane of a polymer electrolyte fuel cell, the membrane thickness of a porous base material is preferably 1 to 100 μm, more preferably 3 to 30 μm, and especially preferably 5 to 20 μm. The pore diameter of the porous base material is preferably 0.01 to 100 μm, and more preferably 0.02 to 10 μm. The porosity of the porous base material is preferably 20 to 98%, and more preferably 40 to 95%.

If the membrane thickness of the porous base material is 1 μm or more, an effect on reinforcement of the strength after the compositing, and a reinforcing effect of imparting flexibility and durability are better, and gas leakage (cross leak) hardly occurs. If the membrane thickness is 100 μm or less, the electric resistance becomes lower to thereby make an obtained composite membrane a better one as a polymer electrolyte membrane for a polymer electrolyte fuel cell. If the pore diameter is 0.01 μm or more, filling of the polyarylene block copolymer according to the present invention becomes easier; and if the pore diameter is 100 μm or less, a reinforcing effect to the polyarylene block copolymer becomes larger. If the porosity is 20% or more, the resistance as a polymer electrolyte membrane becomes smaller; and if the porosity is 98% or less, the strength of a porous base material itself becomes larger to thereby more improve the reinforcing effect, which is preferable.

The polymer electrolyte composite membrane and the polymer electrolyte membrane described above are laminated, and the laminate may be used as a polymer electrolyte membrane for a fuel cell.

[Fuel Cell]

Next, the fuel cell according to the present invention will be described.

The membrane-electrode assembly according to the present invention (hereinafter, referred to as “MEA” in some cases) to become a basic unit of a fuel cell can be manufactured by using at least one of the polymer electrolyte membrane according to the present invention, the polymer electrolyte composite membrane according to the present invention, and a catalyst composition containing the polymer electrolyte according to the present invention and a catalyst component. MEA can be manufactured by using a polymer electrolyte membrane or a composite membrane using the polymer or the polyarylene block copolymer according to the present invention as a proton conductive membrane of the MEA, and joining a catalyst component and a conductive substance as a current collector on both surfaces of the proton conductive membrane.

Here, the catalyst component is not especially limited as long as it can activate the redox reaction between hydrogen and oxygen, and known ones can be used, but microparticles of platinum or a platinum alloy are preferably used as the catalyst component. The microparticles of platinum or a platinum alloy are supported for use on particulate or fibrous carbon such as activated carbon or graphite in many cases.

A catalyst layer is obtained by applying and drying a paste obtained by mixing platinum or a platinum alloy supported on carbon (carbon-supported catalyst) together with a solution of the polymer electrolyte according to the present invention and/or an alcohol solution of a perfluoroalkylsulfonic acid resin as a polymer electrolyte, on a gas diffusion layer and/or a polymer electrolyte membrane and/or a polymer electrolyte composite membrane. Specific methods usable are known methods such as a method described in J. Electrochem. Soc.: Electrochemical Science and Technology, 1988, 135(9), 2209. An MEA is obtained by forming catalyst layers on both surfaces of a polymer electrolyte membrane in such a way. In manufacture of the MEA, in the case where a catalyst layer is formed on a base material to become a gas diffusion layer, an obtained MEA is in a form of a membrane-electrode-gas diffusion layer assembly comprising both of gas diffusion layers and catalyst layers on both surfaces of the polymer electrolyte membrane. In the case where a catalyst composition paste is applied on a polymer electrolyte membrane to form a catalyst layer on the polymer electrolyte membrane, a membrane-electrode-gas diffusion layer assembly can be obtained by further forming a gas diffusion layer on the obtained catalyst layer.

Here, as a catalyst ink used in manufacture of a catalyst layer, the polymer according to the present invention may be used in place of the perfluoroalkylsulfonic acid resin. A known material can be used as a gas diffusion layer, but porous carbon fabric, carbon non-woven fabric or carbon paper is preferable in order to efficiently transport a raw material gas to a catalyst. A known material can be used as a gas diffusion layer, but porous carbon fabric, carbon non-woven fabric or carbon paper is preferable in order to efficiently transport a raw material gas to a catalyst.

Fuel cells having the MEA thus manufactured can be used of course in a type using hydrogen gas or a reformed hydrogen gas as a fuel, and in various types using methanol. The polymer electrolyte fuel cell according to the present invention can be provided as a fuel cell having an excellent power generation performance and a long service life.

Then, a fuel cell as a suitable embodiment will be described. This fuel cell comprises the polymer electrolyte membrane according to the embodiment described above. Such a fuel cell is sufficiently excellent in durability, and can operate over a long period.

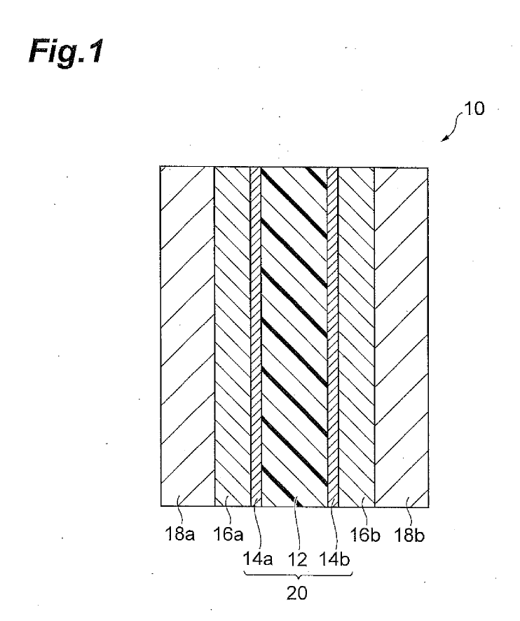

FIG. 1 is a diagram schematically illustrating a cross-sectional structure of the fuel cell according to the present embodiment. As shown in FIG. 1, in a fuel cell 10, catalyst layers 14a, 14b, gas diffusion layers 16a, 16b, and separators 18a, 18b are formed in order on both sides of a polymer electrolyte membrane 12 (proton conductive membrane) described above as a suitable embodiment so as to sandwich the polymer electrolyte membrane 12. The polymer electrolyte membrane 12 and the pair of catalyst layers 14a, 14b sandwiching the membrane constitute a membrane-electrode assembly (hereinafter, abbreviated to “MEA”) 20.

The catalyst layers 14a, 14b adjacent to the polymer electrolyte membrane 12 are layers to function as electrode layers in the fuel cell, and one thereof becomes an anode electrode layer and the other thereof becomes a cathode layer. Such catalyst layers 14a, 14b are constituted of a catalyst composition containing a catalyst, and more suitably comprise the above-mentioned polymer electrolyte.

The catalyst is not especially limited as long as it can activate the redox reaction between hydrogen and oxygen, and examples thereof include noble metals, noble metal alloys, metal complexes and sintered metal complexes prepared by sintering metal complexes. Above all, the catalyst is preferably platinum microparticles, and the catalyst layers 14a, 14b may be a material in which platinum microparticles are supported on particulate or fibrous carbon such as activated carbon or graphite.

The gas diffusion layers 16a, 16b are installed so as to sandwich both sides of the MEA 20, and promote the diffusion of raw material gases to the catalyst layers 14a, 14b. The gas diffusion layers 16a, 16b are preferably constituted of a porous material having electron conductivity. For example, porous carbon non-woven fabric and carbon paper are preferable because these can efficiently transport the raw material gases to the catalyst layers 14a, 14b.

A membrane-electrode-gas diffusion layer assembly (MEGA) is constituted of the polymer electrolyte membrane 12, the catalyst layers 14a, 14b, and the gas diffusion layers 16a, 16b. Such an MEGA can be manufactured, for example, by a method described hereinafter. That is, first, a solution containing a polymer electrolyte and a catalyst are mixed to form a slurry of a catalyst composition. The slurry is applied on a carbon non-woven fabric, a carbon paper or the like to form gas diffusion layers 16a, 16b on by a spray or screen printing method; and the solvent and the like are evaporated to obtain a pair of laminates each in which a catalyst layer is formed on a gas diffusion layer. The obtained pair of laminates are disposed so that respective catalyst layers face each other; a polymer electrolyte membrane 12 is disposed therebetween, and these are compression bonded. An MEGA having the structure described above is thus obtained. Formation of a catalyst layer on a gas diffusion layer may be carried out, for example, by applying and drying a catalyst composition on a predetermined base material (polyimide, polytetrafluoroethylene or the like) to form a catalyst layer, and thereafter transferring the catalyst layer to a gas diffusion layer by heat press.

The separators 18a, 18b are formed of a material having electron conductivity, and examples of such a material include carbon, resin-molded carbon, titanium and stainless steel. In such separators 18a, 18b, though not shown in the FIGURE, grooves to become flow paths for a fuel gas and the like are preferably formed on the catalyst layers 14a, 14b sides of the separators 18a, 18b.

A fuel cell 10 can be obtained by sandwiching the above-mentioned MEGA between the pair of separators 18a, 18b, and joining these.

The fuel cell according to the present invention is not necessarily limited to ones having the above-mentioned structure, and may have a structure suitably different without departing from the gist. For example, the fuel cell 10 may be one having the above-mentioned structure and sealed with a gas seal body or the like. Further, a plurality of the fuel cells 10 having the structure described above may be connected in series to form a fuel cell stack, which is put in practical use. The fuel cell having such a structure can operate as a solid polymer fuel cell in the case where a fuel is hydrogen, and as a direct methanol fuel cell in the case where a fuel is a methanol aqueous solution.

The present invention has been described in detail by way of the embodiments. However, the present invention is not limited to the embodiments described above. For the present invention, various modifications may be made without departing the gist.

### EXAMPLES

Hereinafter, the present invention will be described specifically by way of Examples, but the present invention is not limited thereto.

<Measurement of the Molecular Weight>

The number-average molecular weight (Mn) and the weight-average molecular weight (Mw) of a polymer electrolyte were measured by performing the measurement by gel permeation chromatography (GPC) under the conditions described below, and performing conversion in terms of polystyrene.

(GPC Conditions)

Measurement apparatus: Prominence GPC System, made by Shimadzu Corp.

Column: TSKgel GMH_{HR-M}, made by Tosoh Corp.

Column temperature: 40° C.

Mobile phase solvent: DMF (containing 10 mmol/dm³ of LiBr)

Solvent flow rate: 0.5 mL/min

### Fabrication of Polymer Electrolytes

### Synthesis Example 1

19.7 g (90.1 mmol) of anhydrous nickel bromide and 270 g of NMP were mixed in a flask under an argon atmosphere; and the flask inside temperature was raised to 70° C., and the mixture was stirred for 1 hour. The mixture was cooled to 60° C., and 15.5 g (99.1 mmol) of 2,2′-bipyridyl was added thereto; and the mixture was stirred at the same temperature for 30 min to prepare a nickel-containing solution.

Then, 18.0 g (60.6 mmol) of (2,2-dimethylpropyl) 2,5-dichlorobenzenesulfonate and 7.4 g (29.5 mmol) of 2,5-dichlorobenzophenone were added to a flask under an argon atmosphere, and dissolved in 200 g of NMP to obtain a solution; and 11.8 g (180.1 mmol) of a zinc powder was added to the solution regulated at 50° C., and the nickel-containing solution was poured thereto; the mixture was heated to 65° C. and subjected to a polymerization reaction for 5 hours to obtain a black polymerization solution.

The obtained polymerization solution was charged in 900 g of 8 N nitric acid aqueous solution at room temperature, and stirred for 30 min. A separated crude polymer was filtrated, and washed with water until the pH of the filtrate exceeded 4, and thereafter, further washed with a large amount of methanol to obtain 18.7 g of a polymer having sulfonic acid precursor groups ((2,2-dimethylpropyl) sulfonate groups).

18.0 g of the polymer having sulfonic acid precursor groups obtained as described above was placed in a flask; the flask inside atmosphere was fully replaced by argon; and 2.2 g of water, 10.5 g (121.1 mmol) of anhydrous lithium bromide and 340 g of NMP were added to the flask; and after the polymer having sulfonic acid precursor groups was dissolved sufficiently, the solution was heated to 120° C., and the conversion reaction to sulfonic acid groups was carried out at the same temperature for 12 hours to obtain a polymer solution.

The polymer solution was charged in 900 g of 6N hydrochloric acid, and stirred for 1 hour. A separated crude polymer was filtrated, and several times washed with a large amount of a methanol hydrochloride solution, and thereafter, washed with water until the pH of the filtrate exceeded 4, and dried to obtain 13.1 g of a polymer electrolyte A. The molecular weight of the obtained polymer electrolyte A was Mn=150000 and Mw=330000.

### Synthesis Example 2

### Synthesis of a Polymer Electrolyte B

A polymer electrolyte B was obtained with reference to the method described in Example 2 (paragraph 0058, paragraph 0059) of Japanese Patent Application Laid-Open Publication No. 2005-206807.

As a result of a high-resolution NMR analysis of the obtained polymer electrolyte B, the polymer electrolyte B was confirmed to have a structure represented by the following Chemical Formula (9) (the subscript numbers, 0.74 and 0.26, of each repeating unit of the block copolymer represent a molar composition ratio). The molecular weight of the polymer electrolyte B was Mn=220000 and Mw=510000.

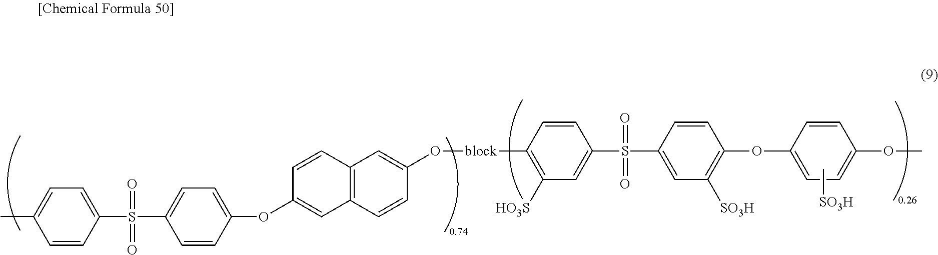

### Synthesis Example 3-1

### Synthesis of a Block Precursor DA Having No Ion-Exchange Group

50.00 g (174.1 mmol) of 4,4′-dichlorodiphenylsulfone, 41.45 g (165.6 mmol) of bis(4-hydroxyphenyl)sulfone, 24.04 g (173.9 mmol) of potassium carbonate, 207 mL of N-methylpyrrolidone (NMP), and 80 mL of toluene were added to a flask equipped with an azeotropic distillation apparatus under a nitrogen atmosphere. A bath was heated at 150° C. under reflux to azeotropically dehydrate moisture in the system, and water generated and toluene were distilled out; thereafter, the bath temperature was raised to 180° C., and the solution was kept at the temperature for 13 hours under stirring. After the reaction solution was allowed to cool, the reaction solution was poured into 37 wt % hydrochloric acid/methanol solution (a mixed solution of 1/1 in weight ratio); and a separated precipitate was collected by filtration, washed with ion-exchange water until the filtrate became neutral, then washed with methanol, and thereafter dried. 86.40 g of an obtained crude product was dissolved in NMP, and the solution was poured into 37 wt % hydrochloric acid/methanol solution (a mixed solution of 1/1 in weight ratio); and a separated precipitate was collected by filtration, washed with ion-exchange water until the filtrate became neutral, and dried. 74.25 g of a target substance was obtained. The molecular weight of the obtained block precursor DA having no ion-exchange group was Mn=18000 and Mw=32000, and the degree of polymerization n was 43.

### Synthesis Example 3-2

### Synthesis of a Polymer Electrolyte D

22.19 g (171.2 mmol) of anhydrous nickel chloride and 221 g of dimethylsulfoxide (DMSO) were added to a flask under an argon atmosphere, and heated to 70° C. to dissolve the mixture. The solution was cooled to 50° C.; and 29.42 g (188.4 mmol) of 2,2′-bipyridyl was added thereto, and the mixture was kept at the same temperature to prepare a nickel-containing solution.

Then, 11.92 g of the precursor DA obtained by Synthesis Example 3-1, and 300 g of DMSO were added to a flask under an argon atmosphere, and heated to 50° C. to dissolve the mixture. 0.039 g (0.40 mmol) of methanesulfonic acid and 16.79 g (256.8 mmol) of a zinc powder were added to the obtained solution, and kept at the temperature under stirring for 30 min. Then, 20.00 g (67.3 mmol) of (2,2-dimethylpropyl) 2,5-dichlorobenzenesulfonate was added thereto and dissolved. The nickel-containing solution described above was poured thereinto, heated to 70° C., and kept at the temperature for 2 hours under stirring to obtain a black polymerization solution.

The obtained polymerization solution was poured into 1,200 g of hot water at 70° C.; and a generated precipitate was collected by filtration. Water was added to the precipitate so that the total of the precipitate and water was 696 g, and 9.2 g of 35 wt % sodium nitrite aqueous solution was further added thereto. To this slurry solution, 172 g of 65 wt % nitric acid was dropped over 30 min, and after the dropping, the slurry solution was stirred at room temperature for 1 hour. The slurry solution was filtrated, and a collected crude polymer was washed with water until the pH of the filtrate exceeded 1. Next, the crude polymer was added to a flask equipped with a cooling device, and water was added thereto so that the total weight of the crude polymer and water reached 698 g; and 5 wt % lithium hydroxide aqueous solution was further added thereto until the pH of the slurry solution of the crude polymer and water reached 7.8; and 666 g of methanol was further added, and the solution was refluxed for 1 hour. The crude polymer was collected by filtration, immersed in and washed with 200 g of water, and then 280 g of methanol, and dried in a drier at 80° C. to obtain 25.23 g of a polymer having sulfonic acid precursor groups ((2,2-dimethylpropyl) sulfonate groups).

Then, the sulfonic acid precursor groups were converted into sulfonic acid groups as follows.

25.15 g of the polymer having sulfonic acid precursor groups obtained as described above was placed in a flask; under an argon atmosphere, 630 g of NMP was added thereto, and the mixture was heated and stirred at 80° C. and dissolved. 33 g of an activated alumina was added thereto, and stirred for 1 hour and 30 min at the temperature. Thereafter, 630 g of NMP was added thereto, and the activated alumina was removed by filtration. NMP was distilled out from the obtained solution under reduced pressure to concentrate the solution to make 305 g of NMP solution. 2.2 g of water and 10.82 g (124.6 mmol) of anhydrous lithium bromide were added to the solution, heated to 120° C., and stirred for 12 hours at the temperature. An obtained reaction solution was charged in 1260 g of 6N hydrochloric acid, and stirred for 1 hour. A separated crude polymer was collected by filtration, and three times immersed in and washed with 1260 g of 35 wt % hydrochloric acid/methanol solution (a mixed solution of 1/1 in weight ratio), and thereafter washed with water until the pH of the filtrate exceeded 4. Then, the crude polymer was four times immersed in and washed with 1640 g of hot water (95° C.), and dried to obtain 17.71 g of a polymer electrolyte D as a target substance. The molecular weight of the obtained polymer electrolyte D was Mn=139000 and Mw=314000.

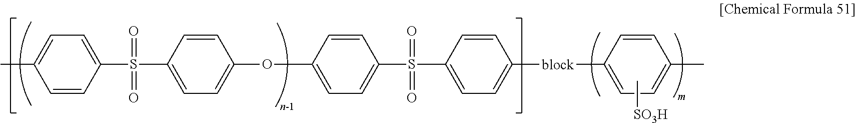

### Synthesis Example 4-1

### Synthesis of a Block Precursor EA Having No Ion-Exchange Group

50.00 g (174.1 mmol) of 4,4′-dichlorodiphenylsulfone, 39.43 g (157.5 mmol) of bis(4-hydroxyphenyl)sulfone, 22.86 g (165.4 mmol) of potassium carbonate, 203 mL of N-methylpyrrolidone (NMP), and 80 mL of toluene were added to a flask equipped with an azeotropic distillation apparatus under a nitrogen atmosphere. A bath was heated at 150° C. under reflux to azeotropically dehydrate moisture in the system, and water generated and toluene were distilled out; thereafter, the bath temperature was raised to 180° C., and the solution was kept at the temperature for 21 hours under stirring. After the reaction solution was allowed to cool, the reaction solution was poured into 37 wt % hydrochloric acid/methanol solution (a mixed solution of 1/1 in weight ratio); and a separated precipitate was collected by filtration, washed with ion-exchange water until the filtrate became neutral, then washed with methanol, and thereafter dried. 77.31 g of an obtained crude product was dissolved in NMP, and the solution was poured into 37 wt % hydrochloric acid/methanol solution (a mixed solution of 1/1 in weight ratio); and a separated precipitate was collected by filtration, washed with ion-exchange water until the filtrate became neutral, and dried. 73.34 g of a target substance was obtained. The molecular weight of the obtained block precursor EA having no ion-exchange group was Mn=9700 and Mw=16000, and the degree of polymerization n was 22.

### Synthesis Example 4-2

### Synthesis of a Polymer Electrolyte E

22.64 g (174.7 mmol) of anhydrous nickel chloride and 221 g of dimethylsulfoxide (DMSO) were added to a flask under an argon atmosphere, and heated to 70° C. to dissolve the mixture. The solution was cooled to 50° C.; and 30.01 g (192.1 mmol) of 2,2′-bipyridyl was added thereto, and the mixture was kept at the same temperature to prepare a nickel-containing solution.

Then, 11.92 g of the precursor EA obtained by Synthesis Example 4-1, and 300 g of DMSO were added to a flask under an argon atmosphere, and heated to 50° C. to dissolve the mixture. 0.039 g (0.40 mmol) of methanesulfonic acid and 17.13 g (262.0 mmol) of a zinc powder were added to the obtained solution, and kept at the temperature for 30 min under stirring. Then, 20.00 g (67.3 mmol) of (2,2-dimethylpropyl) 2,5-dichlorobenzenesulfonate was added thereto and dissolved. The nickel-containing solution described above was poured thereinto, then heated to 70° C., and kept at the temperature for 2 hours under stirring to obtain a black polymerization solution.

The obtained polymerization solution was poured into 1200 g of hot water at 70° C.; and a generated precipitate was collected by filtration. Water was added to the precipitate so that the total of the precipitate and water was 696 g, and 9.2 g of 35 wt % sodium nitrite aqueous solution was further added thereto. To this slurry solution, 172 g of 65 wt % nitric acid was dropped over 30 min, and after the dropping, the slurry solution was stirred at room temperature for 1 hour. The slurry solution was filtrated, and a collected crude polymer was washed with water until the pH of the filtrate exceeded 1. Next, the crude polymer was added to a flask equipped with a cooling device, and water was added thereto so that the total weight of the crude polymer and water reached 698 g; and 5 wt % lithium hydroxide aqueous solution was further added thereto until the pH of the slurry solution of the crude polymer and water reached 8.2; and 666 g of methanol was further added, and the solution was refluxed for 1 hour. The crude polymer was collected by filtration, immersed in and washed with 200 g of water, and then 280 g of methanol, and dried in a drier at 80° C. to obtain 25.37 g of a polymer having sulfonic acid precursor groups ((2,2-dimethylpropyl) sulfonate groups).

Then, the sulfonic acid precursor groups were converted into sulfonic acid groups as follows.

25.31 g of the polymer having sulfonic acid precursor groups obtained as described above was placed in a flask; under an argon atmosphere, 630 g of NMP was added thereto, and the mixture was heated and stirred at 80° C. and dissolved. 33 g of an activated alumina was added thereto, and stirred for 1 hour and 30 min at the temperature. Thereafter, 630 g of NMP was added thereto, and the activated alumina was removed by filtration. NMP was distilled out from the obtained solution under reduced pressure to concentrate the solution to make 302 g of an NMP solution. 2.3 g of water and 10.89 g (125.4 mmol) of anhydrous lithium bromide were added to the solution, heated to 120° C., and stirred for 12 hours at the same temperature. An obtained reaction solution was charged in 1270 g of 6N hydrochloric acid, and stirred for 1 hour. A separated crude polymer was collected by filtration, and three times immersed in and washed with 1270 g of 35 wt % hydrochloric acid/methanol solution (a mixed solution of 1/1 in weight ratio), and thereafter washed with water until the pH of the filtrate exceeded 4. Then, the crude polymer was four times immersed in and washed with 1,650 g of hot water (95° C.), and dried to obtain 18.50 g of a polymer electrolyte E. The molecular weight of the obtained polymer electrolyte E was Mn=137000 and Mw=368000.

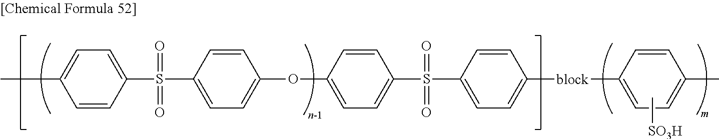

### Fabrication of Polymer Electrolyte Membranes

### Example 1

### Fabrication of a Polymer Electrolyte Membrane AM

The obtained polymer electrolyte A was dissolved in a concentration of 5% by weight in DMSO to prepare a polymer electrolyte solution. Thereafter, the obtained polymer electrolyte solution was continuously cast and applied on a polyethylene terephthalate (PET) film (E5000 grade, made by Toyobo Co., Ltd.) of 300 mm wide and 500 m long as a support base material by using a slot die, and dried under ordinary pressure at 70° C. for 1 hour to remove the solvent, and is thereafter treated with hydrochloric acid and washed with ion-exchange water to fabricate a polymer electrolyte membrane AM having a membrane thickness of about 15 μm.

### Example 2

### Fabrication of a Polymer Electrolyte Membrane DM

The obtained polymer electrolyte D was dissolved in a concentration of 9% by weight in DMSO to prepare a polymer electrolyte solution. Thereafter, the obtained polymer electrolyte solution was continuously cast and applied on a polyethylene terephthalate (PET) film (E5000 grade, made by Toyobo Co., Ltd.) of 300 mm wide and 500 m long as a support base material by using a slot die, and dried under ordinary pressure at 70° C. for 1 hour to remove the solvent, and is thereafter treated with hydrochloric acid and washed with ion-exchange water to fabricate a polymer electrolyte membrane DM having a membrane thickness of about 20 μm.

### Example 3

### Fabrication of a Polymer Electrolyte Membrane EM

The obtained polymer electrolyte E was dissolved in a concentration of 8% by weight in DMSO to prepare a polymer electrolyte solution. Thereafter, the obtained polymer electrolyte solution was continuously cast and applied on a polyethylene terephthalate (PET) film (E5000 grade, made by Toyobo Co., Ltd.) of 300 mm wide and 500 m long as a support base material by using a slot die, and dried under ordinary pressure at 70° C. for 1 hour to remove the solvent, and is thereafter treated with hydrochloric acid and washed with ion-exchange water to fabricate a polymer electrolyte membrane EM having a membrane thickness of about 20 μm.

### Comparative Example 1

### Fabrication of a Polymer Electrolyte Membrane BM

A polymer electrolyte membrane BM having a membrane thickness of about 30 μm was obtained by the same operation as in Example 1, except for preparing a polymer electrolyte solution by dissolving the obtained polymer electrolyte B obtained by synthesis Example 2 in a concentration of 10% by weight in DMSO.

[Evaluations of the Polymer Electrolyte Membranes]

Evaluations of the polymer electrolyte membranes fabricated in Examples and Comparative Example were performed under the conditions described below. The results are shown in Table 1.

<Measurement of the Ion-Exchange Capacity (IEC)>

A polymer electrolyte membrane was cut in a suitable weight, and the dry weight thereof was determined by using a halogen moisture percentage tester (halogen moisture tester HR73, made by Metier Toledo International Inc.) set at a heating temperature of 105° C. Then, the polymer electrolyte membrane was immersed in 5 mL of 0.1 mold, sodium hydroxide aqueous solution; and thereafter, 50 mL of ion-exchange water was further added thereto, and the mixture was allowed to be left for 2 hours. Thereafter, 0.1 mol/L hydrochloric acid aqueous solution was gradually added to the solution in which the polymer electrolyte membrane was immersed to titrate the solution to determine a point of neutralization. The ion-exchange capacity (unit: meq/g) of the polymer electrolyte membrane was calculated from the dry weight of the polymer electrolyte membrane and the amount of hydrochloric acid used for the neutralization.

<Measurement of the Water Absorption Rate>

The weight of a polymer electrolyte membrane after immersed in ion-exchange water at 80° C. for 2 hours was denoted as Wwet, and the weight thereof in the dry state was denoted as Wdry; then, ω represented by the expression (II) shown below was defined as the water absorption rate.

ω(%)=(Wwet−Wdry)/Wdry×100 (II)

The membrane weight in the dry state was determined by cutting a polymer electrolyte membrane in a suitable weight, and using a halogen moisture percentage tester (halogen moisture tester HR73, made by Metier Toledo International Inc.) set at a heating temperature of 105° C.

TABLE 1

| | Polymer | | Membrane | Water |
|---|---|---|---|---|
| | electrolyte | IEC | Thickness | Absorption |
| | Membrane | (meq/g) | (μm) | Rate (%) |
| Example 1 | AM | 3.9 | 15 | 94 |
| Example 2 | DM | 2.5 | 20 | 99 |
| Example 3 | EM | 2.5 | 20 | 92 |
| Comparative | BM | 1.8 | 30 | 120 |
| Example 1 | | | | |

Then, the polymer electrolyte membranes fabricated in Examples and Comparative Example were evaluated for the water-uniformity evaluation, the radical resistance evaluation and the long-term stability evaluation under the conditions described below. The results are shown in Table 2.

<Evaluation of the Water-Uniformity>

### (Fabrication of Immersed Membranes)

For a polymer electrolyte membrane, immersed membranes subjected to the following separate two treatments were fabricated.

### (First Immersion Treatment)

A polymer electrolyte membrane cut out into 3×5 cm was immersed in 5 mL of a 5 mmol/L iron (II) chloride tetrahydrate aqueous solution at 25° C. for 1 hour, thereafter taken out, and dried at 25° C. at a degree of reduced pressure of 10 hPa or lower for 12 hours. The dried polymer electrolyte membrane was cut out into 1 mm square to make a measurement specimen for ¹³C-solid state NMR.

### (Second Immersion Treatment)

A polymer electrolyte membrane cut out into 3×5 cm was immersed in 5 mL ion-exchange water at 25° for 1 hour, thereafter taken out, and dried at 25° C. at a degree of reduced pressure of 10 hPa or lower for 12 hours. The dried polymer electrolyte membrane was cut out into 1 mm square to make a measurement specimen for ¹³C-solid state NMR.

(Solid NMR Measurement)

The measurement of ¹³C-solid state NMR spectra was performed at room temperature by using an “Avance300” by trade name, made by Bruker Biospin GmbH. A specimen was put in a measuring specimen tube of 4 mm in outer diameter; the tube was inserted in the apparatus; and the measurement was performed with a spinning frequency of 10 kHz by the ¹H—¹³C cross polarization magic angle spinning method (hereinafter, referred to as CPMAS method in some cases). Adamantane was used as the standard for the chemical shifts, and the correction was made by setting the signal of CH of adamantane at 29.5 ppm. Here, the delay time for accumulation was 4 sec; and the excitation pulse length of 1H nuclear was 4.8 microseconds, corresponding to 90° pulses. The signal fetch was made such that 1,360 points were recorded at intervals of 22 microseconds. The range of spectrum was set at ±150 ppm centered on 100 ppm by using the corrected chemical shifts.

<Calculation of the Nonuniformity Factor H>

The polymer electrolyte membrane subjected to the first immersion treatment and the polymer electrolyte membrane subjected to the second immersion treatment as described above were each measured for a ¹³C-solid state NMR spectrum to obtain the spectrum, of which the total of peak areas was determined. Then, the nonuniformity factor H (Sp/Snp) was calculated where the total of the peaks of the polymer electrolyte membrane subjected to the first immersion treatment was denoted as Sp, and that of the polymer electrolyte membrane subjected to the second immersion treatment was denoted as Snp. Here, the case where the peaks substantially vanish and H approaches 0 more and more after the second immersion treatment means the superiority in moisture distribution uniformity.

<Evaluation of the Radical Resistance (Fenton Test)>

A polymer electrolyte membrane cut out into 5×5 cm was immersed in 400 mL of an aqueous solution containing 3% hydrogen peroxide and ferrous chloride of 16 ppm in terms of the concentration of iron ions, at 60° C. for 2 hours. The membrane weight was measured by the following method. The measurement used a halogen moisture tester HR73, made by Metler Toledo International Inc., and the membrane was held until there was observed no change in the measurement value for 50 sec in the state of 110° C., and the measurement value was defined as the dry weight. The weight maintenance rate (%) was defined as a value (%) 100 times the dry weight of the membrane after Fenton test divided by the dry weight of the membrane before Fenton test.

<Evaluation of the Long-Term Stability (Load Variation Test)>

### (Production of a Catalyst Ink)

1.00 g of a platinum-supported carbon (SA50BK, made by N.E. Chemcat Corp., platinum content: 50% by weight), which supported platinum, was charged in 11.4 mL of a commercially available 5 wt % Nafion solution (solvent: a mixture of water and lower alcohols); and 50.20 g of ethanol and 7.04 g of water were further added thereto. The obtained mixture was subjected to an ultrasonic treatment for 1 hour, and thereafter stirred for 5 hours by a stirrer to obtain a catalyst ink.

(Manufacture of Membrane-Electrode Assemblies)

Then, the catalyst ink described above was applied on a 5.2 cm square of the central part of one surface of the obtained polymer electrolyte membrane by a spray method. At this time, the distance from a discharge port to the membrane was set at 6 cm; and the stage temperature was set at 75° C. After 8-times overspray was carried out by the similar method, an applied object was allowed to be left on the stage for 15 min to thereby remove the solvent, thus forming an anode catalyst layer. The obtained anode catalyst layer contained 0.6 mg/cm² of platinum as calculated from the composition and the applied weight. Then, the catalyst ink was applied similarly on the surface on the opposite side to the anode catalyst layer of the polymer electrolyte membrane to form a cathode catalyst layer containing 0.6 mg/cm² of platinum. Thereby, a membrane-electrode assembly was obtained.

(Manufacture of a Cell as a Fuel Cell)

A cell as a fuel cell was manufactured by using a commercially available JAM standard cell. That is, a carbon cloth as a gas diffusion layer and a carbon-made separator on which a groove for a gas channel was cutting worked were arranged in this order on each outer side of the above-mentioned membrane-electrode assembly, and a current collector and an end plate were arranged on the further outer side, and these were compressed with bolts, thus assembling a cell as a fuel bell having an effective electrode area of 25 cm².

(Carrying Out of the Load Variation Test)

While the obtained cell as a fuel cell was held at 80° C., hydrogen in a low-moisture state (70 mL/min, back pressure: 0.1 MPaG) and air in a low-moisture state (174 mL/min, back pressure: 0.05 MPaG) were introduced to the cell, and a load variation test in the open circuit and at a constant current was performed.

(Evaluation of the Long-Term Stability)

After the load variation test, the membrane-electrode assembly was taken out, charged in a mixed solution of ethanol/water, and subjected to an ultrasonic treatment to remove the catalyst layers. The molecular weights of the remaining polymer electrolyte membrane and the polymer electrolyte membrane not subjected to the load variation test were measured by the method for measuring molecular weight described above. As an index of the long-term stability evaluation, the maintenance rate of the weight-average molecular weight, that is, a number obtained by dividing the weight-average molecular weight of the polymer electrolyte membrane subjected to the load variation test by the weight-average molecular weight of the polymer electrolyte membrane not subjected to the load variation test, and multiplying the quotient by 100, was used. A higher maintenance rate of the weight-average molecular weight can be judged to exhibit a higher long-term stability of the polymer electrolyte membrane.

TABLE 2

| | Integra- | Magneti- | | Nonuni- | Weight |
|---|---|---|---|---|---|
| | tion | zation | Number of | formity | Main- |
| | Range | Transfer Time | Times of | Factor | tenance |
| | (ppm) | (msec) | Integration | H | Rate (%) |
| Example 1 | 150-115 | 5 | 4096 | 0.01 | 104 |
| Example 2 | 170-100 | 5 | 4096 | 0.39 | 100 |
| Example 3 | 170-100 | 5 | 4096 | 0.25 | 94 |
| Comparative | 170-100 | 3 | 2048 | 0.43 | 23 |
| Example 1 | | | | | |

The polymer electrolyte membranes of Examples 1 to 3 were confirmed to have an excellent radical resistance. By contrast, the polymer electrolyte membrane of Comparative Example 1 had a low radical resistance, and as a result of the evaluation of the long-term stability, it exhibited a maintenance rate of the weight-average molecular weight of 40%, which was inferior in the long-term stability (here, in the measurement of the molecular weight, the mobile phase was altered to dimethylacetamide from the molecular weight measurement method described above).

<Measurement A of the Water Absorption Rate>

As an index indicating the water resistance, the water absorption rate of a polymer electrolyte membrane was measured. A lower water absorption rate indicates a better water resistance. A dried membrane was weighed, and the water absorption rate was calculated from an increasing amount of the weight of the membrane after the membrane was immersed in deionized water at 80° C. for 2 hours, and a ratio of the increasing amount to the dried membrane weight was determined.

<Measurement A of the Ion-Exchange Capacity (IEC)>

A polymer to be used for the measurement was formed as a membrane by the solution cast method to obtain a polymer membrane, and the obtained polymer membrane was cut in a suitable weight. The dry weight of the cut polymer membrane was measured by using a halogen moisture percentage tester set at a heating temperature of 105° C. Then, the polymer membrane thus dried was immersed in 5 mL of 0.1 mol/L sodium hydroxide aqueous solution, and thereafter, 50 mL of ion-exchange water was further added thereto, and the system was allowed to be left for 2 hours. Thereafter, 0.1 mol/L hydrochloric acid was gradually added to the solution in which the polymer membrane was immersed to titrate the solution to determine a point of neutralization. Then, the ion-exchange capacity (unit: meq/g) of the polymer was calculated from the dry weight of the cut polymer membrane and the amount of hydrochloric acid used for the neutralization.

<Measurement A of the Proton Conductivity>

A polymer electrolyte membrane was cut into a membrane strip specimen of 1.0 cm wide, and platinum plates (width: 5.0 mm) were pressed on the surface of the membrane strip specimen with an interval of 1.0 cm. The membrane strip specimen on which the platinum plates were thus pressed was held in a thermohygrostat of 80° C. and a relative humidity of 90%, and the alternating-current impedance at 10⁶ to 10⁻¹ Hz between the platinum plates was measured. The proton conductivity (σ) (S/cm) of the polymer electrolyte membrane was calculated by substituting an obtained value from the measurement in the following expression:

σ(S/cm)=1/(R×d)

wherein in the Cole-Cole plot, a real component of a complex impedance when an imaginary component of the complex impedance was 0 was denoted as R (Ω); and d represented a membrane thickness (cm) of a membrane strip specimen.

### Example A1

120 mL of DMSO, 60 mL of toluene, 5.0 g (14.4 mmol) of sodium 2,5-dichlorobenzenesulfonate, 3.6 g (20.0 mmol) of 2,5-dichlorobenzophenone, and 13.4 g (86.0 mmol) of 2,2′-bipyridyl were added to a flask equipped with an azeotropic distillation apparatus under an argon atmosphere. Thereafter, a bath was heated to 150° C. to heat and distill out toluene to azeotropically dehydrate moisture in the system, which was then cooled to 65° C. Then, 23.7 g (86.0 mmol) of bis(1,5-cyclooctadiene)nickel(0) was added thereto, and stirred at 70° C. for 3 hours. After the reaction solution was allowed to cool, the reaction solution was poured into a large amount of 6 mol/L hydrochloric acid to separate a crude polymer, which was thereafter filtrated. Thereafter, the crude polymer was several times subjected to washing with 6 mol/L hydrochloric acid and filtration, and then washed with water until the pH of the filtrate exceeded 4; and an obtained polymer was dried. The polymer thus obtained was denoted as Polymer A. The yield of Polymer A was 5.3 g. Mn, Mw and IEC of Polymer A were as follows.

| | |
|---|---|
| Mn = | 8.9 × 10⁴ |
| Mw = | 2.1 × 10⁵ |
| IEC | 3.2 meq/g |

Polymer A obtained was dissolved in 10 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 40 μm.

The water absorption rate and the proton conductivity of the obtained polymer electrolyte membrane were as follows.

| | |
|---|---|
| The water absorption rate | 70% |
| The proton conductivity | 1.4 × 10⁻¹ S/cm (at 80° C. and |
| | a relative humidity of 90%) |

### Example A2

20.1 g (92.0 mmol) of anhydrous nickel bromide and 220 g of NMP were mixed in a flask under an argon atmosphere, and the flask inside temperature was raised to 70° C., and the solution was stirred for 1 hour. The solution was cooled to 60° C., and 15.8 g (101.2 mmol) of 2,2′-bipyridyl was added thereto, and stirred at the same temperature for 30 min to prepare a nickel-containing solution.

20.0 g (67.3 mmol) of (2,2-dimethylpropyl) 2,5-dichlorobenzenesulfonate and 6.2 g (24.7 mmol) of 2,5-dichlorobenzophenone were added to a flask under an argon atmosphere, and dissolved in 150 g of NMP, and the temperature was regulated at 50° C. 12.0 g (183.9 mmol) of a zinc powder was added to the obtained solution; and the nickel-containing solution described above was poured thereinto, and heated to 65° C. to carry out the polymerization reaction for 5 hours to obtain a black polymerization solution.

The obtained polymerization solution was charged in 900 g of 8 N nitric acid aqueous solution at room temperature, and stirred for 30 min. A separated crude polymer was filtrated, washed with water until the pH of the filtrate exceeded 4, and thereafter further washed with a large amount of methanol to obtain 19.1 g of a polymer having sulfonic acid precursor groups ((2,2-dimethylpropyl) sulfonate groups).

Then, sulfonic acid precursor groups were converted into sulfonic acid groups as follows.

18.5 g of the polymer having sulfonic acid precursor groups obtained as described above was placed in a flask; the flask inside atmosphere was fully replaced by argon; and 2.4 g of water, 11.7 g (134.7 mmol) of anhydrous lithium bromide and 350 g of NMP were added thereto, and after the polymer having sulfonic acid precursor groups was sufficiently dissolved, the system was heated to 120° C., and the conversion reaction to the sulfonic acid group was carried out at the same temperature for 12 hours to obtain a polymer solution.

The polymer solution was charged in 900 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried. A polymer thus obtained was denoted as Polymer B. The yield of Polymer B was 13.0 g. Mn, Mw and IEC of Polymer B were as follows.

| | |
|---|---|
| Mn = | 1.6 × 10⁵ |
| Mw = | 4.0 × 10⁵ |
| IEC | 4.2 meq/g |

Polymer B obtained was dissolved in 6 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 15 μm.

The water absorption rate and the proton conductivity of the obtained polymer electrolyte membrane were as follows.

| | |
|---|---|
| The water absorption rate | 100% |
| The proton conductivity | 4.6 × 10⁻¹ S/cm (at 80° C. and |
| | a relative humidity of 90%) |

### Example A3

14.6 g (66.7 mmol) of anhydrous nickel bromide and 180 g of NMP were mixed in a flask under an argon atmosphere, and the flask inside temperature was raised to 70° C., and the solution was stirred for 1 hour. The solution was cooled to 60° C., and 11.5 g (73.5 mmol) of 2,2′-bipyridyl was added thereto, and cooled to 40° C. under stirring to prepare a nickel-containing solution.

20.0 g (38.2 mmol) of di(2,2-dimethylpropyl) 4,4′-dichlorobiphenyl-2,2′-disulfonate and 7.2 g (28.7 mmol) of 2,5-dichlorobenzophenone were added to a flask under an argon atmosphere, and dissolved in 380 g of NMP, and the temperature was regulated at 50° C. 8.7 g (133.7 mmol) of a zinc powder was added to the obtained solution, which was then cooled to 40° C. under stirring. The nickel-containing solution described above was poured thereinto, and the polymerization reaction was carried out at 40° C. as it stood for 5 hours to obtain a black polymerization solution.

The obtained polymerization solution was charged in 2000 g of 6N hydrochloric acid aqueous solution at room temperature, and stirred for 30 min. A separated crude polymer was filtrated, washed with water until the pH of the filtrate exceeded 4, and thereafter further washed with a large amount of methanol to obtain 22.5 g of a polymer having sulfonic acid precursor groups ((2,2-dimethylpropyl) sulfonate groups).

Then, sulfonic acid precursor groups were converted into sulfonic acid groups as follows.

21.0 g of the polymer having sulfonic acid precursor groups obtained as described above was placed in a flask; the flask inside atmosphere was fully replaced by argon; and 54.6 g of water, 13.3 g (134.7 mmol) of anhydrous lithium bromide and 500 g of NMP were added thereto, and after the polymer having sulfonic acid precursor groups was sufficiently dissolved, the system was heated to 120° C., and the conversion reaction to the sulfonic acid group was carried out at the same temperature for 12 hours to obtain a polymer solution.

The polymer solution was charged in 2,100 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried. A polymer thus obtained was denoted as Polymer C. The yield of Polymer C was 16.3 g. Mn, Mw and IEC of Polymer C were as follows.

| | |
|---|---|
| Mn = | 3.2 × 10⁵ |
| Mw = | 7.7 × 10⁵ |
| IEC | 4.3 meq/g |

Polymer C obtained was dissolved in 4 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 15 μm.

The water absorption rate and the proton conductivity of the obtained polymer electrolyte membrane were as follows.

| | |
|---|---|
| The water absorption rate | 110% |
| The proton conductivity | 3.8 × 10⁻¹ S/cm (at 80° C. and |
| | a relative humidity of 90%) |

Polymer C obtained was dissolved in 4 wt % concentration in NMP to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 10 μm.

The water absorption rate and the proton conductivity of the obtained polymer electrolyte membrane were as follows.

| | |
|---|---|
| The water absorption rate | 90% |
| The proton conductivity | 3.9 × 10⁻¹ S/cm (at 80° C. and |
| | a relative humidity of 90%) |

### Example A4

12.5 g (57.2 mmol) of anhydrous nickel bromide and 150 g of NMP were mixed in a flask under an argon atmosphere, and the flask inside temperature was raised to 70° C., and the solution was stirred for 1 hour. The solution was cooled to 60° C., and 9.8 g (62.9 mmol) of 2,2′-bipyridyl was added thereto, and cooled to 50° C. under stirring to prepare a nickel-containing solution.

10.0 g (19.1 mmol) of di(2,2-dimethylpropyl) 4,4′-dichlorobiphenyl-2,2′-disulfonate and 6.3 g (38.1 mmol) of 1,4-dichloro-2-fluorobenzene were added to a flask under an argon atmosphere, and dissolved in 320 g of NMP, and the temperature was regulated at 50° C. 7.5 g (114.4 mmol) of a zinc powder was added to the obtained solution; and the nickel-containing solution described above was poured thereinto, and the temperature was raised to 65° C., and the polymerization reaction was carried out at the temperature for 3 hours to obtain a black polymerization solution.

A polymer having sulfonic acid precursor groups was obtained by the similar operation as in Example A3 from the obtained polymerization solution, and then, sulfonic acid precursor groups were converted into sulfonic acid groups by the similar operation as in Example A3 to obtain Polymer D. Mn, Mw and IEC of Polymer D were as follows.

| | |
|---|---|
| Mn = | 3.4 × 10⁵ |
| Mw = | 7.8 × 10⁵ |
| IEC | 3.9 meq/g |

Polymer D obtained was dissolved in 4 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 15 μm.

The water absorption rate and the proton conductivity of the obtained polymer electrolyte membrane were as follows.

| | |
|---|---|
| The water absorption rate | 280% |
| The proton conductivity | 3.5 × 10⁻¹ S/cm (at 80° C. and |
| | a relative humidity of 90%) |

Polymer D obtained was dissolved in 3 wt % concentration in DMSO to prepare a polymer electrolyte solution. Then, the obtained polymer electrolyte solution was continuously cast and applied on a polyethylene terephthalate (PET) film (E5000 grade, made by Toyobo Co., Ltd.) of 300 mm wide and 500 m long as a support base material by using an applicator, and dried under ordinary pressure at 70° C. for 1 hour to remove the solvent, and then subjected to hydrochloric acid treatment and washing with ion-exchange water to fabricate a polymer electrolyte membrane A4 having a membrane thickness of about 20 μm.

The proton conductivity of the obtained polymer electrolyte membrane was as follows.

| | |
|---|---|
| The proton conductivity | 3.6 × 10⁻¹ S/cm (at 80° C. and |
| | a relative humidity of 90%) |

The obtained polymer electrolyte membrane A4 was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation set at 2048. The obtained nonuniformity factor H was 0.13.

### Example A5

10.4 g (47.8 mmol) of anhydrous nickel bromide and 130 g of NMP were mixed in a flask under an argon atmosphere, and the flask inside temperature was raised to 70° C., and the solution was stirred for 1 hour. The solution was cooled to 60° C., and 7.8 g (50.1 mmol) of 2,2′-bipyridyl was added thereto, and cooled to 30° C. under stirring to prepare a nickel-containing solution.

20.0 g (38.2 mmol) of di(2,2-dimethylpropyl) 4,4′-dichlorobiphenyl-2,2′-disulfonate and 4.2 g (9.6 mmol) of 2,5-dichloro-4′-[(4-phenoxy)phenoxy]benzophenone were added to a flask under an argon atmosphere, and dissolved in 270 g of NMP, and the temperature was regulated at 50° C. 6.3 g (95.5 mmol) of a zinc powder was added to the obtained solution, which was then cooled to 30° C. under stirring. The nickel-containing solution described above was poured thereinto, and the polymerization reaction was carried out at 30° C. as it stood for 5 hours to obtain a black polymerization solution.

A polymer having sulfonic acid precursor groups was obtained by the similar operation as in Example A3 from the obtained polymerization solution, and then, sulfonic acid precursor groups were converted into sulfonic acid groups by the similar operation as in Example A3 to obtain Polymer E. The yield of Polymer E was 14.6 g. Mn, Mw and IEC of Polymer E were as follows.

| | |
|---|---|
| Mn = | 3.9 × 10⁵ |
| Mw = | 9.2 × 10⁵ |
| IEC | 4.6 meq/g |

Polymer E obtained was dissolved in 4 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane A5 having a membrane thickness of about 15 μm.

The water absorption rate and the proton conductivity of the obtained polymer electrolyte membrane were as follows.

| | |
|---|---|
| The water absorption rate | 150% |
| The proton conductivity | 4.3 × 10⁻¹ S/cm (at 80° C. and |
| | a relative humidity of 90%) |

The obtained polymer electrolyte membrane A5 was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2048. The obtained nonuniformity factor H was 0.04.

Polymer E obtained was dissolved in 4 wt % concentration in NMP to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 10 μm.

The water absorption rate and the proton conductivity of the obtained polymer electrolyte membrane were as follows.

| | |
|---|---|
| The water absorption rate | 90% |
| The proton conductivity | 4.6 × 10⁻¹ S/cm (at 80° C. and |
| | a relative humidity of 90%) |

### Example A6

13.5 g (61.6 mmol) of anhydrous nickel bromide and 160 g of NMP were mixed in a flask under an argon atmosphere, and the flask inside temperature was raised to 70° C., and the solution was stirred for 1 hour. The solution was cooled to 60° C., and 10.6 g (67.8 mmol) of 2,2′-bipyridyl was added thereto, and cooled to 30° C. under stirring to prepare a nickel-containing solution.

20.0 g (38.2 mmol) of di(2,2-dimethylpropyl) 4,4′-dichlorobiphenyl-2,2′-disulfonate, 5.9 g (23.4 mmol) of 2,5-dichlorobenzophenone and 1.6 g (10.9 mmol) of 1,3-dichlorobenzene were added to a flask under an argon atmosphere, and dissolved in 350 g of NMP, and the temperature was regulated at 50° C. 8.1 g (123.3 mmol) of a zinc powder was added to the obtained solution, which was then cooled to 30° C. under stirring. The nickel-containing solution described above was poured thereinto, and the temperature was cooled to 30° C., and the polymerization reaction was carried out at 30° C. as it stood for 5 hours to obtain a black polymerization solution.

A polymer having sulfonic acid precursor groups was obtained by the similar operation as in Example A3 from the obtained polymerization solution, and then, sulfonic acid precursor groups were converted into sulfonic acid groups by the similar operation as in Example A3 to obtain Polymer F. The yield of Polymer F was 16.4 g. Mn, Mw and IEC of Polymer F were as follows.

| | |
|---|---|
| Mn = | 3.6 × 10⁵ |
| Mw = | 9.0 × 10⁵ |
| IEC | 4.4 meq/g |

Polymer F obtained was dissolved in 5 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 10 μm.

The water absorption rate and the proton conductivity of the obtained polymer electrolyte membrane were as follows.

| | |
|---|---|
| The water absorption rate | 200% |
| The proton conductivity | 4.0 × 10⁻¹ S/cm (at 80° C. and |
| | a relative humidity of 90%) |

Polymer F obtained was dissolved in 5 wt % concentration in DMSO to prepare a polymer electrolyte solution. Then, the obtained polymer electrolyte solution was continuously cast and applied on a polyethylene terephthalate (PET) film (E5000 grade, made by Toyobo Co., Ltd.) of 300 mm wide and 500 m long as a support base material by using an applicator, and dried under ordinary pressure at 70° C. for 1 hour to remove the solvent, and then subjected to hydrochloric acid treatment and washing with ion-exchange water to fabricate a polymer electrolyte membrane A6 having a membrane thickness of about 20 μm.

The obtained polymer electrolyte membrane A6 was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2,048. The obtained nonuniformity factor H was 0.03.

### Example A7

5.5 g (84 mmol) Of a zinc powder and 172 g of N,N-dimethylacetamide were mixed under a nitrogen atmosphere, and the temperature was regulated at 80° C. A solution composed of 0.16 g (1.68 mmol) of methanesulfonic acid and 8 g of N,N-dimethylacetamide was added thereto, and stirred at 80° C. for 2 hours. The solution was cooled to 30° C., and 18.0 g (31.3 mmol) of (2,2-dimethylpropyl) 4,4′-dichlorobiphenyl-2,2′-disulfonate, 5.85 g (10.67 mmol) of 9,9-dioctyl-2,7-dibromofluorene, and 89 g of toluene were added thereto (this was denoted as Solution A).

2.75 g (12.6 mmol) of anhydrous nickel bromide, 2.95 g (18.9 mmol) of 2,2′-bipyridyl and 148 g of N,N-dimethylacetamide were mixed in a flask under a nitrogen atmosphere, and the flask inside temperature was raised to 65° C., and the solution was stirred for 1 hour. The solution was cooled to 30° C. to prepare a nickel-containing solution (this was denoted as Solution B).

Solution B was poured into Solution A, and stirred at 30° C. for 2 hours to obtain a black polymerization solution. A polymer having sulfonic acid precursor groups was obtained by the similar operation as in Example A3 from the obtained polymerization solution, and then, sulfonic acid precursor groups were converted into sulfonic acid groups by the similar operation as in Example A3 to obtain Polymer G The yield of Polymer G was 13.3 g. Mn, Mw and IEC of Polymer G were as follows.

| | |
|---|---|
| Mn = | 1.3 × 10⁵ |
| Mw = | 3.7 × 10⁵ |
| IEC | 4.5 meq/g |

Polymer G obtained was dissolved in 5 wt % concentration in DMSO to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane A7 having a membrane thickness of about 20 μm.

The water absorption rate and the proton conductivity of the obtained polymer electrolyte membrane were as follows.

| | |
|---|---|
| The water absorption rate | 250% |
| The proton conductivity | 3.9 × 10⁻¹ S/cm (at 80° C. and |
| | a relative humidity of 90%) |

The obtained polymer electrolyte membrane A7 was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2048. The obtained nonuniformity factor H was 0.06.

The polymer according to the present invention can suitably be used particularly in applications to fuel cells because the polymer can simultaneously satisfy both a high-level ion conductivity and an excellent water resistance when used as a polymer electrolyte membrane, particularly as a proton conductive membrane for fuel cells.

<Measurement B of the Molar Composition Ratio and the Degree of Polymerization>

The ¹H-NMR (600 MHz) was measured and the molar composition ratio was calculated from the integration ratio. The degree of polymerization was similarly measured, and calculated from the integration ratio of terminal protons and other protons.

<Measurement B of the Ion-Exchange Capacity (IEC)>

A polymer used for the measurement was formed as a membrane by the solution cast method to obtain a polymer membrane, and the obtained polymer membrane was cut in a suitable weight. The dry weight of the cut polymer membrane was measured by using a halogen moisture percentage tester set at a heating temperature of 110° C. Then, the polymer membrane thus dried was immersed in 5 mL of 0.1 mol/L sodium hydroxide aqueous solution, and thereafter, 50 mL of ion-exchange water was further added thereto, and allowed to be left for 2 hours. Thereafter, 0.1 mol/L hydrochloric acid was gradually added to the solution in which the polymer membrane was immersed to titrate the solution to determine a point of neutralization, and the ion-exchange capacity (unit: meq/g) of the polymer was calculated from the dry weight of the cut polymer membrane and the amount of hydrochloric acid used for the neutralization.

<Measurement B of the Proton Conductivity>

The proton conductivity was measured by an alternating-current method. Two measuring cells were prepared each in which a carbon electrode was pasted on one surface of a silicon rubber (thickness: 200 μm) having a 1-cm² opening and arranged so that the carbon electrodes are opposed to each other, and terminals of an impedance measuring device were directly connected to the two cells described above. Then, between the two measuring cells, the polymer electrolyte membrane, obtained by the method described above, whose ion-exchange groups had been converted into a proton type, was set, and the resistance value between the two measuring cells at 23° C. was measured. Thereafter, the polymer electrolyte membrane was removed, and the resistance value was again measured. The membrane resistance in the membrane thickness direction of the polymer electrolyte membrane was calculated based on the difference between two resistance values acquired for the state of having a polymer electrolyte membrane and the state of having no polymer electrolyte membrane. The proton conductivity in the membrane thickness direction of the polymer electrolyte membrane was calculated from the value of the membrane resistance and the membrane thickness acquired. As a solution to be brought into contact with both sides of the polymer electrolyte membrane, 1 mol/L dilute sulfuric acid was used.

<Measurement B of the Water Absorption Rate>

As an index indicating the water resistance, the water absorption rate of a polymer electrolyte membrane was measured. A lower water absorption rate indicates a better water resistance. A dried membrane was weighed, and the amount of water absorbed was calculated from an increasing amount of the membrane weight after immersed in deionized water at 80° C. for 2 hours, and the ratio to the dried membrane was determined.

### Example B1

50.00 g (174.1 mmol) of 4,4′-dichlorodiphenylsulfone, 39.43 g (157.5 mmol) of 4,4′-sulfonyldiphenol, 22.86 g (165.4 mmol) of potassium carbonate, 203 mL of N-methylpyrrolidone, and 80 mL of toluene were added to a flask equipped with an azeotropic distillation apparatus under a nitrogen atmosphere. Toluene was heated and refluxed in a bath at 150° C. for 12 hours to azeotropically dehydrate moisture in the system, and water generated and toluene were distilled out; thereafter, the bath temperature was raised to 180° C., and the solution was kept at the temperature for 21 hours under stirring. After the reaction solution was allowed to cool, the reaction solution was poured into 12N hydrochloric acid/methanol solution (a mixed solution of 1/1 in weight ratio); and a separated precipitate was filtrated, washed with ion-exchange water until the filtrate became neutral, then washed with methanol, and thereafter dried. 77.31 g of an obtained crude product was dissolved in N-methylpyrrolidone, and the solution was poured into 12N hydrochloric acid/methanol solution (a mixed solution of 1/1 in weight ratio); and a separated precipitate was filtrated, washed with ion-exchange water until the filtrate became neutral, and dried to obtain 73.34 g of a polymer represented by the formula (E-1) shown below.

The GPC molecular weight: Mn=10000, Mw=16000
The degree of polymerization (n): 21
The hydrophobicity parameter: 2.43

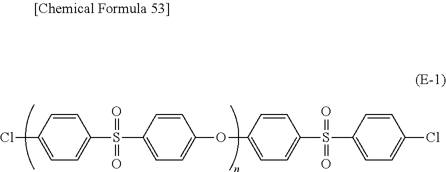

Then, 22.64 g (174.7 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 30.01 g (192.1 mmol) of 2,2′-bipyridyl was added thereto; and the mixture was stirred at the same temperature for 30 min to prepare a nickel-containing solution.

11.92 g of the polymer represented by the above formula (E-1) and 300 g of dimethylsulfoxide were added to a flask under an argon atmosphere, and the temperature was regulated at 50° C. 17.13 g (262.0 mmol) of a zinc powder and 20.0 g (67.29 mmol) of (2,2-dimethylpropyl) 2,5-dichlorobenzenesulfonate were added thereto, and the nickel-containing solution described above was poured thereto; the mixture was heated to 70° C. and subjected to a polymerization reaction for 3 hours to obtain a black polymerization solution.

The obtained polymerization solution was poured into water, and a generated precipitate was filtrated. Water, 9.2 g of a 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and a 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 25.23 g of a polymer having sulfonic acid precursor groups ((2,2-dimethylpropyl) sulfonate groups).

Then, sulfonic acid precursor groups were converted into sulfonic acid groups as follows.

25.18 g of the polymer having sulfonic acid precursor groups obtained as described above was placed in a flask; the flask inside atmosphere was fully replaced by argon; and 2.25 g of water, 10.83 g (124.7 mmol) of anhydrous lithium bromide and 315 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1260 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 18.41 g of a polymer represented by the formula (E-2) described below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=127000, Mw=356000
IEC: 2.81 meq/g
The proton conductivity: 0.081 S/cm
The water absorption rate: 118%

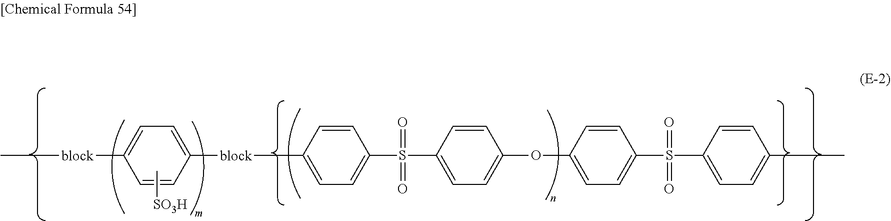

### Example B2

17.60 g (94.52 mmol) of 4,4′-biphenol, 50.00 g (174.1 mmol) of 4,4′-dichlorodiphenylsulfone, 15.77 g (63.01 mmol) of 4,4′-sulfonyldiphenol, 22.86 g (165.4 mmol) of potassium carbonate, 195 mL of N-methylpyrrolidone, and 60 mL of toluene were added to a flask equipped with an azeotropic distillation apparatus under a nitrogen atmosphere. Toluene was heated and refluxed in a bath at 150° C. for 6 hours to azeotropically dehydrate moisture in the system, and water generated and toluene were distilled out; thereafter, the bath temperature was raised to 180° C., and the solution was kept at the temperature for 13 hours under stirring. After the reaction solution was allowed to cool, the reaction solution was poured into 12N hydrochloric acid/methanol solution (a mixed solution of 1/1 in weight ratio); and a separated precipitate was filtrated, washed with ion-exchange water until the filtrate became neutral, then washed with methanol, and thereafter dried. 79.23 g of an obtained crude product was dissolved in 317 g of N-methylpyrrolidone, and the solution was poured into 12N hydrochloric acid/methanol solution (a mixed solution of 1/1 in weight ratio); and a separated precipitate was filtrated, thereafter washed with ion-exchange water until the filtrate became neutral, and dried to obtain 73.66 g of a polymer represented by the formula (E-3) shown below.

The GPC molecular weight: Mn=11000, Mw=18000
The molar composition ratio: aromatic residues originated from 4,4′-dichlorodiphenylsulfone+aromatic residues originated from 4,4′-sulfonyldiphenol/aromatic residues originated from 4,4′-biphenol=72/28
The degree of polymerization (n): 25
The hydrophobicity parameter: 2.51
The hydrophobicity parameter was calculated to be 2.51 by the following calculation expression:

(2.43×72)+(2.70×28)/100=2.51

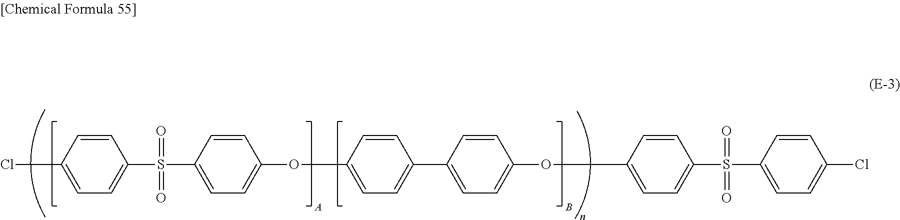

22.45 g (173.2 mmol) of anhydrous nickel chloride and 220 g of dimethylsulfoxide were mixed in a flask under an argon atmosphere; and the flask inside temperature was raised to 70° C., and the solution was stirred for 1 hour. The solution was cooled to 50° C., and 29.76 g (190.5 mmol) of 2,2′-bipyridyl was added thereto; and the mixture was stirred at the same temperature for 30 min to prepare a nickel-containing solution.

11.92 g of the polymer represented by the above formula (E-3) and 300 g of dimethylsulfoxide were added to a flask under an argon atmosphere, and the temperature was regulated at 50° C. 16.99 g (259.8 mmol) of a zinc powder and 20.0 g (67.29 mmol) of (2,2-dimethylpropyl) 2,5-dichlorobenzenesulfonate were added thereto, and the nickel-containing solution described above was poured thereto; the mixture was heated to 70° C. and subjected to a polymerization reaction for 3 hours to obtain a black polymerization solution.

The obtained polymerization solution was poured into water, and a generated precipitate was filtrated. Water, 9.2 g of a 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and a 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 26.55 g of a polymer having sulfonic acid precursor groups ((2,2-dimethylpropyl) sulfonate groups).

Then, sulfonic acid precursor groups were converted into sulfonic acid groups as follows.

26.55 g of the polymer having sulfonic acid precursor groups obtained as described above was placed in a flask; the flask inside atmosphere was fully replaced by argon; and 2.44 g of water, 11.77 g (135.5 mmol) of anhydrous lithium bromide and 313 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1250 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 19.84 g of a polymer represented by the formula (E-4) shown below.

The obtained polyarylene block copolymer was dissolved in 7 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=226000, Mw=486000
IEC: 2.78 meq/g
The proton conductivity: 0.088 S/cm
The water absorption rate: 101%

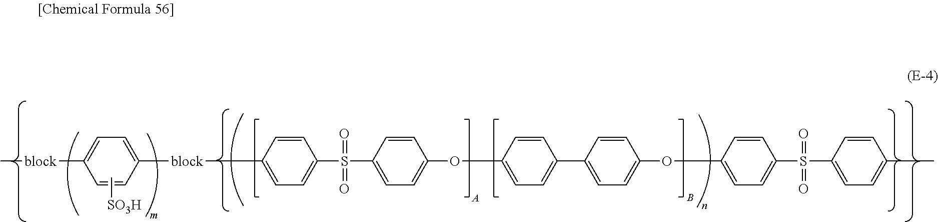

The obtained polymer electrolyte membrane was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2048. The obtained nonuniformity factor H was 0.30.

### Example B3

21.58 g (94.52 mmol) of 2,2-bis(4-hydroxyphenyl)propane, 50.00 g (174.1 mmol) of 4,4′-dichlorodiphenylsulfone, 15.77 g (63.01 mmol) of 4,4′-sulfonyldiphenol, 22.86 g (165.4 mmol) of potassium carbonate, 198 mL of N-methylpyrrolidone and 60 mL of toluene were added to a flask equipped with an azeotropic distillation apparatus under a nitrogen atmosphere. Toluene was heated and refluxed in a bath at 150° C. for 7 hours to azeotropically dehydrate moisture in the system, and water generated and toluene were distilled out; thereafter, the bath temperature was raised to 180° C., and the solution was kept at the temperature for 12 hours under stirring. After the reaction solution was allowed to cool, the reaction solution was poured into 12N hydrochloric acid/methanol solution (a mixed solution of 1/1 in weight ratio); and a separated precipitate was filtrated, thereafter washed with ion-exchange water until the filtrate became neutral, then washed with methanol, and thereafter dried. 80.54 g of an obtained crude product was dissolved in 321 g of N-methylpyrrolidone, and the solution was poured into 12N hydrochloric acid/methanol solution (a mixed solution of 1/1 in weight ratio); and a separated precipitate was filtrated, thereafter washed with ion-exchange water until the filtrate became neutral, and dried to obtain 72.89 g of a polymer represented by the formula (E-5) shown below.

The GPC molecular weight: Mn=7900, Mw=14000
The molar composition ratio: aromatic residues originated from 4,4′-dichlorodiphenylsulfone+aromatic residues originated from 4,4′-sulfonyldiphenol/aromatic residues originated from 2,2-bis(4-hydroxyphenyl)propane=71/29
The degree of polymerization (n): 21
The hydrophobicity parameter: 3.01
The hydrophobicity parameter was calculated to be 3.01 by the following calculation expression:

(2.43×71)+(4.43×29)/100=3.01

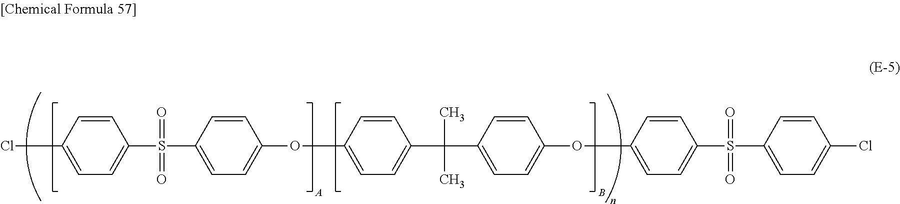

22.58 g (174.2 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 29.93 g (191.6 mmol) of 2,2′-bipyridyl was added thereto; and the mixture was stirred at the same temperature for 30 min to prepare a nickel-containing solution.

11.92 g of the polymer represented by the above formula (E-5) and 300 g of dimethylsulfoxide were added to a flask under an argon atmosphere, and the temperature was regulated at 50° C. 17.09 g (261.3 mmol) of a zinc powder and 20.0 g (67.29 mmol) of (2,2-dimethylpropyl) 2,5-dichlorobenzenesulfonate were added thereto, and the nickel-containing solution described above was poured thereto; the mixture was heated to 70° C. and subjected to a polymerization reaction for 3 hours to obtain a black polymerization solution.

The obtained polymerization solution was poured into water, and a generated precipitate was filtrated. Water, 9.2 g of 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 27.18 g of a polymer having sulfonic acid precursor groups ((2,2-dimethylpropyl) sulfonate groups).

Then, sulfonic acid precursor groups were converted into sulfonic acid groups as follows.

27.18 g of the polymer having sulfonic acid precursor groups obtained as described above was placed in a flask; the flask inside atmosphere was fully replaced by argon; and 2.43 g of water, 11.71 g (134.8 mmol) of anhydrous lithium bromide and 335 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1339 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 19.68 g of a polymer represented by the formula (E-6) shown below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=183000, Mw=383000
IEC: 2.78 meq/g
The proton conductivity: 0.090 S/cm
The water absorption rate: 89%

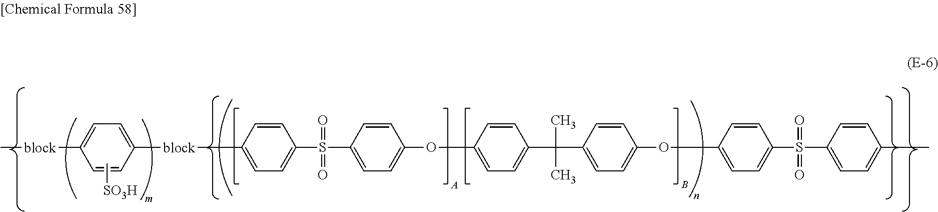

The polymer electrolyte membrane described above was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2,048. The obtained nonuniformity factor H was 0.25.

### Example B4

35.96 g (157.5 mmol) of 2,2-bis(4-hydroxyphenyl)propane, 50.00 g (174.1 mmol) of 4,4′-dichlorodiphenylsulfone, 22.86 g (165.4 mmol) of potassium carbonate, 195 mL of N-methylpyrrolidone and 60 mL of toluene were added to a flask equipped with an azeotropic distillation apparatus under a nitrogen atmosphere. Toluene was heated and refluxed in a bath at 150° C. for 6 hours to azeotropically dehydrate moisture in the system, and water generated and toluene were distilled out; thereafter, the bath temperature was raised to 180° C., and the solution was kept at the temperature for 11 hours under stirring. After the reaction solution was allowed to cool, the reaction solution was added to 12N hydrochloric acid/methanol solution (a mixed solution of 1/1 in weight ratio); and a separated precipitate was filtrated, thereafter washed with ion-exchange water until the filtrate became neutral, then washed with methanol, and thereafter dried. 74.16 g of an obtained crude product was dissolved in 300 g of N-methylpyrrolidone, and the solution was added to 12N hydrochloric acid/methanol solution (a mixed solution of 1/1 in weight ratio); and a separated precipitate was filtrated, thereafter washed with ion-exchange water until the filtrate became neutral, and dried to obtain 70.95 g of a polymer represented by the formula (E-7) shown below.

The GPC molecular weight: Mn=6000, Mw=10000
The molar composition ratio: aromatic residues originated from 4,4′-dichlorodiphenylsulfone+aromatic residues originated from 4,4′-sulfonyldiphenol/aromatic residues originated from 2,2-bis(4-hydroxyphenyl)propane=53/47
The degree of polymerization (n): 19
The hydrophobicity parameter: 3.37
The hydrophobicity parameter was calculated to be 3.37 by the following calculation expression:

(2.43×53)+(4.43×47)/100=3.37

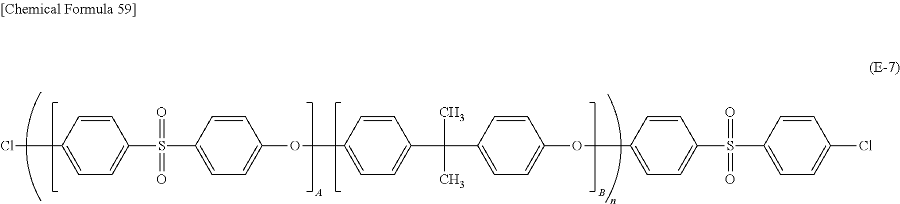

Then, 22.58 g (174.2 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 29.93 g (191.6 mmol) of 2,2′-bipyridyl was added thereto; and the mixture was stirred at the same temperature for 30 min to prepare a nickel-containing solution.

11.92 g of the polymer represented by the above formula (E-7) and 300 g of dimethylsulfoxide were added to a flask under an argon atmosphere, and the temperature was regulated at 50° C. 17.09 g (261.3 mmol) of a zinc powder and 20.0 g (67.29 mmol) of (2,2-dimethylpropyl) 2,5-dichlorobenzenesulfonate were added thereto, and the nickel-containing solution described above was poured thereinto; the mixture was heated to 70° C. and subjected to a polymerization reaction for 3 hours to obtain a black polymerization solution.

The obtained polymerization solution was poured into water, and a generated precipitate was filtrated. Water, 9.2 g of 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 26.04 g of a polymer having sulfonic acid precursor groups ((2,2-dimethylpropyl) sulfonate groups).

Then, sulfonic acid precursor groups were converted into sulfonic acid groups as follows.

26.04 g of the polymer having sulfonic acid precursor groups obtained as described above was placed in a flask; the flask inside atmosphere was fully replaced by argon; and 2.33 g of water, 11.21 g (129.1 mmol) of anhydrous lithium bromide and 326 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1,302 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 15.47 g of a polymer represented by the formula (E-8) shown below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=78000, Mw=279000
IEC: 2.73 meq/g
The proton conductivity: 0.075 S/cm
The water absorption rate: 69%

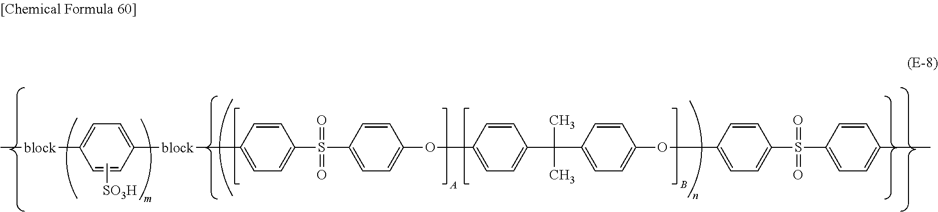

The polyarylene block copolymer described above was dissolved in 9 wt % concentration in N-methylpyrrolidone to prepare a polymer electrolyte solution. Then, the obtained polymer electrolyte solution was cast and applied on a PET film, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm. The obtained polymer electrolyte membrane was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2,048. The obtained nonuniformity factor H was 0.21.

### Example B5

50.00 g (174.1 mmol) of 4,4′-dichlorodiphenylsulfone, 41.45 g (165.6 mmol) of 4,4′-sulfonyldiphenol, 24.04 g (173.9 mmol) of potassium carbonate, 207 mL of N-methylpyrrolidone and 80 mL of toluene were added to a flask equipped with an azeotropic distillation apparatus under a nitrogen atmosphere. Toluene was heated and refluxed in a bath at 150° C. to azeotropically dehydrate moisture in the system, and water generated and toluene were distilled out; thereafter, the bath temperature was raised to 180° C., and the solution was kept at the temperature for 13 hours under stirring. After the reaction solution was allowed to cool, the reaction solution was added to 12N hydrochloric acid/methanol solution (a mixed solution of 1/1 in weight ratio); and a separated precipitate was filtrated, thereafter washed with ion-exchange water until the filtrate became neutral, then washed with methanol, and thereafter dried. 86.40 g of an obtained crude product was dissolved in N-methylpyrrolidone, and the solution was added to 12N hydrochloric acid/methanol solution (a mixed solution of 1/1 in weight ratio); and a separated precipitate was filtrated, thereafter washed with ion-exchange water until the filtrate became neutral, and dried to obtain 74.25 g of a polymer represented by the formula (E-9) shown below.

The obtained polyarylene block copolymer was dissolved in 10 wt % concentration in NMP to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=18000, Mw=32000
The degree of polymerization (n): 42
The hydrophobicity parameter: 2.43

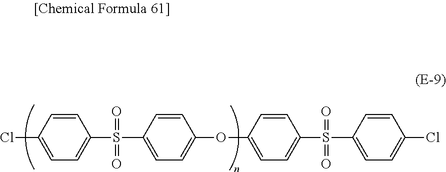

Then, 22.19 g (171.2 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 29.42 g (188.4 mmol) of 2,2′-bipyridyl was added thereto; and the mixture was stirred at the same temperature for 30 min to prepare a nickel-containing solution.

11.92 g of the polymer represented by the above formula (E-9) and 300 g of dimethylsulfoxide were added to a flask under an argon atmosphere, and the temperature was regulated at 50° C. 16.79 g (256.8 mmol) of a zinc powder and 20.0 g (67.29 mmol) of (2,2-dimethylpropyl) 2,5-dichlorobenzenesulfonate were added thereto, and the nickel-containing solution described above was poured thereinto; the mixture was then heated to 70° C. and subjected to a polymerization reaction for 3 hours to obtain a black polymerization solution.

The obtained polymerization solution was poured into water, and a generated precipitate was filtrated. Water, 9.2 g of 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 25.88 g of a polymer having sulfonic acid precursor groups ((2,2-dimethylpropyl) sulfonate groups).

Then, sulfonic acid precursor groups were converted into sulfonic acid groups as follows.

25.80 g of the polymer having sulfonic acid precursor groups obtained as described above was placed in a flask; the flask inside atmosphere was fully replaced by argon; and 2.30 g of water, 11.10 g (127.8 mmol) of anhydrous lithium bromide and 323 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1290 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 18.10 g of a polymer represented by the formula (E-10) shown below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=147000, Mw=341000
IEC: 2.61 meq/g
The proton conductivity: 0.062 S/cm
The water absorption rate: 95%

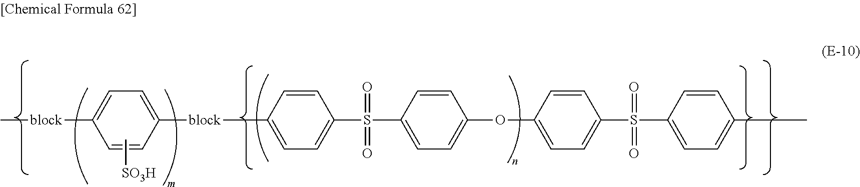

### Example B6

18.69 g (100.37 mmol) of 4,4′-biphenol, 50.00 g (174.1 mmol) of 4,4′-dichlorodiphenylsulfone, 16.75 g (66.92 mmol) of 4,4′-sulfonyldiphenol, 24.28 g (175.7 mmol) of potassium carbonate, 199 mL of N-methylpyrrolidone and 80 mL of toluene were added to a flask equipped with an azeotropic distillation apparatus under a nitrogen atmosphere. Toluene was heated and refluxed in a bath at 150° C. for 6 hours to azeotropically dehydrate moisture in the system, and water generated and toluene were distilled out; thereafter, the bath temperature was raised to 180° C., and the solution was kept at the temperature for 15 hours under stirring. After the reaction solution was allowed to cool, the reaction solution was poured into 12N hydrochloric acid/methanol solution (a mixed solution of 1/1 in weight ratio); and a separated precipitate was filtrated, thereafter washed with ion-exchange water until the filtrate became neutral, then washed with methanol, and thereafter dried. An obtained crude product was dissolved in N-methylpyrrolidone, and the solution was added to 12N hydrochloric acid/methanol solution (a mixed solution of 1/1 in weight ratio); and a separated precipitate was filtrated, thereafter washed with ion-exchange water until the filtrate became neutral, and dried to obtain 69.78 g of a polymer represented by the formula (E-11) shown below.

The GPC molecular weight: Mn=23000, Mw=38000
The molar composition ratio: aromatic residues originated from 4,4′-dichlorodiphenylsulfone+aromatic residues originated from 4,4′-sulfonyldiphenol/aromatic residues originated from 4,4′-biphenol=71/29
The degree of polymerization (n): 45
The hydrophobicity parameter: 2.51
The hydrophobicity parameter was calculated to be 2.51 by the following calculation expression:

(2.43×71)+(2.70×29)/100=2.51

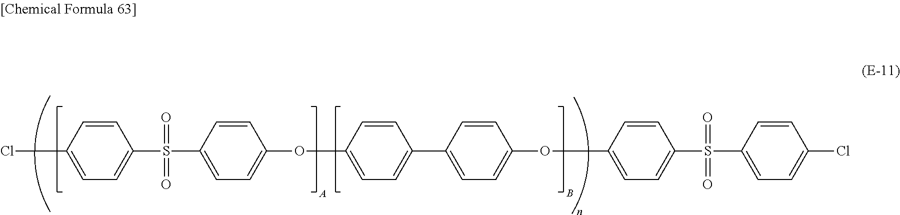

22.11 g (170.6 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 29.30 g (187.6 mmol) of 2,2′-bipyridyl was added thereto; and the mixture was stirred at the same temperature for 30 min to prepare a nickel-containing solution.

11.20 g of the polymer represented by the above formula (E-11) and 300 g of dimethylsulfoxide were added to a flask under an argon atmosphere, and the temperature was regulated at 50° C. 16.73 g (255.9 mmol) of a zinc powder and 20.0 g (67.29 mmol) of (2,2-dimethylpropyl) 2,5-dichlorobenzenesulfonate were added thereto, and the nickel-containing solution described above was poured thereto; the mixture was heated to 70° C. and subjected to a polymerization reaction for 3 hours to obtain a black polymerization solution.

The obtained polymerization solution was poured into water, and a generated precipitate was filtrated. Water, 9.2 g of 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 24.50 g of a polymer having sulfonic acid precursor groups ((2,2-dimethylpropyl) sulfonate groups).

Then, sulfonic acid precursor groups were converted into sulfonic acid groups as follows.

24.50 g of the polymer having sulfonic acid precursor groups obtained as described above was placed in a flask; the flask inside atmosphere was fully replaced by argon; and 2.24 g of water, 10.84 g (124.8 mmol) of anhydrous lithium bromide and 306 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1225 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 14.87 g of a polymer represented by the formula (E-12) shown below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=135000, Mw=269000
IEC: 2.65 meq/g
The proton conductivity: 0.025 S/cm
The water absorption rate: 78%

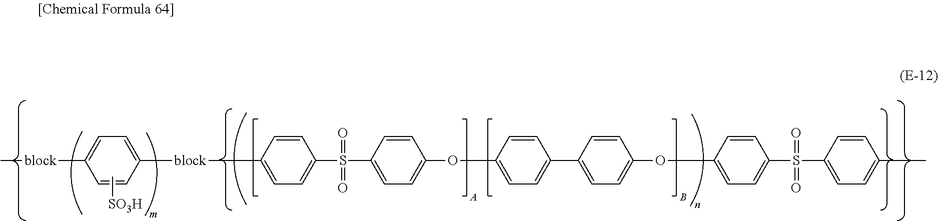

The polyarylene block copolymer described above was dissolved in 9 wt % concentration in N-methylpyrrolidone to prepare a polymer electrolyte solution. Then, the obtained polymer electrolyte solution was cast and applied on a PET film, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm. The obtained polymer electrolyte membrane was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2048. The obtained nonuniformity factor H was 0.25.

### Example B7

22.69 g (99.38 mmol) of 2,2-bis(4-hydroxyphenyl)propane, 50.00 g (174.1 mmol) of 4,4′-dichlorodiphenylsulfone, 16.58 g (66.25 mmol) of 4,4′-sulfonyldiphenol, 24.04 g (173.9 mmol) of potassium carbonate, 202 mL of N-methylpyrrolidone and 60 mL of toluene were added to a flask equipped with an azeotropic distillation apparatus under a nitrogen atmosphere. Toluene was heated and refluxed in a bath at 150° C. for 7 hours to azeotropically dehydrate moisture in the system, and water generated and toluene were distilled out; thereafter, the bath temperature was raised to 180° C., and the solution was kept at the temperature for 14 hours under stirring. After the reaction solution was allowed to cool, the reaction solution was added to 12N hydrochloric acid/methanol solution (a mixed solution of 1/1 in weight ratio); and a separated precipitate was filtrated, thereafter washed with ion-exchange water until the filtrate became neutral, then washed with methanol, and thereafter dried. 76.77 g of an obtained crude product was dissolved in 304 g of N-methylpyrrolidone, and the solution was added to 12N hydrochloric acid/methanol solution (a mixed solution of 1/1 in weight ratio); and a separated precipitate was filtrated, thereafter washed with ion-exchange water until the filtrate became neutral, and dried to obtain 75.59 g of a polymer represented by the formula (E-13) shown below.

The GPC molecular weight: Mn=14000, Mw=26000
The molar composition ratio: aromatic residues originated from 4,4′-dichlorodiphenylsulfone+aromatic residues originated from 4,4′-sulfonyldiphenol/aromatic residues originated from 2,2-bis(4-hydroxyphenyl)propane=70/30
The degree of polymerization (n): 39
The hydrophobicity parameter: 3.03
The hydrophobicity parameter was calculated to be 3.03 by the following calculation expression:

(2.43×70)+(4.43×30)/100=3.03

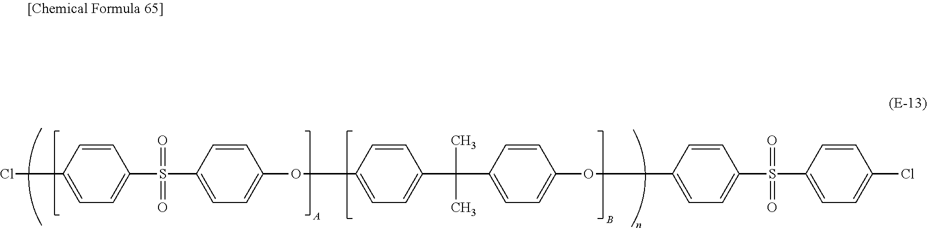

22.23 g (171.6 mmol) of anhydrous nickel chloride and 221 g of dimethylsulfoxide were mixed in a flask under an argon atmosphere; and the flask inside temperature was raised to 70° C., and the solution was stirred for 1 hour. The solution was cooled to 50° C., and 29.47 g (188.7 mmol) of 2,2′-bipyridyl was added thereto; and the mixture was stirred at the same temperature for 30 min to prepare a nickel-containing solution.

11.92 g of the polymer represented by the above formula (E-13) and 300 g of dimethylsulfoxide were added to a flask under an argon atmosphere, and the temperature was regulated at 50° C. 16.83 g (257.3 mmol) of a zinc powder and 20.0 g (67.29 mmol) of (2,2-dimethylpropyl) 2,5-dichlorobenzenesulfonate were added thereto, and the nickel-containing solution described above was poured thereto; and the mixture was heated to 70° C. and subjected to a polymerization reaction for 3 hours to obtain a black polymerization solution.

The obtained polymerization solution was poured into water, and a generated precipitate was filtrated. Water, 9.2 g of 35% sodium nitrite aqueous solution and 160 g of 69% nitric acid were added to the obtained precipitate, and stirred at room temperature for 1 hour. The crude polymer solution was filtrated, and the crude polymer was washed with water until the pH of the filtrate exceeded 4. Then, the crude polymer was added to a flask equipped with a cooling device, and water was added so that the total weight of the crude polymer and water reached 696 g; and 5% lithium hydroxide aqueous solution was added thereto until the pH of the crude polymer aqueous solution became 7 to 9, and 666 g of methanol was further added thereto, and the mixture was heated and stirred at a bath temperature of 90° C. for 1 hour. The crude polymer was filtrated, further washed with water and methanol, and dried to thereby obtain 26.29 g of a polymer having sulfonic acid precursor groups ((2,2-dimethylpropyl) sulfonate groups).

Then, sulfonic acid precursor groups were converted into sulfonic acid groups as follows.

26.29 g of the polymer having sulfonic acid precursor groups obtained as described above was placed in a flask; the flask inside atmosphere was fully replaced by argon; and 2.33 g of water, 11.32 g (130.4 mmol) of anhydrous lithium bromide and 329 g of N-methylpyrrolidone were added thereto, and after the polymer having sulfonic acid precursor groups was sufficiently dissolved, the bath temperature was raised to 126° C., and the conversion reaction to the sulfonic acid group was carried out at the same temperature for 12 hours to obtain a polymer solution.

The polymer solution was charged in 1315 g of 6N hydrochloric acid, and stirred for 1 hour. A separated crude polymer was filtrated, several times washed with a large amount of hydrochloric acid methanol solution, and thereafter washed with water until the pH of the filtrate exceeded 4, and dried to obtain 18.15 g of a polymer represented by the formula (E-14) shown below.

The obtained polyarylene block copolymer was dissolved in 9 wt % concentration in N-methylpyrrolidone to prepare a polymer electrolyte solution. Then, the obtained polymer electrolyte solution was cast and applied on a glass plate, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm.

The GPC molecular weight: Mn=135000, Mw=325000
IEC: 2.70 meq/g
The proton conductivity: 0.047 S/cm
The water absorption rate: 80%

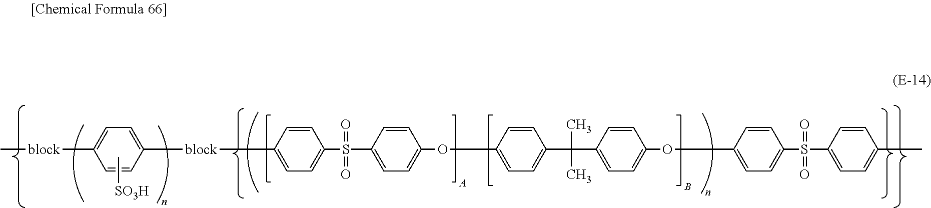

The polyarylene block copolymer described above was dissolved in 9 wt % concentration in N-methylpyrrolidone to prepare a polymer electrolyte solution. Then, the obtained polymer electrolyte solution was cast and applied on a PET film, and dried under ordinary pressure at 80° C. for 2 hours to remove the solvent, and then subjected to hydrochloric acid treatment and washing with ion-exchange water to fabricate a polymer electrolyte membrane having a membrane thickness of about 20 μm. The obtained polymer electrolyte membrane was subjected to the first immersion treatment and the second immersion treatment as described before, and measured for ¹³C-solid state NMR spectra. The area was determined by integrating peaks of the ¹³C-solid state NMR spectrum in the range of 170 ppm to 100 ppm. The contact time was set at 3 msec, and the number of accumulation was set at 2048. The obtained nonuniformity factor H was 0.29.

The evaluation results of Examples described above are collectively shown in Table 3.

TABLE 3

| | | Hydrophobicity | | | | Proton |
|---|---|---|---|---|---|---|
| | Mw of | Parameter of | | Proton | Water | Conductivity/ |
| | Hydrophobic | Hydrophobic | IEC, | Conductivity | Absorption | Water Absorption |
| | Polymer | Polymer | meq/g | S/cm | Rate, % | Rate × 1000 |
| Example B1 | 16000 | 2.43 | 2.81 | 0.081 | 118 | 0.72 |
| Example B2 | 18000 | 2.51 | 2.78 | 0.088 | 101 | 0.87 |
| Example B3 | 14000 | 3.01 | 2.78 | 0.090 | 89 | 1.01 |
| Example B4 | 10000 | 3.37 | 2.73 | 0.075 | 69 | 1.09 |
| Example B5 | 32000 | 2.43 | 2.61 | 0.062 | 95 | 0.65 |
| Example B6 | 38000 | 2.51 | 2.65 | 0.025 | 78 | 0.32 |
| Example B7 | 26000 | 3.03 | 2.70 | 0.047 | 80 | 0.58 |

From the above results, it has been clarified that the polyarylene block copolymer can provide a membrane having a high proton conductivity as well as an excellent water resistance, wherein the polyarylene block copolymer is a block copolymer comprising a block having ion-exchange groups and a block having substantially no ion-exchange group and obtained by polymerizing a polymer having ion-exchange groups with a polymer having substantially no ion-exchange group and a polystyrene-equivalent weight-average molecular weight of 4000 to 25000; and the block having ion-exchange groups comprises a structural unit represented by the above formula (B-1), and the block having substantially no ion-exchange group comprises a structural unit represented by the above formula (B-2). The polymer electrolyte according to the present invention is industrially very useful because the polymer electrolyte can provide a fuel cell excellent in the power generation efficiency.

<Measurement C of the Ion-Exchange Capacity (IEC)>

A membrane whose ion-exchange groups had been converted into a free acid type (proton type) was dried further at 105° C. by a halogen moisture percentage tester to determine a bone-dried weight thereof. This membrane was immersed in 5 mL of 0.1 mol/L sodium hydroxide aqueous solution, and thereafter, 50 mL of ion-exchange water was added thereto, and the membrane was allowed to be left for 2 hours. Thereafter, 0.1 mol/L hydrochloric acid was gradually added to the solution in which the polymer electrolyte membrane was immersed to titrate the solution to determine a point of neutralization. The ion-exchange capacity is determined from the bone-died weight and the amount of 0.1 mol/L hydrochloric acid used for the neutralization.

<Measurement C of the Degree of Polymerization n>

The ¹H-NMR (600 MHz) of a precursor of a block having no ion-exchange group was measured, and the degree of polymerization n was calculated from the integration ratio of terminal protons and other protons.

### Synthesis Example C1

### Block Precursor A Having No Ion-Exchange Group

50.00 g (174.1 mmol) of 4,4′-dichlorodiphenylsulfone, 41.45 g (165.6 mmol) of bis(4-hydroxyphenyl)sulfone, 24.04 g (173.9 mmol) of potassium carbonate, 207 mL of N-methylpyrrolidone (NMP) and 80 nit of toluene were added to a flask equipped with an azeotropic distillation apparatus under a nitrogen atmosphere. A bath was heated at 150° C. under reflux to azeotropically dehydrate moisture in the system, and water generated and toluene were distilled out; thereafter, the bath temperature was raised to 180° C., and the solution was kept at the temperature for 13 hours under stirring. After the reaction solution was allowed to cool, the reaction solution was poured into 37 wt % hydrochloric acid/methanol solution (a mixed solution of 1/1 in weight ratio); and a separated precipitate was collected by filtration, washed with ion-exchange water until the filtrate became neutral, then washed with methanol, and thereafter dried. 86.40 g of an obtained crude product was dissolved in NMP, and the solution was poured into 37 wt % hydrochloric acid/methanol solution (a mixed solution of 1/1 in weight ratio); and a separated precipitate was collected by filtration, washed with ion-exchange water until the filtrate became neutral, and dried. 74.25 g of a target substance was obtained. The molecular weight of the obtained Block Precursor A having no ion-exchange group was Mn=18000 and Mw=32000, and the degree of polymerization n was 43.

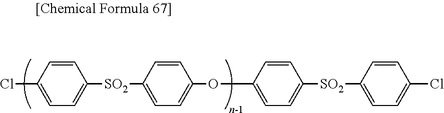

### Synthesis Example C2

### Block Precursor B Having No Ion-Exchange Group

50.00 g (174.1 mmol) of 4,4′-dichlorodiphenylsulfone, 39.43 g (157.5 mmol) of bis(4-hydroxyphenyl)sulfone, 22.86 g (165.4 mmol) of potassium carbonate, 203 mL of N-methylpyrrolidone (NMP) and 80 mL of toluene were added to a flask equipped with an azeotropic distillation apparatus under a nitrogen atmosphere. A bath was heated at 150° C. under reflux to azeotropically dehydrate moisture in the system, and water generated and toluene were distilled out; thereafter, the bath temperature was raised to 180° C., and the solution was kept at the temperature for 21 hours under stirring. After the reaction solution was allowed to cool, the reaction solution was poured into 37 wt % hydrochloric acid/methanol solution (a mixed solution of 1/1 in weight ratio); and a separated precipitate was collected by filtration, washed with ion-exchange water until the filtrate became neutral, then washed with methanol, and thereafter dried. 77.31 g of an obtained crude product was dissolved in NMP, and the solution was poured into 37 wt % hydrochloric acid/methanol solution (a mixed solution of 1/1 in weight ratio); and a separated precipitate was collected by filtration, washed with ion-exchange water until the filtrate became neutral, and dried. 73.34 g of a target substance was obtained. The molecular weight of the obtained Block Precursor B having no ion-exchange group was Mn=9700 and Mw=16000, and the degree of polymerization n was 22.

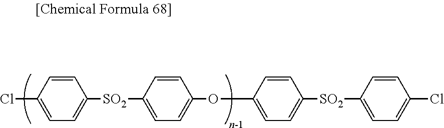

### Synthesis Example C3

### Block Precursor C Having No Ion-Exchange Group

8.00 g (32.0 mmol) of bis(4-hydroxyphenyl)sulfone, 5.30 g (38.4 mmol) of potassium carbonate, 71 mL of N,N-dimethylacetamide (DMAc) and 36 mL of toluene were added to a flask equipped with an azeotropic distillation apparatus under a nitrogen atmosphere. Then, the mixture was heated and refluxed at 140° C. to azeotropically dehydrate moisture in the system, and water generated and toluene were distilled out, and thereafter, the solution was cooled to 60° C. 20.77 g (76.7 mmol) of 4-chloro-4′-fluorodiphenylsulfone was added thereto, and the temperature was raised to 120° C. and held at the temperature for 13 hours under stirring. After the reaction solution was allowed to cool, the reaction solution was filtrated to remove inorganic salts; and the filtrate was poured into methanol, and a separated precipitate was collected by filtration, and dried. An obtained crude product was subjected to a recrystallization refining with chloroform-ethyl acetate to obtain 7.73 g of a target substance. The degree of polymerization n of the obtained Block Precursor C having no ion-exchange group was 3.

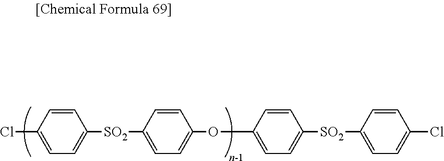

### Synthesis Example C4

22.19 g (171.2 mmol) of anhydrous nickel chloride and 221 g of dimethylsulfoxide (DMSO) were added to a flask under an argon atmosphere, and heated to 70° C. to dissolve the mixture. The solution was cooled to 50° C.; and 29.42 g (188.4 mmol) of 2,2′-bipyridyl was added thereto, and the mixture was kept at the same temperature to prepare a nickel-containing solution.

11.92 g of Precursor A obtained in Synthesis Example C1, and 300 g of DMSO were added to a flask under an argon atmosphere, and heated to 50° C. to dissolve the mixture. 0.039 g (0.40 mmol) of methanesulfonic acid and 16.79 g (256.8 mmol) of a zinc powder were added to the obtained solution, and kept at the temperature under stirring for 30 min. Then, 20.00 g (67.3 mmol) of (2,2-dimethylpropyl) 2,5-dichlorobenzenesulfonate was added thereto and dissolved. The nickel-containing solution described above was poured thereinto, heated to 70° C., and kept at the temperature for 2 hours under stirring to obtain a black polymerization solution.

The obtained polymerization solution was poured into 1200 g of hot water at 70° C.; and a generated precipitate was collected by filtration. Water was added to the precipitate so that the total of the precipitate and water was 696 g, and 9.2 g of 35 wt % sodium nitrite aqueous solution was further added thereto. To this slurry solution, 172 g of 65 wt % nitric acid was dropped over 30 min, and after the dropping, the slurry solution was stirred at room temperature for 1 hour. The slurry solution was filtrated, and a collected crude polymer was washed with water until the pH of the filtrate exceeded 1. Next, the crude polymer was added to a flask equipped with a cooling device, and water was added thereto so that the total weight of the crude polymer and water reached 698 g; and 5 wt % lithium hydroxide aqueous solution was further added thereto until the pH of the slurry solution of the crude polymer and water reached 7.8; and 666 g of methanol was further added, and the solution was refluxed for 1 hour. The crude polymer was collected by filtration, immersed in and washed with 200 g of water, and then 280 g of methanol, and dried in a drier at 80° C. to obtain 25.23 g of a polymer having sulfonic acid precursor groups ((2,2-dimethylpropyl) sulfonate groups).

Then, the sulfonic acid precursor groups were converted into sulfonic acid groups as follows.

25.15 g of the polymer having sulfonic acid precursor groups obtained as described above was placed in a flask; under an argon atmosphere, 630 g of NMP was added thereto, and the mixture was heated and stirred at 80° C. and dissolved. 33 g of an activated alumina was added thereto, and stirred for 1 hour and 30 min at the temperature. Thereafter, 630 g of NMP was added thereto, and the activated alumina was removed by filtration. NMP was distilled out from the obtained solution under reduced pressure to concentrate the solution to make 305 g of an NMP solution. 2.2 g of water and 10.82 g (124.6 mmol) of anhydrous lithium bromide were added to the solution, heated to 120° C., and stirred at the temperature for 12 hours. An obtained reaction solution was charged in 1260 g of 6N hydrochloric acid, and stirred for 1 hour. A separated crude polymer was collected by filtration, and three times immersed in and washed with 1260 g of 35 wt % hydrochloric acid/methanol solution (a mixed solution of 1/1 in weight ratio), and thereafter washed with water until the pH of the filtrate exceeded 4. Then, the crude polymer was four times immersed in and washed with 1640 g of hot water (95° C.), and dried to obtain 17.71 g of a polyarylene block copolymer represented by the structure shown below. The molecular weight of the obtained copolymer was Mn=139000 and Mw=314000.

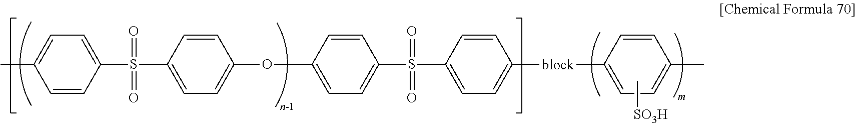

The obtained polyarylene block copolymer was dissolved in 9.0 wt % concentration in DMSO to prepare a polymer electrolyte solution. Then, the obtained polymer electrolyte solution was cast and applied on a PET film, and dried under ordinary pressure at 100° C. to remove the solvent, and then subjected to an immersion treatment with a 2N sulfuric acid and washing with ion-exchange water to fabricate a polymer electrolyte membrane C1 having a membrane thickness of about 22 μm. The IEC of the obtained polymer electrolyte membrane C1 was 2.49 meq/g.

### Synthesis Example C5

22.64 g (174.7 mmol) of anhydrous nickel chloride and 221 g of dimethylsulfoxide (DMSO) were added to a flask under an argon atmosphere, and heated to 70° C. to dissolve the mixture. The solution was cooled to 50° C.; and 30.01 g (192.1 mmol) of 2,2′-bipyridyl was added thereto, and the mixture was kept at the same temperature to prepare a nickel-containing solution.

11.92 g of Precursor B obtained by Synthesis Example C2, and 300 g of DMSO were added to a flask under an argon atmosphere, and heated to 50° C. to dissolve the mixture. 0.039 g (0.40 mmol) of methanesulfonic acid and 17.13 g (262.0 mmol) of a zinc powder were added to the obtained solution, and kept at the temperature under stirring for 30 min. Then, 20.00 g (67.3 mmol) of (2,2-dimethylpropyl) 2,5-dichlorobenzenesulfonate was added thereto and dissolved. The nickel-containing solution described above was poured thereinto, heated to 70° C., and kept at the temperature for 2 hours under stirring to obtain a black polymerization solution.

The obtained polymerization solution was poured into 1200 g of hot water at 70° C.; and a generated precipitate was collected by filtration. Water was added to the precipitate so that the total of the precipitate and water was 696 g, and 9.2 g of 35 wt % sodium nitrite aqueous solution was further added thereto. To this slurry solution, 172 g of 65 wt % nitric acid was dropped over 30 min, and after the dropping, the slurry solution was stirred at room temperature for 1 hour. The slurry solution was filtrated, and a collected crude polymer was washed with water until the pH of the filtrate exceeded 1. Next, the crude polymer was added to a flask equipped with a cooling device, and water was added thereto so that the total weight of the crude polymer and water reached 698 g; and 5 wt % lithium hydroxide aqueous solution was further added thereto until the pH of the slurry solution of the crude polymer and water reached 8.2; and 666 g of methanol was father added, and the solution was refluxed for 1 hour. The crude polymer was collected by filtration, immersed in and washed with 200 g of water, and then 280 g of methanol, and dried in a drier at 80° C. to obtain 25.37 g of a polymer having sulfonic acid precursor groups ((2,2-dimethylpropyl) sulfonate groups).

Then, the sulfonic acid precursor groups were converted into sulfonic acid groups as follows.

25.31 g of the polymer having sulfonic acid precursor groups obtained as described above was placed in a flask; under an argon atmosphere, 630 g of NMP was added thereto, and the mixture was heated and stirred at 80° C. and dissolved. 33 g of an activated alumina was added thereto, and stirred for 1 hour and 30 min at the temperature. Thereafter, 630 g of NMP was added thereto, and the activated alumina was removed by filtration. NMP was distilled out from the obtained solution under reduced pressure to concentrate the solution to make 302 g of an NMP solution. 2.3 g of water and 10.89 g (125.4 mmol) of anhydrous lithium bromide were added to the solution, heated to 120° C., and stirred at the temperature for 12 hours. An obtained reaction solution was charged in 1270 g of 6N hydrochloric acid, and stirred for 1 hour. A separated crude polymer was collected by filtration, and three times immersed in and washed with 1270 g of 35 wt % hydrochloric acid/methanol solution (a mixed solution of 1/1 in weight ratio), and thereafter washed with water until the pH of the filtrate exceeded 4. Then, the crude polymer was four times immersed in and washed with 1650 g of hot water (95° C.), and dried to obtain 18.50 g of a polyarylene block copolymer represented by the structure shown below. The molecular weight of the obtained copolymer was Mn=116000 and Mw 315000.

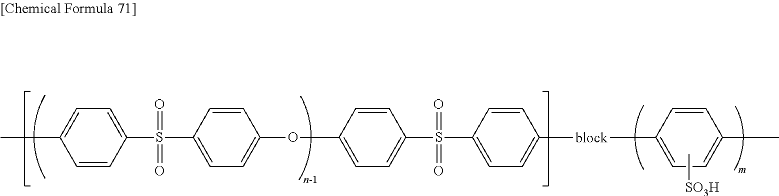

The obtained polyarylene block copolymer was dissolved in 9.0 wt % concentration in DMSO to prepare a polymer electrolyte solution. Then, the obtained polymer electrolyte solution was cast and applied on a PET film, and dried under ordinary pressure at 115° C. to remove the solvent, and then subjected to an immersion treatment with a 2N sulfuric acid and washing with ion-exchange water to fabricate a polymer electrolyte membrane C2 having a membrane thickness of about 20 μm. The IEC of the obtained polymer electrolyte membrane C2 was 2.70 meq/g.

### Synthesis Example C6

13.85 g (106.9 mmol) of anhydrous nickel chloride and 110 g of dimethylsulfoxide (DMSO) were added to a flask under an argon atmosphere, and heated to 70° C. to dissolve the mixture. The solution was cooled to 50° C.; and 18.36 g (117.6 mmol) of 2,2′-bipyridyl was added thereto, and the mixture was kept at the same temperature to prepare a nickel-containing solution.

6.35 g of Precursor C obtained by Synthesis Example C3, and 150 g of DMSO were added to a flask under an argon atmosphere, and heated to 50° C. to dissolve the mixture. 0.019 g (0.20 mmol) of methanesulfonic acid and 10.48 g (160.3 mmol) of a zinc powder were added to the obtained solution, and kept at the temperature under stirring for 30 min. Then, 10.00 g (33.7 mmol) of (2,2-dimethylpropyl) 2,5-dichlorobenzenesulfonate was added thereto and dissolved. The nickel-containing solution described above was poured thereinto, heated to 70° C., and kept at the temperature for 2 hours under stirring to obtain a black polymerization solution. The obtained polymerization solution was poured into 600 g of hot water at 70° C.; and a generated precipitate was collected by filtration. Water was added to the precipitate so that the total of the precipitate and water was 348 g, and 4.6 g of 35 wt % sodium nitrite aqueous solution was further added thereto. To this slurry solution, 80 g of 70 wt % nitric acid was dropped over 12 min, and after the dropping, the slurry solution was stirred at room temperature for 1 hour. The slurry solution was filtrated, and a collected crude polymer was washed with water until the pH of the filtrate exceeded 1. Next, the crude polymer was added to a flask equipped with a cooling device, and water was added thereto so that the total weight of the crude polymer and water reached 352 g; and 5 wt % lithium hydroxide aqueous solution was further added thereto until the pH of the slurry solution of the crude polymer and water reached 8.4; and 333 g of methanol was further added, and the solution was refluxed for 1 hour. The crude polymer was collected by filtration, immersed in and washed with 150 g of water, and then 150 g of methanol, and dried in a drier at 80° C. to obtain 12.30 g of a polymer having sulfonic acid precursor groups ((2,2-dimethylpropyl) sulfonate groups).

Then, the sulfonic acid precursor groups were converted into sulfonic acid groups as follows.

12.25 g of the polymer having sulfonic acid precursor groups obtained as described above was placed in a flask; under an argon atmosphere, 110 g of NMP, 1.1 g of water and 5.13 g (59.7 mmol) of anhydrous lithium bromide were added thereto, and the temperature was raised to 120° C., and kept at the temperature for 13 hours under stirring. An obtained reaction solution was charged in 610 g of 6N hydrochloric acid, and stirred for 1 hour. A separated crude polymer was collected by filtration, and three times immersed in and washed with 600 g of 35 wt % hydrochloric acid/methanol solution (a mixed solution of 1/1 in weight ratio), and thereafter washed with water until the pH of the filtrate exceeded 4. Then, the crude polymer was three times immersed in and washed with 800 g of hot water (95° C.), and dried to obtain 8.89 g of a polyarylene block copolymer represented by the structure shown below. The molecular weight of the obtained copolymer was Mn=54000 and Mw=301000.

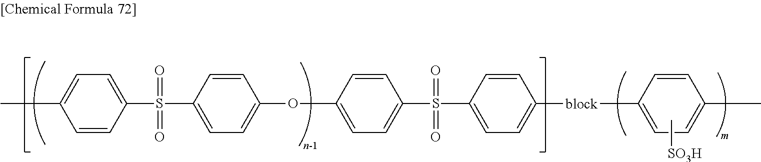

The obtained polyarylene block copolymer was dissolved in 12.0 wt % concentration in DMSO to prepare a polymer electrolyte solution. Then, the obtained polymer electrolyte solution was cast and applied on a PET, and dried under ordinary pressure at 100° C. to remove the solvent, and then subjected to an immersion treatment with a 2N sulfuric acid and washing with ion-exchange water to fabricate a polymer electrolyte membrane C3 having a membrane thickness of about 27 μm. The IEC of the obtained polymer electrolyte membrane C3 was 2.82 meq/g.

Fabrication and Evaluation of a Cell as a Fuel Cell

### (Preparation of a Catalyst Ink)

0.50 g of a platinum-supported carbon, which supported 50% by weight of platinum, (SA50BK, made by N. E. Chemcat Co., Ltd.) was charged in 3.15 g of a commercially available 5 wt % Nafion® solution (made by Sigma-Aldrich Corp., trade name: Nafion perfluorinated ion-exchange resin, 5 wt % solution in lower aliphatic alcohols/H₂O mix, the solvent: a mixture of water and lower alcohols), and 3.23 g of water and 21.83 g of ethanol were further added thereto. The obtained mixture was subjected to an ultrasonic treatment for 1 hour, and thereafter stirred for 6 hours by a stirrer to obtain a catalyst ink.

### Example C1

### (Fabrication of MEA1)

The catalyst ink described above was applied on a region of 1 cm×1.3 cm of the central part of one surface of the polymer electrolyte membrane C1 fabricated as described above, by a spray method. At this time, the distance from a discharge port to the membrane was set at 6 cm; and the stage temperature was set at 75° C. After overspray was similarly carried out, the solvent was removed to form an anode catalyst layer. The anode catalyst layer applied had a solid content of 2.1 mg (platinum basis weight: 0.6 mg/cm²). Then, the catalyst ink was similarly applied on the other surface to form a cathode catalyst layer, thus obtaining MEA1. The cathode catalyst layer applied had a solid content of 2.1 mg (platinum basis weight: 0.6 mg/cm²).

### Example C2

### (Fabrication of MEA2)

MEA2 was obtained as in Example C1, except for using the polymer electrolyte membrane C2 in place of the polymer electrolyte membrane C1 of Example C1. The anode catalyst layer applied had a solid content of 2.1 mg (platinum basis weight: 0.6 mg/cm²); and the cathode catalyst layer applied had a solid content of 2.1 mg (platinum basis weight: 0.6 mg/cm²).

### Example C3

### (Fabrication of MEA3)

MEA3 was obtained as in Example C1, except for using the polymer electrolyte membrane C3 in place of the polymer electrolyte membrane C1 of Example C1. The anode catalyst layer applied had a solid content of 2.1 mg (platinum basis weight: 0.6 mg/cm²); and the cathode catalyst layer applied had a solid content of 2.1 mg (platinum basis weight: 0.6 mg/cm²).

(Assembling of a Cell as a Fuel Cell)

A carbon paper as a gas diffusion layer and a carbon-made separator on which a groove for a gas channel is cutting worked were arranged on each outer side of the MEA obtained as described above, and a current collector and an end plate were further arranged on the further outer side, and these were compressed with bolts, thus assembling a cell as a fuel cell having an effective membrane area of 1.3 cm².

(Evaluation of the Power Generation Characteristic)

While the obtained cell as a fuel cell was kept at 80° C., a moistened hydrogen was fed to the anode, and a moistened air was fed to the cathode. At this time, the back pressures at gas outlets of the cell were set at 0.1 MPaG. Moistening of the each raw material gas was carried out by passing the gas through a bubbler containing water, and the degree of moistening was regulated by the temperature of the bubbler water. The gas flow volume of hydrogen was set at 529 mL/min, and the gas flow volume of air was set at 1665 mL/min.

Each of MEA obtained in Examples C1 to C3 was assembled in a cell as a fuel cell, and the voltage values at a current density of 1.0 A/cm² under the moistening conditions described below were measured. The results are shown in Table 4. A higher voltage value indicates a better power generation characteristic.

### [Moistening Condition 1]

Anode bubbler water temperature: 80° C.
Cathode bubbler water temperature: 80° C.
Anode gas relative humidity: 100% RH
Cathode gas relative humidity: 100% RH

### [Moistening Condition 2]

Anode bubbler water temperature: 45° C.
Cathode bubbler water temperature: 55° C.
Anode gas relative humidity: 20% RH
Cathode gas relative humidity: 33% RH

TABLE 4

| | Moistening Condition 1 | Moistening Condition 2 |
|---|---|---|
| Example C1 | 0.71 V | 0.39 V |
| Example C2 | 0.69 V | 0.45 V |
| Example C3 | 0.73 V | 0.26 V |

From the above results, it has been clarified that the present invention can provide a polyarylene block copolymer exhibiting a good power generation characteristic under high-temperature and low-moisture conditions when used as an electrolyte membrane, a polymer electrolyte comprising the block copolymer, a polymer electrolyte membrane prepared by using the polymer electrolyte, a catalyst composition prepared by using the polymer electrolyte, and a polymer electrolyte fuel cell prepared by using these.

### REFERENCE SIGNS LIST

10 . . . FUEL CELL, 12 . . . POLYMER ELECTROLYTE MEMBRANE, 14a, 14b . . . CATALYST LAYER, 16a, 16b . . . GAS DIFFUSION LAYER, 18a, 18b . . . SEPARATOR, 20 . . . MEMBRANE-ELECTRODE ASSEMBLY (MEA)

1. A polymer electrolyte membrane comprising a polymer electrolyte having an ion-exchange group, wherein Sp and Snp satisfy the relationship expressed by the following expression (I):
Sp/Snp≦0.42 (I)
wherein Sp represents the total of peak areas obtained by measurement of a ¹³C-solid state nuclear magnetic resonance spectrum of the polymer electrolyte membrane, the polymer electrolyte membrane having been subjected to a first immersion treatment comprising immersing the polymer electrolyte membrane in 5 mmol/L iron (II) chloride tetrahydrate aqueous solution at 25° C. for 1 hour, and thereafter drying the polymer electrolyte membrane at 25° C. at 10 hPa or lower for 12 hours; and
Snp represents the total of peak areas obtained by measurement of a ¹³C-solid state nuclear magnetic resonance spectrum of the polymer electrolyte membrane, the polymer electrolyte membrane before the first immersion treatment having been subjected to a second immersion treatment comprising immersing the polymer electrolyte membrane in water at 25° C. for 1 hour, and thereafter drying the polymer electrolyte membrane at 25° C. at 10 hPa or lower for 12 hours.

2. The polymer electrolyte membrane according to claim 1, wherein the polymer electrolyte comprises a copolymer comprising a structural unit having an ion-exchange group and a structural unit having no ion-exchange group.

3. The polymer electrolyte membrane according to claim 1, wherein the polymer electrolyte is an aromatic polymer electrolyte.

4. A polymer whose main chain is of a polyarylene structure in which a plurality of aromatic rings are linked together substantially via direct bonds, wherein part or all of the aromatic rings constituting the main chain have a sulfonic acid group directly bonded thereto, and part or all of the aromatic rings constituting the main chain further have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent, and
wherein the ion-exchange capacity of the polymer is more than 3.0 meq/g.

5. The polymer according to claim 4, wherein a structural unit having in the main chain an aromatic ring having a sulfonic acid group directly bonded thereto accounts for 20 mol % or more based on 100 mol % of the total of structural units.

6. The polymer according to claim 4, comprising a structural unit represented by the following formula (A-1):
[Chemical Formula 1]
Ar¹ (A-1)
wherein in the formula (A-1), Ar¹ denotes a divalent aromatic group, and the aromatic group may be substituted with at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; and at least one sulfonic acid group is directly bonded to an aromatic ring constituting the main chain of Ar¹.

7. The polymer according to claim 6, wherein the structural unit represented by the formula (A-1) comprises a structural unit represented by the following formula (A-2): 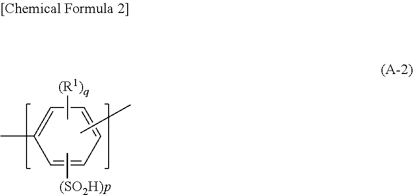
wherein in the formula (A-2), R¹ denotes a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, or an acyl group having 2 to 20 carbon atoms that may have a substituent; p is an integer of 1 or more and 3 or less, q is an integer of 0 or more and 3 or less, and p+q is an integer of 4 or less; and in the case where q is 2 or more, the plurality of R¹ may be identical or different from each other.

8. The polymer according to claim 4, wherein the polyarylene structure is a structure having a proportion of direct bonds of 80% or more based on 100% of the total number of bonds between aromatic rings.

9. A polymer, obtained by polymerizing raw material monomers comprising a first aromatic monomer represented by the following formula (A-3) and a second aromatic monomer represented by the following formula (A-4):
Q-Ar¹⁰-Q (A-3)
wherein in the formula (A-3), Ar¹⁰ is a divalent aromatic group that may have at least one group selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; Q denotes a leaving group, and two Q may be identical or different from each other; and a sulfonic acid group and/or a sulfonic acid precursor group is bonded to an aromatic ring bonded with one of the two Q, and
Q-Ar⁰-Q (A-4)
wherein in the formula (A-4), Ar⁰ denotes a divalent aromatic group, and the divalent aromatic group has at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; and Q denotes a leaving group, and two Q may be identical or different from each other.

10. The polymer according to claim 9, wherein the second aromatic monomer has as a substituent an acyl group that may have a substituent.

11. The polymer according to claim 9, obtained by polymerizing the raw material monomers in the presence of a zero-valent transition metal complex.

12. A polyarylene block copolymer, comprising a block having an ion-exchange group and a block having substantially no ion-exchange group obtained from a polymer having substantially no ion-exchange group and having a polystyrene-equivalent weight-average molecular weight of 4000 to 25000,
wherein the block having an ion-exchange group comprises a structural unit represented by the following formula (B-1), and the block having substantially no ion-exchange group comprises a structural unit represented by the following formula (B-2):
[Chemical Formula 3]
Ar¹ (B-1)
Ar²—X¹ (B-2)
wherein in the formula (B-1), Ar¹ denotes an arylene group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; and at least one ion-exchange group is directly bonded to an aromatic ring constituting the main chain in Ar¹, and in the formula (B-2), Ar² denotes a divalent aromatic group, and may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; and X¹ denotes an oxygen atom (—O—) or a sulfur atom (—S—).

13. The polyarylene block copolymer according to claim 12, wherein the ion-exchange group is at least one acid group selected from the group consisting of a sulfonic acid group, a phosphonic acid group, a carboxylic acid group and a sulfonimide group.

14. The polyarylene block copolymer according to claim 12, wherein the structural unit represented by the formula (B-1) is a structural unit represented by the following formula (B-3): 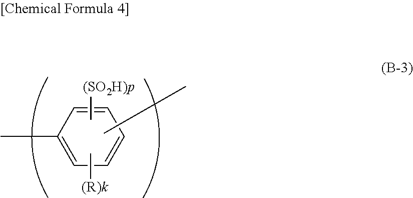
wherein in the formula (B-3), R denotes an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, or a cyano group; k denotes an integer of 0 to 3, p denotes an integer of 1 or 2, and k+p denotes an integer of 4 or less; and in the case where k is 2 or more, the plurality of R may be identical or different from each other.

15. The polyarylene block copolymer according to claim 12, wherein the polymer having substantially no ion-exchange group is a polymer represented by the following formula (B-4): 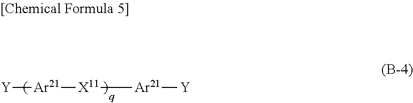
wherein in the formula (B-4), Ar²¹ denotes a divalent aromatic group, and the plurality of Ar²¹ may be identical or different from each other; the aromatic group may be substituted with at least one group selected from the group consisting of an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, an acyl group having 2 to 20 carbon atoms that may have a substituent, and a cyano group; X¹¹ denotes an oxygen atom (—O—) or a sulfur atom (—S—), and the plurality of X¹¹ may be identical or different from each other; Y denotes a leaving group, and two Y may be identical or different from each other; and q denotes an integer of 4 or more.

16. The polyarylene block copolymer according to claim 15, wherein a hydrophobicity parameter of the polymer represented by the formula (B-4) is 1.7 to 6.0.

17. The polyarylene block copolymer according to claim 15, wherein a hydrophobicity parameter of the polymer represented by the (B-4) is 2.5 to 4.0.

18. The polyarylene block copolymer according to claim 12, wherein the ion-exchange capacity of the polyarylene block copolymer is 1.0 to 7.0 meq/g.

19. A polyarylene block copolymer, comprising a block having an ion-exchange group and a block having substantially no ion-exchange group,
wherein the main chain of the block having an ion-exchange group has a polyarylene structure in which a plurality of aromatic rings are linked together substantially directly,
wherein a part or all of ion-exchange groups are directly bonded to the aromatic rings constituting the main chain, and
the block having substantially no ion-exchange group has a structure represented by the following formula (C-1): 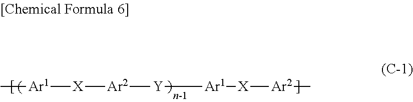
wherein in the formula (C-1), Ar¹ and Ar² each independently denote an arylene group, and the arylene group may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms, that may have a substituent or an acyl group having 2 to 20 carbon atoms that may have a substituent; X denotes a carbonyl group (—C(═O)—) or a sulfonyl group (—S(═O)₂—); Y denotes an oxygen atom (—O—) or a sulfur atom (—S—); n denotes an integer of 3 to 45; and the pluralities of Ar¹, Ar², X and Y may be each identical or different from each other.

20. The polyarylene block copolymer according to claim 19, wherein the block having substantially no ion-exchange group has a structure represented by the following formula (C-2): 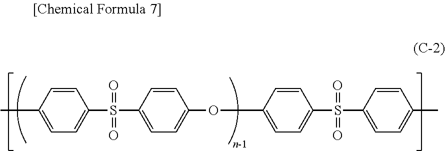
wherein n denotes an integer of 3 to 45.

21. The polyarylene block copolymer according to claim 19, wherein the block having an ion-exchange group has a structure represented by the following formula (C-3): 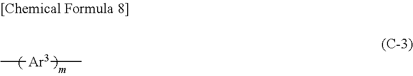
wherein in the formula (C-3), m denotes an integer of 3 or more; Ar³ denotes an arylene group; the arylene group may be substituted with a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms, that may have a substituent or an acyl group having 2 to 20 carbon atoms that may have a substituent; in Ar³, at least one ion-exchange group is directly bonded to an aromatic ring constituting the main chain thereof; and the plurality of Ar³ may be identical or different from each other.

22. The polyarylene block copolymer according to claim 19, wherein the ion-exchange group is at least one acid group selected from the group consisting of a sulfonic acid group, a phosphonic acid group and a carboxylic acid group.

23. The polyarylene block copolymer according to claim 19, wherein the block having an ion-exchange group has a structure represented by the following formula (C-4): 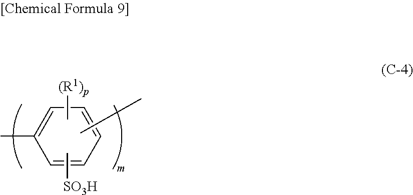
wherein in the formula (C-4), m denotes an integer of 3 or more; R¹ denotes at least one substituent selected from the group consisting of a fluorine atom, an alkyl group having 1 to 20 carbon atoms that may have a substituent, an alkoxy group having 1 to 20 carbon atoms that may have a substituent, an aryl group having 6 to 20 carbon atoms that may have a substituent, an aryloxy group having 6 to 20 carbon atoms that may have a substituent, and an acyl group having 2 to 20 carbon atoms that may have a substituent; p is an integer of 0 to 3; and in the case where there are a plurality of R¹, R¹ may be identical or different from each other.

24. The polyarylene block copolymer according to claim 19, wherein the ion-exchange capacity of the polyarylene block copolymer is 0.5 meq/g to 5.0 meq/g.

25. A polymer electrolyte, comprising the polymer according to claim 4.

26. A polymer electrolyte, comprising the polyarylene block copolymer according to claim 12.

27. A polymer electrolyte, comprising the polyarylene block copolymer according to claim 19.

28. A polymer electrolyte membrane, comprising the polymer electrolyte according to claim 25.

29. A polymer electrolyte composite membrane, comprising a porous base material having a polymer electrolyte in pores thereof, wherein the polymer electrolyte is the polymer electrolyte according to claim 25.

30. A catalyst composition, comprising the polymer electrolyte according to claim 25 and a catalyst component.

31. A membrane-electrode assembly, comprising the polymer electrolyte membrane according to claim 1 and a catalyst layer formed on the polymer electrolyte membrane.

32. A membrane-electrode assembly, comprising a polymer electrolyte membrane and a catalyst layer formed on the polymer electrolyte membrane,
wherein the polymer electrolyte membrane comprises the polymer electrolyte according to claim 25.

33. A membrane-electrode assembly, comprising the polymer electrolyte membrane according to claim 28.

34. A membrane-electrode assembly, comprising a polymer electrolyte membrane and a catalyst layer formed on the polymer electrolyte membrane,
wherein the catalyst layer is formed of the catalyst composition according to claim 30.

35. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 31.

36. A polymer electrolyte membrane, comprising the polymer electrolyte according to claim 26.

37. A polymer electrolyte membrane, comprising the polymer electrolyte according to claim 27.

38. A polymer electrolyte composite membrane, comprising a porous base material having a polymer electrolyte in pores thereof,
wherein the polymer electrolyte is the polymer electrolyte according to claim 26.

39. A polymer electrolyte composite membrane, comprising a porous base material having a polymer electrolyte in pores thereof,
wherein the polymer electrolyte is the polymer electrolyte according to claim 27.

40. A catalyst composition, comprising the polymer electrolyte according to claim 26 and a catalyst component.

41. A catalyst composition, comprising the polymer electrolyte according to claim 27 and a catalyst component.

42. A membrane-electrode assembly, comprising a polymer electrolyte membrane and a catalyst layer formed on the polymer electrolyte membrane,
wherein the polymer electrolyte membrane comprises the polymer electrolyte according to claim 26.

43. A membrane-electrode assembly, comprising a polymer electrolyte membrane and a catalyst layer formed on the polymer electrolyte membrane,
wherein the polymer electrolyte membrane comprises the polymer electrolyte according to claim 27.

44. A membrane-electrode assembly, comprising the polymer electrolyte membrane according to claim 36.

45. A membrane-electrode assembly, comprising the polymer electrolyte membrane according to claim 37.

46. A membrane-electrode assembly, comprising the polymer electrolyte composite membrane according to claim 29.

47. A membrane-electrode assembly, comprising the polymer electrolyte composite membrane according to claim 38.

48. A membrane-electrode assembly, comprising the polymer electrolyte composite membrane according to claim 39.

49. A membrane-electrode assembly, comprising a polymer electrolyte membrane and a catalyst layer formed on the polymer electrolyte membrane,
wherein the catalyst layer is formed of the catalyst composition according to claim 40.

50. A membrane-electrode assembly, comprising a polymer electrolyte membrane and a catalyst layer formed on the polymer electrolyte membrane,
wherein the catalyst layer is formed of the catalyst composition according to claim 41.

51. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 32.

52. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 33.

53. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 34.

54. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 42.

55. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 43.

56. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 44.

57. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 45.

58. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 46.

59. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 47.

60. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 48.

61. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 49.

62. A fuel cell, comprising a pair of separators, a pair of gas diffusion layers disposed between the pair of separators, and a membrane-electrode assembly disposed between the pair of gas diffusion layers,
wherein the membrane-electrode assembly is the membrane-electrode assembly according to claim 50.
